(19) United States
(12) Patent Application Publication
(10) Pub. No.: US 2014/0297787 A1
(43) Pub. Date: Oct. 2, 2014

(54) Systems, methods, and mediums for components and applications comprising components

(71) Applicants: Kevin A. Baugh, Reston, VA (US); Douglas Mark Dillon, Reston, VA (US); Michele Kim Casey, Arlington, VA (US); Barry Samuel Hess, Fairfax, VA (US); David William Pachura, Ellicott, MD (US); Martea Denisa Scott, Linden, VA (US)

(72) Inventors: Kevin A. Baugh, Reston, VA (US); Douglas Mark Dillon, Reston, VA (US); Michele Kim Casey, Arlington, VA (US); Barry Samuel Hess, Fairfax, VA (US); David William Pachura, Ellicott, MD (US); Martea Denisa Scott, Linden, VA (US)

(21) Appl. No.: 13/986,075

(22) Filed: Mar. 29, 2013

(51) Int. Cl. H04L 29/08

(52) U.S. Cl. CPC H04L 67/10
USPC 709/217

(57) ABSTRACT

A computer system may include a processor and a memory configured to store a library of applications for execution by the processor. The computer system may be configured to allow users of the computer system to download one or more applications from the library of applications to communications devices. The downloaded one or more applications may be configured to connect at least one first communications device of the communications devices to at least one second communications device of the communications devices in a network. Information transfer within the network from the at least one first communications device to the at least one second communications device may be independent of the processor.

### BACKGROUND

1. Field

End-user computing (“EUC”) refers to systems in which individuals who are not professional programmers may create working applications, and methods for individuals who are not professional programmers to create working applications. End-user development (“EUD”) refers to methods and tools that allow individuals who are not professional programmers to program computers and other electronic devices without in-depth knowledge of a programming language. A spreadsheet is a common example of an EUD tool.

2. Description of Related Art

As may be known to a person having ordinary skill in the art (“PHOSITA”), LEGO® MINDSTORMS® NXT Software refers to a particular icon-based, drag-and-drop programming software product for use with LEGO® MINDSTORMS® NXT robotics tool sets. NXT (or “NXT brick”) refers to an intelligent, computer-controlled LEGO® brick that functions as the brain of an associated MINDSTORMS® robot. The NXT brick may have, for example, a Universal Serial Bus (“USB”) port, four input ports (ports 1-4), and three output ports (ports A-C). Generally, sensors should be attached to input ports of the NXT brick by electrical cables (typically a 6-wire cable). The sensors may include, for example, color sensors, touch sensors, and ultrasonic sensors. Similarly, motors should be attached to output ports of the NXT brick by electrical cables (typically a 6-wire cable). The motors may include, for example, interactive servo motors. Standard settings for the input ports may include, for example, port 1 (touch sensor), port 2 (touch sensor), port 3 (light/color sensor), and port 4 (ultrasonic sensor). Standard for the output ports may include, for example, port A (motor used for extra function), port B2 (motor for movement), and port C (motor for movement). An end-user may perform limited programming of a MINDSTORMS® robot without a computer by using an NXT Program submenu.

As also may be known to a person having ordinary skill in the art (“PHOSITA”), NeatTools refers to an object-oriented, visual programming environment, coded in C++(with a Java-like thin-layer API). NeatTools modules (visual objects) may be selected and dragged into the workspace from toolbox collections. Modules may possess properties, parameters, and various data inputs and outputs. Inputs, outputs, and parameters may be connected to other modules by links (lines) drawn by the programmer.

### SUMMARY

Example embodiments may provide computer systems that support EUC, EUD, and/or similar capabilities.

Example embodiments also may provide computer-implemented methods that support EUC, EUD, and/or similar capabilities.

Additionally, example embodiments may provide computer-readable mediums that support EUC, EUD, and/or similar capabilities.

In some example embodiments, a “mobile” communications device refers to a cellular device that transfers information, for example, using channel access methods such as code-division multiple access (“CDMA”), frequency-division multiple access (“FDMA”), space-division multiple access (“SDMA”), and time-division multiple access (“TDMA”). A “mobile” communications device typically is associated with a telephone number. Examples include cellular phones and watch phones.

In some example embodiments, a “wireless” communications device refers to a device that transfers information, for example, using an Institute of Electrical and Electronics Engineers (“IEEE”) standard for wireless communications, such as an IEEE 802 standard (e.g., Bluetooth, WiFi, and ZigBee). In some example embodiments, a “wireless” communications device refers to a device that transfers information, for example, using Quick Response (“QR”) codes. In some example embodiments, a “wireless” communications device refers to a device that transfers information, for example, using near field communication (“NFC”). In some example embodiments, a “wireless” communications device refers to a device that transfers information, for example, using radiofrequency identification (“RFID”). In some example embodiments, a “wireless” communications device refers to a device that transfers information, for example, using electro-optical approaches (e.g., infrared”).

In some example embodiments, a “mobile” or “wireless” communications device may use the Android operating system, the iOS operating system, the Windows Mobile operating system, the Blackberry operating system, the Symbian operating system, or other operating system.

In some example embodiments, programming references may be to Java, Objective C, C Sharp, or other programming language.

In some example embodiments, a computer-readable medium that is not a transitory propagating signal may comprise, for example, a non-transitory computer-readable medium.

In some example embodiments, a computer system may comprise a processor and/or a memory configured to store a library of applications for execution by the processor. The computer system may be configured to allow users of the computer system to download one or more applications from the library of applications to communications devices. The downloaded one or more applications may be configured to connect at least one first communications device of the communications devices to at least one second communications device of the communications devices in a network. Information transfer within the network from the at least one first communications device to the at least one second communications device may be independent of the processor.

In some example embodiments, the communications devices may comprise one or more mobile communications devices.

In some example embodiments, the communications devices may comprise one or more wireless communications devices.

In some example embodiments, the communications devices may comprise one or more wired communications devices.

In some example embodiments, the computer system may be further configured to allow users of the computer system to edit the one or more applications from the library of applications prior to downloading the edited one or more applications from the library of applications to the communications devices.

In some example embodiments, the computer system may be further configured to allow users of the computer system to add the edited one or more applications to the library of applications.

In some example embodiments, when a sensor of the at least one first communications device detects a change in an environment of the at least one first communications device, the at least one first communications device may transfer information within the network from the at least one first communications device to the at least one second communications device.

In some example embodiments, a computer-implemented method for connecting communications devices using a library of applications stored in a memory of a computer system may comprise downloading one or more applications from the library of applications to the communications devices; and/or using the downloaded one or more applications to connect at least one first communications device of the communications devices to at least one second communications device of the communications devices in a network. Information transfer within the network from the at least one first communications device to the at least one second communications device may be independent of the processor.

In some example embodiments, the communications devices may comprise one or more mobile communications devices.

In some example embodiments, the communications devices may comprise one or more wireless communications devices.

In some example embodiments, the communications devices may comprise one or more wired communications devices.

In some example embodiments, the method may further comprise editing the one or more applications from the library of applications prior to downloading the one or more applications from the library of applications to the communications devices.

In some example embodiments, the method may further comprise adding the edited one or more applications to the library of applications.

In some example embodiments, the method may further comprise transferring information within the network from the at least one first communications device to the at least one second communications device when a sensor of the at least one first communications device detects a change in an environment of the at least one first communications device.

In some example embodiments, a computer-readable medium that is not a transitory propagating signal, the computer-readable medium having stored thereon instructions that, when executed by a computing device, may cause the computing device to perform functions comprising allowing users of the computing device to download one or more applications, from a library of applications stored in a memory of the computing device, to communications devices; and allowing the downloaded one or more applications to connect at least one first communications device of the communications devices to at least one second communications device of the communications devices in a network. Information transfer within the network from the at least one first communications device to the at least one second communications device is independent of the processor.

In some example embodiments, the communications devices may comprise one or more mobile communications devices.

In some example embodiments, the communications devices may comprise the communications devices comprise one or more wireless communications devices.

In some example embodiments, the communications devices may comprise one or more wired communications devices.

In some example embodiments, the computer-readable medium, having stored thereon instructions that, when executed by a computing device, may cause the computing device to perform functions further comprising allowing the users of the computing device to edit the one or more applications from the library of applications prior to downloading the one or more applications from the library of applications to the communications devices.

In some example embodiments, the computer-readable medium, having stored thereon instructions that, when executed by a computing device, may cause the computing device to perform functions further comprising allowing the users of the computing device to add the edited one or more applications to the library of applications.

In some example embodiments, the computer-readable medium having stored thereon instructions that, when executed by a computing device, may cause the computing device to perform functions further comprising allowing the at least one first communications device to transfer information within the network from the at least one first communications device to the at least one second communications device when a sensor of the at least one first communications device detects a change in an environment of the at least one first communications device.

In some example embodiments, a computer system may comprise a processor and a memory configured to store a library of applications for execution by the processor. The computer system may be configured to allow users of the computer system to download one or more applications from the library of applications to communications devices. The downloaded one or more applications may be configured to connect at least one first communications device of the communications devices and at least one second communications device of the communications devices in a network. Two-way information transfer within the network between the at least one first communications device and the at least one second communications device may be independent of the processor.

In some example embodiments, the communications devices may comprise one or more mobile communications devices.

In some example embodiments, the communications devices may comprise one or more wireless communications devices.

In some example embodiments, the communications devices may comprise one or more wired communications devices.

In some example embodiments, the computer system may be further configured to allow users of the computer system to edit the one or more applications from the library of applications prior to downloading the edited one or more applications from the library of applications to the communications devices.

In some example embodiments, the computer system may be further configured to allow users of the computer system to add the edited one or more applications to the library of applications.

In some example embodiments, when a sensor of the at least one first communications device detects a change in an environment of the at least one first communications device, the at least one first communications device may transfer information within the network from the at least one first communications device to the at least one second communications device.

In some example embodiments, a computer-implemented method for connecting communications devices using a library of applications stored in a memory of a computer system, the method comprising downloading one or more applications from the library of applications to the communications devices; and/or using the downloaded one or more applications to connect at least one first communications device of the communications devices and at least one second communications device of the communications devices in a network. Two-way information transfer within the network between the at least one first communications device and the at least one second communications device is independent of the processor.

In some example embodiments, the communications devices may comprise one or more mobile communications devices.

In some example embodiments, the communications devices may comprise one or more wireless communications devices.

In some example embodiments, the communications devices may comprise one or more wired communications devices.

In some example embodiments, the method may further comprise editing the one or more applications from the library of applications prior to downloading the one or more applications from the library of applications to the communications devices.

In some example embodiments, the method may further comprise adding the edited one or more applications to the library of applications.

In some example embodiments, the method may further comprise transferring information within the network from the at least one first communications device to the at least one second communications device when a sensor of the at least one first communications device detects a change in an environment of the at least one first communications device.

In some example embodiments, a computer-readable medium that is not a transitory propagating signal, the computer-readable medium having stored thereon instructions that, when executed by a computing device, may cause the computing device to perform functions comprising: allowing users of the computing device to download one or more applications, from a library of applications stored in a memory of the computing device, to communications devices; and/or allowing the downloaded one or more applications to connect at least one first communications device of the communications devices and at least one second communications device of the communications devices in a network. Two-way information transfer within the network between the at least one first communications device and the at least one second communications device may be independent of the processor.

In some example embodiments, the communications devices may comprise one or more mobile communications devices.

In some example embodiments, the communications devices may comprise one or more wireless communications devices.

In some example embodiments, the communications devices may comprise one or more wired communications devices.

In some example embodiments, the computer-readable medium, having stored thereon instructions that, when executed by a computing device, may cause the computing device to perform functions further comprising allow the users of the computing device to edit the one or more applications from the library of applications prior to downloading the one or more applications from the library of applications to the communications devices.

In some example embodiments, the computer-readable medium, having stored thereon instructions that, when executed by a computing device, may cause the computing device to perform functions further comprising allowing the users of the computing device to add the edited one or more applications to the library of applications.

In some example embodiments, the computer-readable medium, having stored thereon instructions that, when executed by a computing device, may cause the computing device to perform functions further comprising allowing the at least one first communications device to transfer information within the network from the at least one first communications device to the at least one second communications device when a sensor of the at least one first communications device detects a change in an environment of the at least one first communications device.

In some example embodiments, a computer system may comprise a processor and a memory configured to store a library of applications for execution by the processor. Each application in the library of applications may comprise a plurality of components. The computer system may be configured to allow a user of the computer system to access at least one component of the plurality of components. The computer system may be further configured to allow the user to edit the accessed at least one component. The computer system may be further configured to allow the user to construct a new application, tailored to the user, that includes the edited at least one component and at least one other component of the plurality of components.

In some example embodiments, to access the at least one component of the plurality of components may comprise identifying a visual representation of the at least one component on a workspace of the computer system.

In some example embodiments, to access the at least one component of the plurality of components may comprise moving a visual representation of the at least one component onto a workspace of the computer system.

In some example embodiments, to construct the new application may comprise moving a visual representation of the edited at least one component onto a workspace of the computer system, and moving a visual representation of the at least one other component onto the workspace of the computer system.

In some example embodiments, to construct the new application may comprise connecting a visual representation, on a workspace of the computer system, of the edited at least one component to a visual representation, on the workspace of the computer system, of the at least one other component.

In some example embodiments, a computer-implemented method for tailoring, to a user of a computer system, an application in a library of applications stored in a memory of the computer system, each application in the library of applications comprising a plurality of components may comprise accessing at least one component of the plurality of components; editing the accessed at least one component; and/or constructing a new application, tailored to the user, that includes the edited at least one component and at least one other component of the plurality of components.

In some example embodiments, the method may further comprise identifying a visual representation of the at least one component on a workspace of the computer system.

In some example embodiments, the method may further comprise moving a visual representation of the at least one component onto a workspace of the computer system.

In some example embodiments, the method may further comprise moving a visual representation of the edited at least one component onto a workspace of the computer system and/or moving a visual representation of the at least one other component onto the workspace of the computer system.

In some example embodiments, the method may further comprise connecting a visual representation, on a workspace of the computer system, of the edited at least one component to a visual representation, on the workspace of the computer system, of the at least one other component.

In some example embodiments, a computer-readable medium that is not a transitory propagating signal, the computer-readable medium having stored thereon instructions that, when executed by a computing device, may cause the computing device to allow a user of the computing device to perform functions comprising: accessing at least one component of a plurality of components of an application, in a library of applications stored in a memory of the computing device; editing the at least one accessed component; and/or constructing a new application, tailored to the user, that includes the edited at least one component and at least one other component of the plurality of components.

In some example embodiments, the computer-readable medium, having stored thereon instructions that, when executed by the computing device, may cause the computing device to perform functions further comprising: identifying a visual representation of the at least one component on a workspace of the computing device.

In some example embodiments, the computer-readable medium, having stored thereon instructions that, when executed by the computing device, may cause the computing device to perform functions further comprising: moving a visual representation of the at least one component onto a workspace of the computing device.

In some example embodiments, the computer-readable medium, having stored thereon instructions that, when executed by the computing device, may cause the computing device to perform functions further comprising: moving a visual representation of the edited at least one component onto a workspace of the computing device; and/or moving a visual representation of the at least one other component onto the workspace of the computing device.

In some example embodiments, constructing the new application may comprise connecting a visual representation, on the workspace of the computing device, of the edited at least one component to a visual representation, on the workspace of the computing device, of the at least one other component.

In some example embodiments, a computer system may comprise a processor and a memory configured to store a library of components for applications for execution by the processor. The computer system may be configured to allow a user of the computer system to access the library of components. The computer system may be further configured to allow the user to construct a new application, tailored to the user, that includes two or more components of the library of components.

In some example embodiments, to access the library of components may comprise identifying visual representations of the two or more components on a workspace of the computer system.

In some example embodiments, to access the library of components may comprise moving visual representations of the two or more components onto a workspace of the computer system.

In some example embodiments, to construct the new application may comprise connecting visual representations of the two or more components on a workspace of the computer system.

In some example embodiments, a computer-implemented method for tailoring, to a user of a computer system, an application in a library of components for applications stored in a memory of the computer system, may comprise: accessing the library of components; and/or constructing a new application, tailored to the user, that includes two or more components of the library of components.

In some example embodiments, the method may further comprise identifying visual representations of the two or more components on a workspace of the computer system.

In some example embodiments, the method may further comprise moving visual representations of the two or more components onto a workspace of the computer system.

In some example embodiments, the method may further comprise connecting visual representations of the two or more components on a workspace of the computer system.

In some example embodiments, a computer-readable medium that is not a transitory propagating signal, the computer-readable medium having stored thereon instructions that, when executed by a computing device, may cause the computing device to allow a user of the computing device to perform functions comprising: accessing a library of components; and/or constructing a new application, tailored to the user, that includes two or more components of the library of components.

In some example embodiments, the computer-readable medium having stored thereon instructions that, when executed by the computing device, may cause the computing device to perform functions further comprising: identifying visual representations of the two or more components on a workspace of the computer system.

In some example embodiments, the computer-readable medium having stored thereon instructions that, when executed by the computing device, may cause the computing device to perform functions further comprising: moving visual representations of the two or more components onto a workspace of the computer system.

These and other features and advantages of this invention are described in, or are apparent from, the following detailed description of various example embodiments of the apparatuses and methods according to the invention.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 illustrates system architecture;

FIG. 2 illustrates system architecture including Application Builder and Application Loader;

FIG. 3 illustrates the Application Server's combination of Components and Runtime base classes to form applications;

FIG. 4 illustrates a menu interface for users of devices in the system;

FIG. 5 illustrates component categories;

FIG. 6 illustrates the steps which may be involved in creating a new application;

FIG. 7 illustrates the button component in the User Interface component category in the upper left corner component button;

FIG. 8 illustrates the button component being dragged into the default activity window from the component categories in the upper left corner;

FIG. 9 shows the button component in the default activity window and the properties box;

FIG. 10 illustrates selection of the Send SMS component button from the Input/Output component category in the upper left corner of the designer workspace;

FIG. 11 illustrates dragging the Send SMS component into the canvas area and that the property box in the upper right corner remains associated with the button component until the send SMS component is selected;

FIG. 12 illustrates the property box for the SMS component;

FIG. 13 illustrates creation of connections between components and the current state of the application being saved;

FIG. 14 illustrates the prompt displayed as the application saves;

FIG. 15 illustrates compiling the application;

FIG. 16 illustrates a display of the QR Code and URL to download the application package file (“APK”) of the application;

FIG. 17 illustrates the screen of the mobile device at execution of the application when the button has not been selected;

FIG. 18 illustrates the screen of the mobile device at execution of the application when the button has been selected and triggers the display of the GreenLED, beside the designer window to illustrate that the button is above the GreenLED in the mobile device just as in the default activity window;

FIG. 19 illustrates a listing of saved applications which a user may select to view or edit, or download the APK;

FIG. 20 illustrates the GPSTrack application as an example for editing an existing application;

FIG. 21 illustrates the screen of the mobile device executing the GPSTrack application;

FIG. 22 illustrates the GPSTrack application edited to change the connections between components;

FIG. 23 illustrates the GPSTrack application edited to change the order of components;

FIG. 24 illustrates the manner in which a user may create a new Component interface;

FIG. 25 illustrates the Component Manager which lists the existing components giving a user the ability to export and import component source code, and modify the Component interface;

FIG. 26 illustrates components in a library of components according to some example embodiments;

FIG. 27 is a screenshot showing some example embodiments of logic components;

FIG. 28 illustrates an “AND” component according to some example embodiments;

FIG. 29 illustrates an “OR” component according to some example embodiments;

FIG. 30 illustrates an “NOT” component according to some example embodiments;

FIG. 31 is a table providing information regarding some example embodiments of logic components;

FIG. 32 is a screenshot showing some example embodiments of converter components;

FIG. 33 illustrates a “BooleanToJson” component according to some example embodiments;

FIG. 34 illustrates a “BooleanToString” component according to some example embodiments;

FIG. 35 illustrates a “ByteArrayToString” component according to some example embodiments;

FIG. 36 illustrates a “ByteToInteger” component according to some example embodiments;

FIG. 37 illustrates a “ByteToString” component according to some example embodiments;

FIG. 38 illustrates a “DateToString” component according to some example embodiments;

FIG. 39 illustrates a “DoubleToInteger” component according to some example embodiments;

FIG. 40 illustrates a “DoubleToString” component according to some example embodiments;

FIG. 41 illustrates a “FloatToInteger” component according to some example embodiments;

FIG. 42 illustrates a “FloatToString” component according to some example embodiments;

FIG. illustrates an “ImageToBase64” component according to some example embodiments;

FIG. 44 illustrates an “IntegerToBoolean” component according to some example embodiments;

FIG. 45 illustrates an “IntegerToByte” component according to some example embodiments;

FIG. 46 illustrates an “IntegerToFloat” component according to some example embodiments;

FIG. 47 illustrates an “IntegerToString” component according to some example embodiments;

FIG. 48 illustrates a “JsonArrayToByteArray” component according to some example embodiments;

FIG. 49 illustrates a “JsonCombiner” component according to some example embodiments;

FIG. 50 illustrates a “LocationToJson” component according to some example embodiments;

FIG. 51 illustrates a “LocationToString” component according to some example embodiments;

FIG. 52 provides source code for “LocationToString” components according to some example embodiments;

FIG. 53 illustrates a “LowercaseString” component according to some example embodiments;

FIG. 54 illustrates a “StringGenerator” component according to some example embodiments;

FIG. 55 illustrates a “StringLength” component according to some example embodiments;

FIG. 56 illustrates a “StringToByte” component according to some example embodiments;

FIG. 57 illustrates a “StringToByteArray” component according to some example embodiments;

FIG. 58 illustrates a “StringToFloat” component according to some example embodiments;

FIG. 59 illustrates a “StringTolnteger” component according to some example embodiments;

FIG. 60 illustrates a “StringToJson” component according to some example embodiments;

FIG. 61 illustrates an “UnixToDateString” component according to some example embodiments;

FIG. 62 illustrates an “UppercaseString” component according to some example embodiments;

FIG. 63 is a table providing information regarding some example embodiments of converter components;

FIG. 64 is a screenshot showing some example embodiments of input/output components;

FIG. 65 illustrates an “BluetoothSPPClientAddr” component according to some example embodiments;

FIG. 66 illustrates an “BluetoothSPPServerAddr” component according to some example embodiments;

FIG. 67 illustrates a “Decryptor” component according to some example embodiments;

FIG. 68 illustrates an “Encryptor” component according to some example embodiments;

FIG. 69 illustrates a “GetUrl” component according to some example embodiments;

FIG. 70 illustrates a “ObbLogger” component according to some example embodiments;

FIG. 71 illustrates a “PostFile” component according to some example embodiments;

FIG. 72 illustrates a “PostJson” component according to some example embodiments;

FIG. 73 illustrates a “PulseOx13” component according to some example embodiments;

FIG. 74 illustrates a “ReadFile” component according to some example embodiments;

FIG. 75 illustrates a “ReceiveSMS” component according to some example embodiments;

FIG. 76 illustrates a “SaveImage” component according to some example embodiments;

FIG. 77 illustrates a “SaveToFile” component according to some example embodiments;

FIG. 78 illustrates a “SendSMS” component according to some example embodiments;

FIG. 79 illustrates a “SendText” component according to some example embodiments;

FIG. 80 provides source code for “SendText” components according to some example embodiments;

FIG. 81 illustrates an “SQS” component according to some example embodiments;

FIG. 82 illustrates an “S3Uploader” component according to some example embodiments;

FIG. 83 is a table providing information regarding some example embodiments of input/output components;

FIG. 84 is a screenshot showing some example embodiments of hardware components;

FIG. 85 illustrates an “Accelerometer” component according to some example embodiments;

FIG. 86 illustrates a “BarcodeScanner” component according to some example embodiments;

FIG. 87 illustrates a “camera” component according to some example embodiments;

FIG. 88 illustrates a “GPS” component according to some example embodiments;

FIGS. 89A-89C provide source code for “GPS” components according to some example embodiments;

FIG. 90 illustrates a “GPS Box” component according to some example embodiments;

FIG. 91 illustrates a “GPS Fence” component according to some example embodiments;

FIG. 92A-92D provide source code for “GPS Fence” components according to some example embodiments;

FIG. 93 illustrates a “MagneticField” component according to some example embodiments;

FIG. 94 illustrates a “Microphone” component according to some example embodiments;

FIG. 95 illustrates a “ProximitySensor” component according to some example embodiments;

FIG. 96 is a table providing information regarding some example embodiments of hardware components;

FIG. 97 is a screenshot showing some example embodiments of user interface components;

FIG. 98 illustrates a “boolLED” component according to some example embodiments;

FIG. 99 illustrates a “Button” component according to some example embodiments;

FIG. 100 illustrates a “CheckBox” component according to some example embodiments;

FIG. 101 illustrates a “DatePicker” component according to some example embodiments;

FIG. 102 illustrates an “EmbeddedCamera” component according to some example embodiments;

FIG. 103 illustrates a “GreenLED” component according to some example embodiments;

FIG. 104 illustrates an “ImageDisplay” component according to some example embodiments;

FIG. 105 illustrates a “Label” component according to some example embodiments;

FIG. 106 illustrates an “LED” component according to some example embodiments;

FIG. 107 illustrates a “MultiSpinner” component according to some example embodiments;

FIG. 108 illustrates an “ObbFacebook” component according to some example embodiments;

FIG. 109 illustrates an “ObbTwitter” component according to some example embodiments;

FIG. 110 illustrates a “PushButton” component according to some example embodiments;

FIG. 111 illustrates a “RadioGroup” component according to some example embodiments;

FIG. 112 illustrates a “SimpleDialog” component according to some example embodiments;

FIG. 113 illustrates a “Spinner” component according to some example embodiments;

FIG. 114 illustrates a “TextField” component according to some example embodiments;

FIG. 115 illustrates a “ToggleSwitch” component according to some example embodiments;

FIG. 116 is a table providing information regarding some example embodiments of user interface components;

FIG. 117 is a screenshot showing some example embodiments of miscellaneous components;

FIG. 118 illustrates a “BtAddrSelectByName” component according to some example embodiments;

FIG. 119 illustrates a “DateComparer” component according to some example embodiments;

FIG. 120 illustrates a “DateWatchDog” component according to some example embodiments;

FIG. 121 illustrates a “GreaterThan” component according to some example embodiments;

FIG. 122 illustrates an “IntegerThreshold” component according to some example embodiments;

FIG. 123 illustrates a “OneTimeTrigger” component according to some example embodiments;

FIG. 124 illustrates a “Recorder” component according to some example embodiments;

FIG. 125 illustrates a “RegexMatcher” component according to some example embodiments;

FIG. 126 illustrates a “RegexValidator” component according to some example embodiments;

FIG. 127 illustrates a “ShutterFlyProcessor” component according to some example embodiments;

FIG. 128A-128I provide source code for “Shutterfly Processor” components according to some example embodiments;

FIG. 129 illustrates a “StoresLastLocation” component according to some example embodiments;

FIG. 130 illustrates a “SystemInfo” component according to some example embodiments;

FIG. 131 illustrates a “TimeLimiter” component according to some example embodiments;

FIG. 132 provides source code for “TimeLimiter” components according to some example embodiments;

FIG. 133 illustrates a “TimeStamper” component according to some example embodiments;

FIG. 134 illustrates a “Tone” component according to some example embodiments;

FIG. 135 illustrates a “UnixTime” component according to some example embodiments;

FIG. 136 illustrates a “UserLogin3” component according to some example embodiments;

FIG. 137 is a table providing information regarding some example embodiments of miscellaneous components;

FIG. 138 illustrates a Four Geo-Fence Application according to some example embodiments;

FIG. 139 illustrates a Geo-Poster Application according to some example embodiments;

FIG. 140 illustrates a Shutterfly Post Application according to some example embodiments;

FIG. 141 illustrates an Accelerometer Display Application according to some example embodiments;

FIG. 142 illustrates a Post-a-Picture Application according to some example embodiments; and

FIG. 143 illustrates a Medical Triage Application according to some example embodiments.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, functions, and/or acts noted may occur out of the order noted in the figures. For example, two figures shown in succession may in fact be executed substantially concurrently or may sometimes be executed in the reverse order, depending upon the functionality and/or acts involved.

Reference will now be made to example embodiments, which are illustrated in the accompanying drawings, wherein like reference numerals may refer to like components throughout.

### 1. Overview

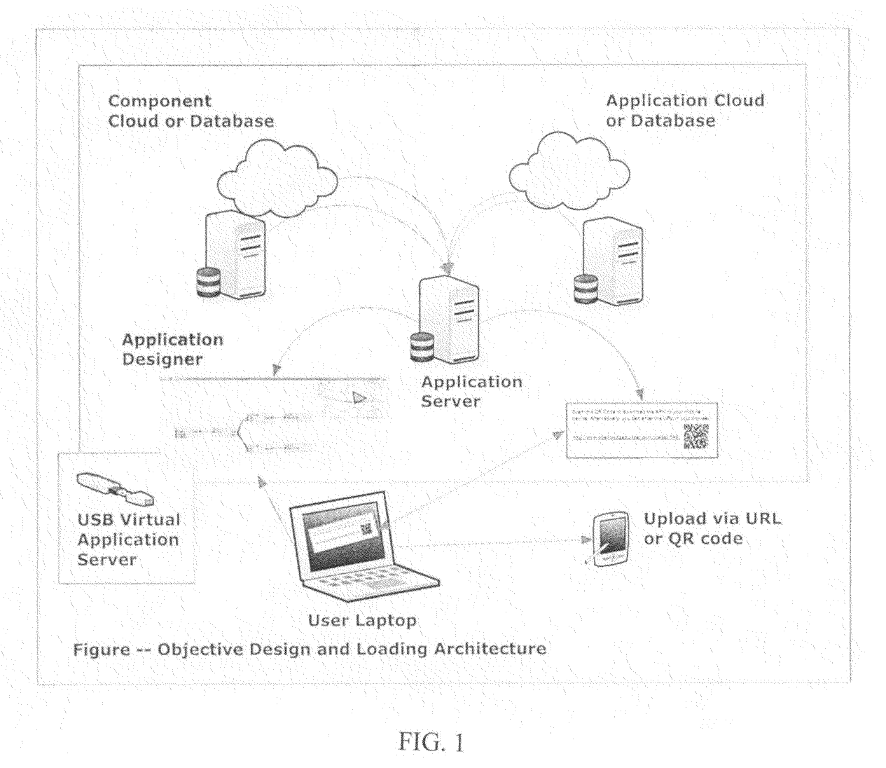

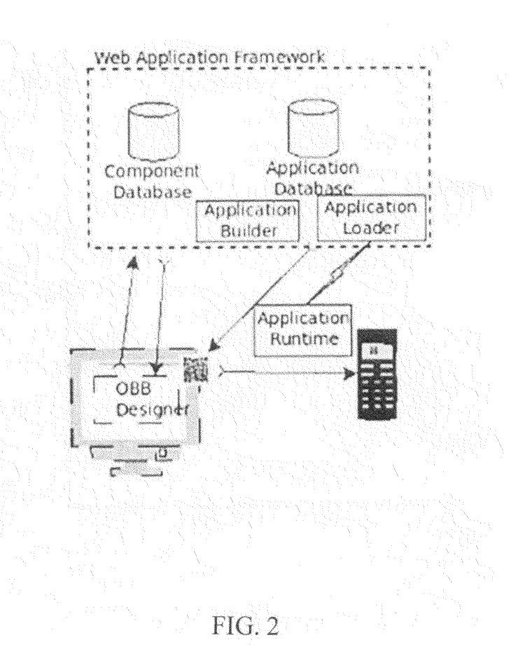

FIGS. 1-3 illustrate a system architecture in which devices may communicate with servers across networks. As in FIG. 1, a device, although illustrated as a User Laptop, may also include any communications device including, for example, a mobile phone, smart phone, computer, mobile device, laptop, tablet, terminal, mobile unit, receiver, transmitter, personal digital assistant (“PDA”), or any other computing device that includes a web browser. Though not pictured for simplicity, the system architecture may include additional devices which also communicate with the servers and with other devices. The device communicates with the Application Server for the creation of applications for execution on mobile devices. As in FIG. 2, the Application Server (or cloud or other technologies) may include a Component Database and Application Database or may communicate with them remotely. As in FIG. 1, the Application Server may be implemented as a USB Virtual Application Server.

The database memory may be any device capable of storing data including magnetic storage, flash storage, etc. The memory may store data and executable instructions corresponding to each of the operations described below. The Component and Application Databases may be located at the Application Server or at remote servers.

A processor may be configured to perform each of the operations described below based on executable instructions stored in memory. A processing unit may be any device capable of processing data including, for example, a microprocessor configured to carry out specific operations based on input data, or capable of executing instructions included in computer readable code.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, scripts, etc., that performs particular tasks or implement particular abstract data types. The program modules and functional processes discussed herein may be implemented using existing hardware in existing communication networks.

The Application Server includes Application Builder and Application Loader, which the web browser at the device may communicate with through receiving units and transmitting units at both the server and the device, where these units are configured hardware for receiving and transmitting data. A transmitting unit is a device that includes hardware and any necessary software for transmitting wired and/or wireless signals including, for example, data signals and control signals, via one or more wired and/or wireless connections to network elements in the communications network. A receiving unit is a device that includes hardware and any necessary software for receiving wired and/or wireless signals including, for example, data signals and control signals, in a communications network.

When starting the designer workspace, the web browser initially may make a request of the Application Server to receive component definitions from the Component database which populate the Component drop down menu. If opening a new application, no further data should be required. If requesting a saved application, the web browser may request to receive all data for the application which includes component instances, configurable properties, and connectors. These communications may be in a variety of formats (e.g., JSON). When saving or compiling an application, the current representation of the application including components, applications and data, may be converted into a variety of formats (e.g., JSON) and transmitted by the device to the Application Server. In other words, the designer workspace within the web browser at the device transmits the current state of the created or edited application to the Application Builder at the Application Server.

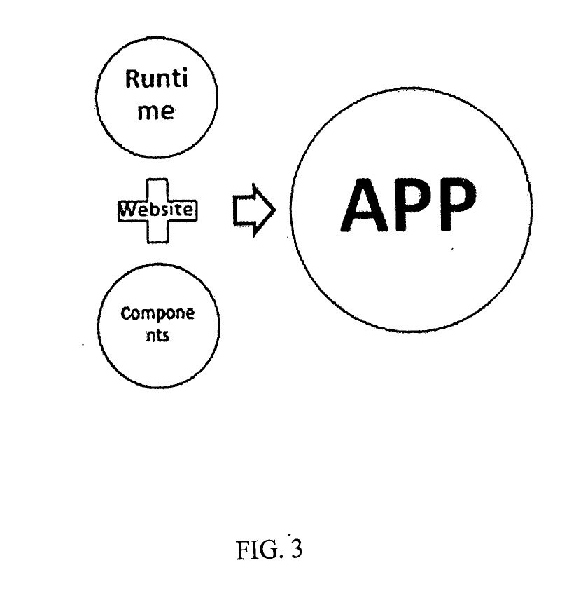

FIG. 3 illustrates that Application Builder may combine components with runtime code and create instantiations of runtime classes, for example ObbService and ObbActivity to create applications. Application Builder may generate a project (e.g., Android project), generate code, generate properties, and modify metadata in a manifest (e.g., Android manifest) of the APK. After Application Builder creates the APK, it transmits the APK to the Application Loader. Application Loader manages the APK within the file system of the server and the download of the APK to the mobile device for application execution. The APK may be saved to the mobile device and executed by users of the device. The system is compatible with various platforms and operating systems (e.g., Android, iOS).

Each device may be operated by users which login to the system. Login may take place according to known authorization and authentication mechanisms, such as username and password verification. Once successfully logged into the system, users may be presented with a menu of operations which may be performed.

FIG. 3 illustrates the way in which applications are built at the Application Server. Runtime classes combined with Components form the application. There may be six runtime base classes including Component base class, ObbActivity base class, ObbService base class, ComponentLink base class, ComponentOutputPort base class, and ComponentInputPort base class.

Component base class is the base class for all components in the system. It may be the interface for outside code to the Obb runtime. It may define lifecycle methods for the component (creation, destruction and other events) as well as relationships to the system such as the context within which the component is executing (which activity/service) or what view the component has and whether it is visible or not. Created components extend from this base class. There are two main methods, ‘receive’ and ‘triggerOutput’. A ‘receive’ method handles an input to the component and handles the input type you are expecting. The ‘triggerOutput’ method handles sending data out an output port.

ObbActivity is the base class for an activity in an application. An activity is a context within which components may execute and call lifecycle events on the components as they occur. Any views associated with its layout may be wired to the appropriate components. The activity may also start and bind to any necessary service and provide a simple application programming interface (API) to the service for showing dialogs. The ObbActivity base class is subclassed with generated code to implement the parts specific to a particular application.

ObbService is the base class for a service in an application. A service is a context within which components may execute and call lifecycle events on the components as they occur. Calls from the activity are handled to register views for components. This class is subclassed with generated code to implement the parts specific to a particular application.

ComponentLink is the base class that connects two component ports. When a component calls triggerOutput, the appropriate port may call ‘send’ on each attached component link to forward the data to the input port on the other side.

ComponentOutputPort connects component links to a component. It has a method called ‘broadcast’ that is invoked when a component calls the ‘triggerOutput’ method. ‘Broadcast’ may invoke the ‘send’ method on each attached component link, which forwards the data to the other side of the link.

ComponentInputPort connects component links to a component. It has a method ‘receive’ that may be invoked when an attached component link invokes its ‘send’ method. ‘Receive’ may pass the data from the component link to the component.

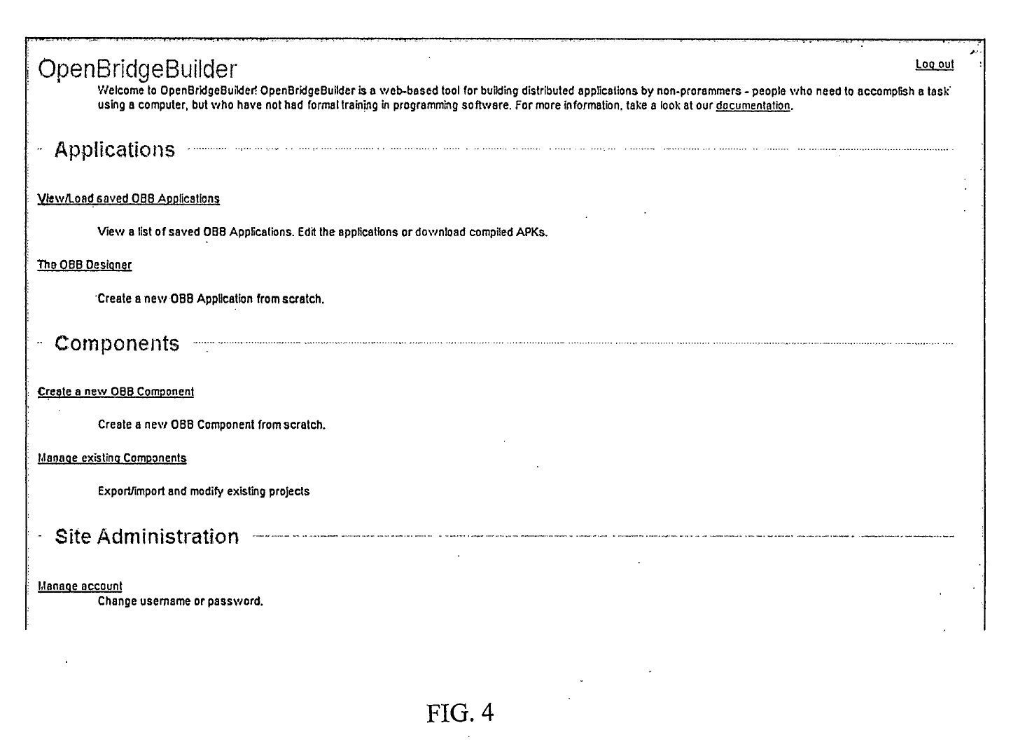

FIG. 4 illustrates an example of a menu for the system which may be accessible to the user after login. The system may provide a user the ability to create a new application. The system may provide the user the ability to view a list of all applications, download compiled application software package files (e.g., Android APK) for distribution and installation on mobile devices, and/or edit saved applications. The system may also allow the user to create new components, download existing component source code for editing and subsequent upload. User may also manage account settings and logout of the system.

### 2. Creating New Applications

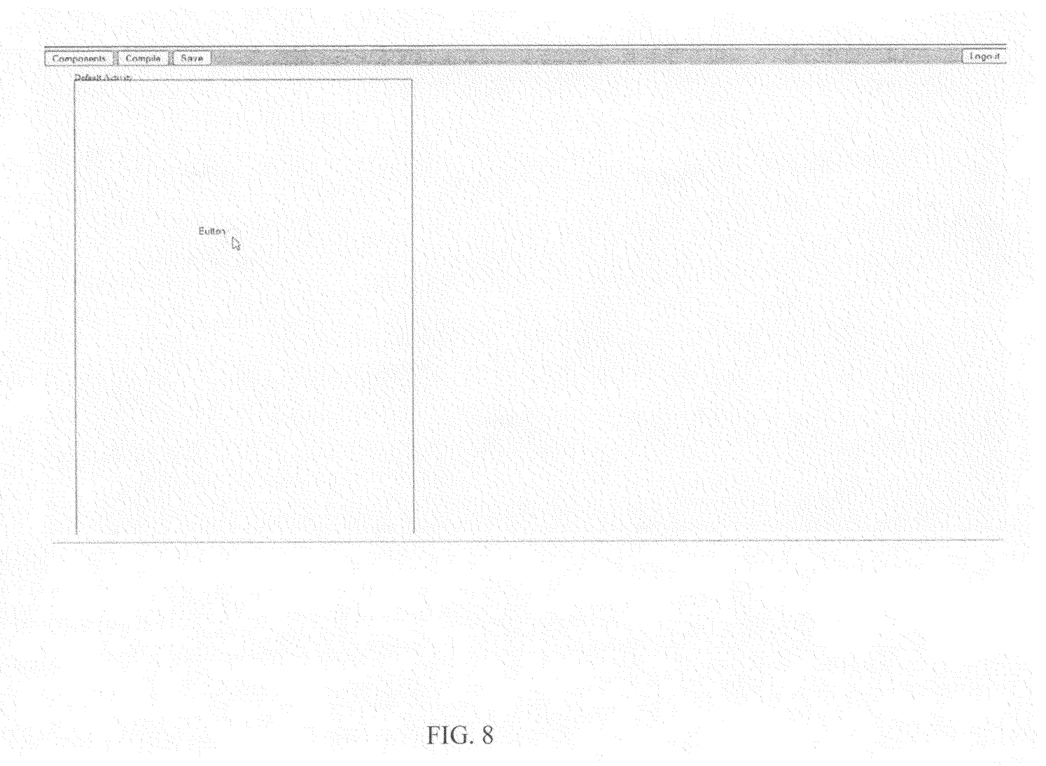

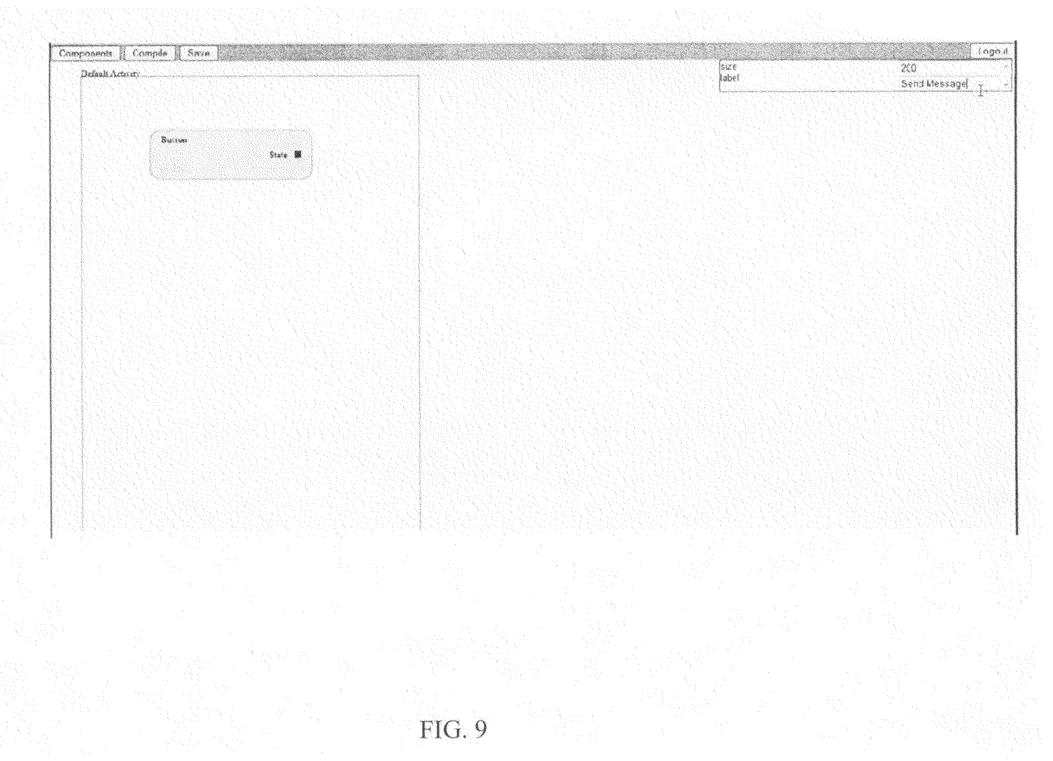

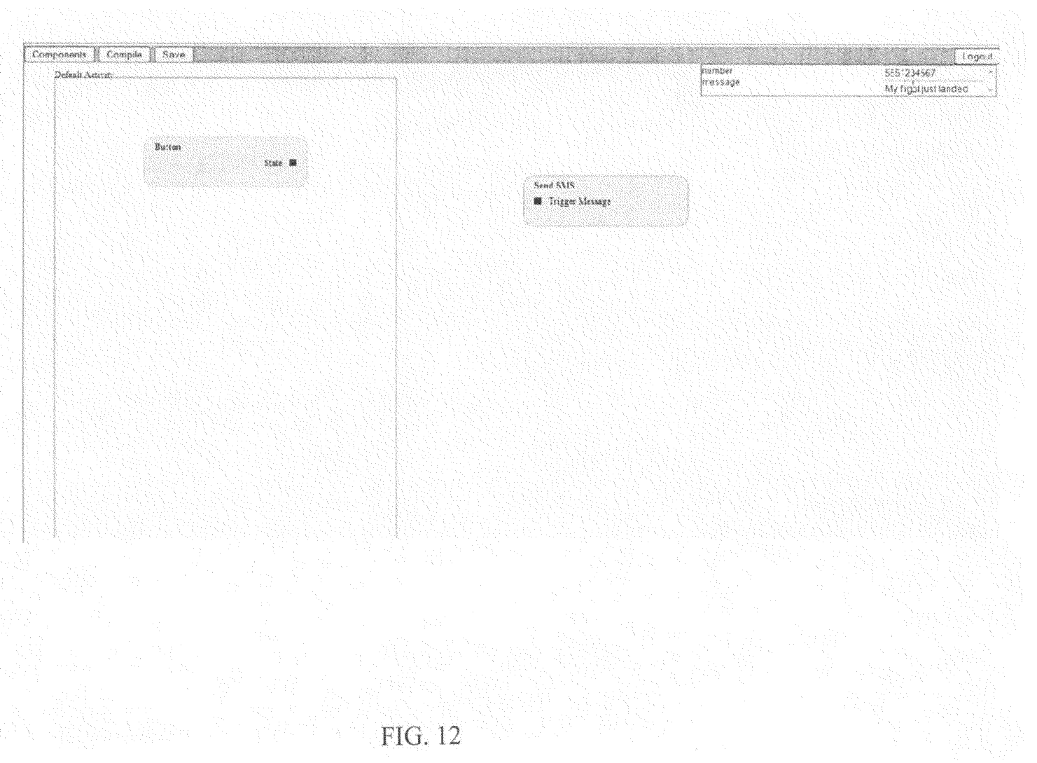

FIG. 8 illustrates an example of a designer workspace which is used to create a new application. The designer workspace may consist of a default activity window and a canvas area. The default activity window is the location components are placed in the designer workspace if the component will be displayed on the mobile device screen upon application execution (e.g., toggle, GPS map), as shown in FIG. 9. Otherwise, components which will not be displayed on the mobile device screen upon application execution should be dragged outside of the default activity window which is called the canvas area (e.g., an accelerometer is not displayed so is placed in the canvas area), as shown in FIG. 12. Once a component is dragged into the designer workspace, it may be moved to a different location within the designer workspace at any time. However, only components which are displayed on the mobile device screen at application execution may be moved into the default activity window. A user may move the position of the default activity window within the designer workspace by clicking the default activity window and dragging it to the desired location. The designer workspace may also allow a user to select a tab to view the appearance the layout of the components as they would appear on the mobile device at application execution.

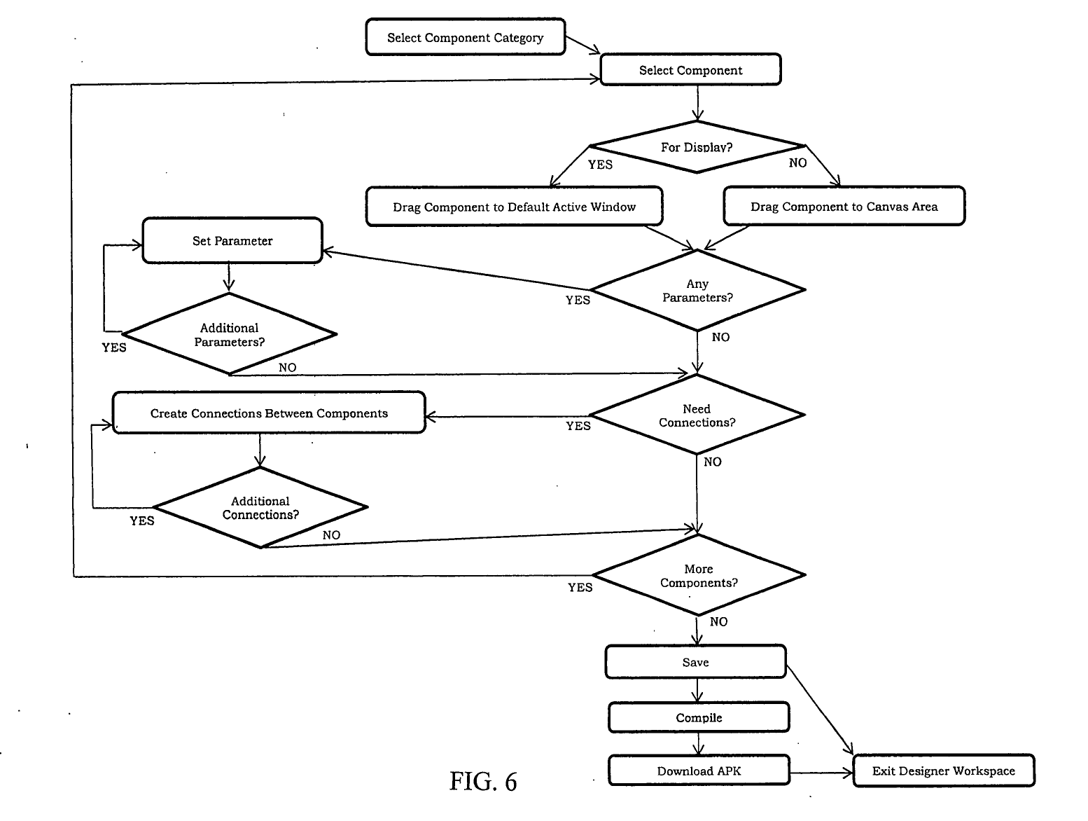

FIG. 6 illustrates steps which may be involved in creating a new application. Creation of new applications includes selecting components, dragging components to the appropriate region of the designer workspace depending on whether the component is displayed on the mobile device screen at time of application execution, setting parameters of components, creating connections between components, saving the application, compiling, and downloading an APK for installation on a mobile device for execution. The steps of selecting components, dragging components to the appropriate region of the designer workspace, setting parameters of components, creating connections between components, and saving the application may be performed in any order.

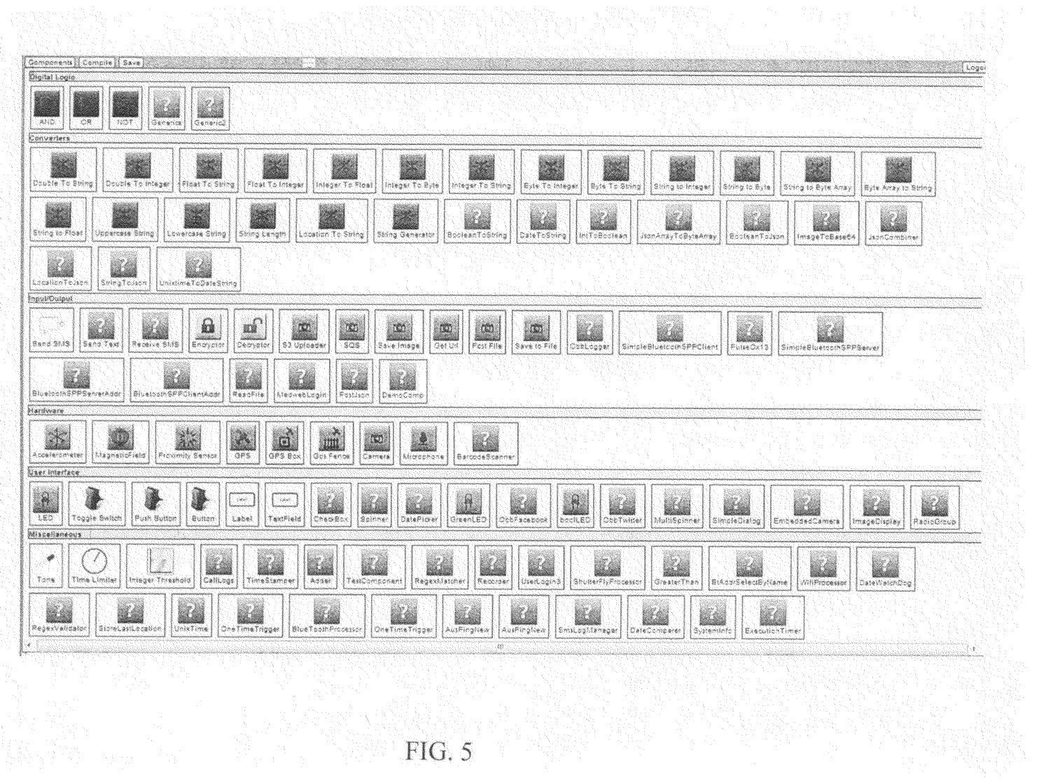

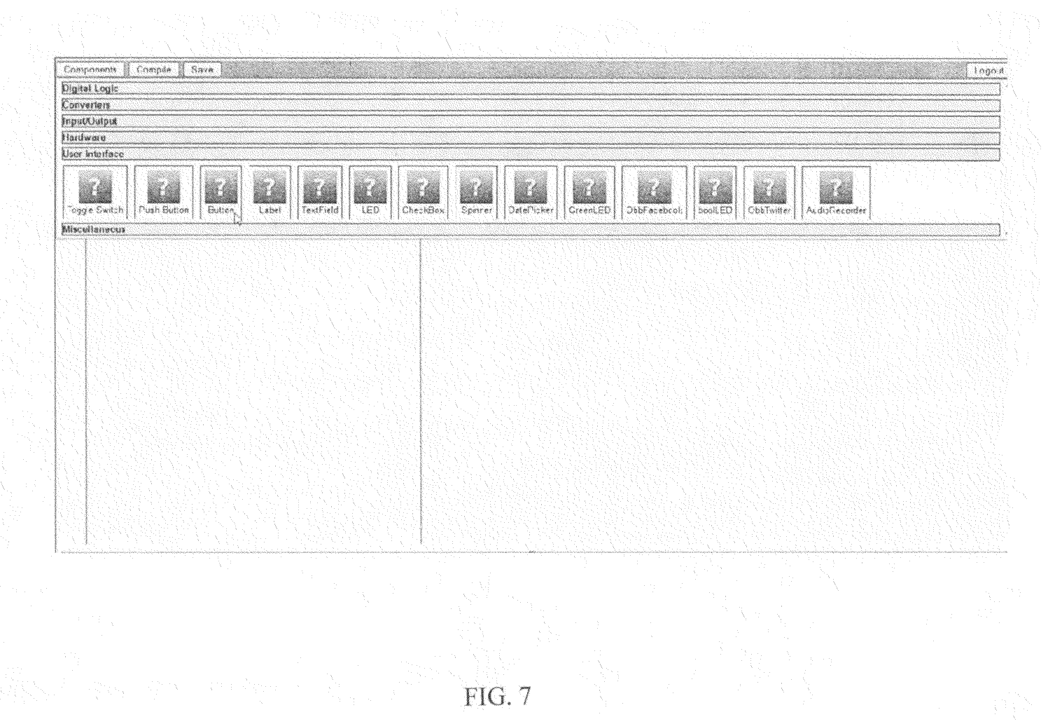

In order to create an application within the designer workspace, a user may first select components by selecting the Components button. Selecting the Components button may expand a drop down list of component categories. Component categories may include Digital Logic, Converters, Input/Output, Hardware, User Interface, and Miscellaneous, as shown in FIG. 5. Selecting each component category in the drop down listing may expand or collapse that component category to further list the components within that component category. FIG. 5 illustrates all the component categories as expanded thus displaying all components within each component category. A user may select a component from this drop down menu by dragging the component from the drop down menu into the designer workspace, as shown in FIGS. 7-9. The component may be dragged into the default activity window only if is a component which will be displayed on the mobile device screen upon application execution (e.g., toggle, GPS map), as shown in FIG. 9. Otherwise, components which will not be displayed on the mobile device screen upon application execution should be dragged into the canvas area (e.g., accelerometer), as shown in FIG. 12. Once a component is dragged into the designer workspace, it may be moved to a different location within the designer workspace at any time. However, only components which are displayed on the mobile device screen at application execution may be moved into the default activity window. Once the component is dragged and placed in the designer workspace, the drop down listing of component categories may collapse such that only the Components button is displayed. The process of selecting a component may be repeatedly performed to obtain all components needed for the application being created, as shown in FIG. 6.

Selecting a component by clicking it in the designer workspace may display a properties box as shown in FIG. 9. A user may enter property values in the properties box for that selected component. When additional components are dragged into the designer workspace, the properties box for the previously selected component already in the designer workspace may continue to display, until such point when the new component is finished being dragged into location and specifically selected, at which time the properties box may display the properties of the newly selected component. The process of setting properties, also referred to as configurable properties, may be performed for each component selected and for as many properties as the component has, as shown in FIG. 6.

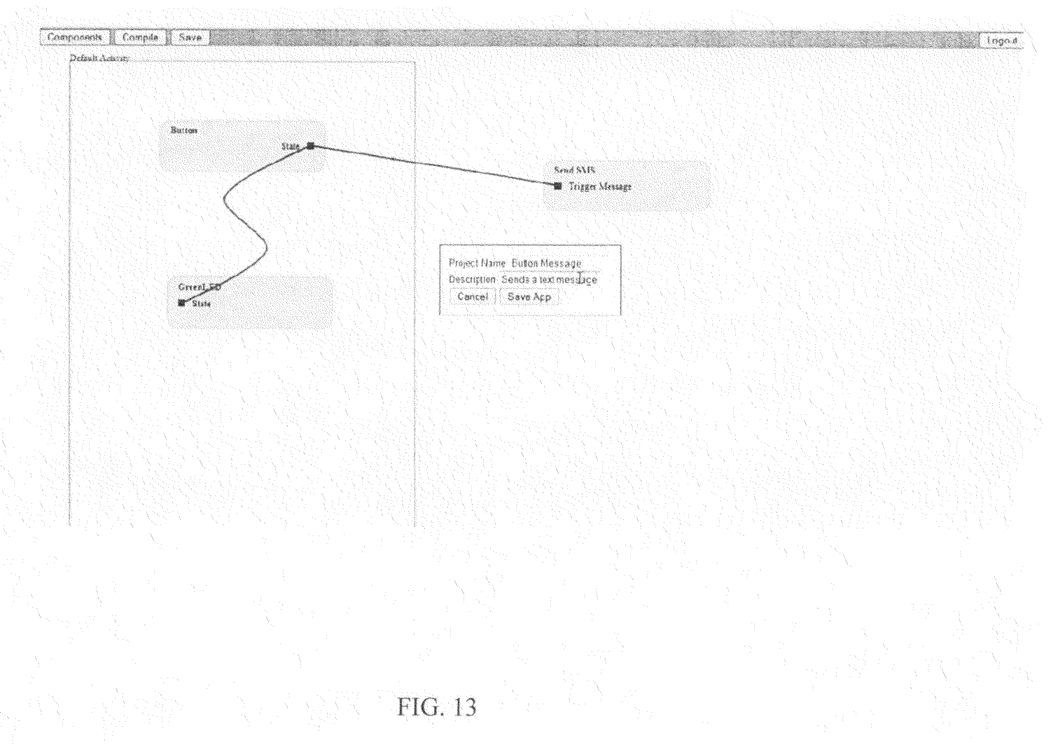

Relationships, also referred to as connections, between components are created by selecting an output of one component and an input of another component and forming a line representing the connection as shown in FIG. 13. If the input and output are incompatible, an error message may appear in the designer workspace, for example in the bottom left of the screen. A connection may be selected and thereafter the shape of the connection may be changed from straight line, curved line, and/or angled line. Once the connection is selected, a connection may be deleted by pressing the delete key on the keyboard. The process of creating connections between components may be performed repeatedly for each component as shown in FIG. 6.

The steps in FIG. 6 may be performed in any order and a user may save the progress of the application at any step. For example, connections between components may be created before all components are dragged into the designer workspace and before parameters are set.

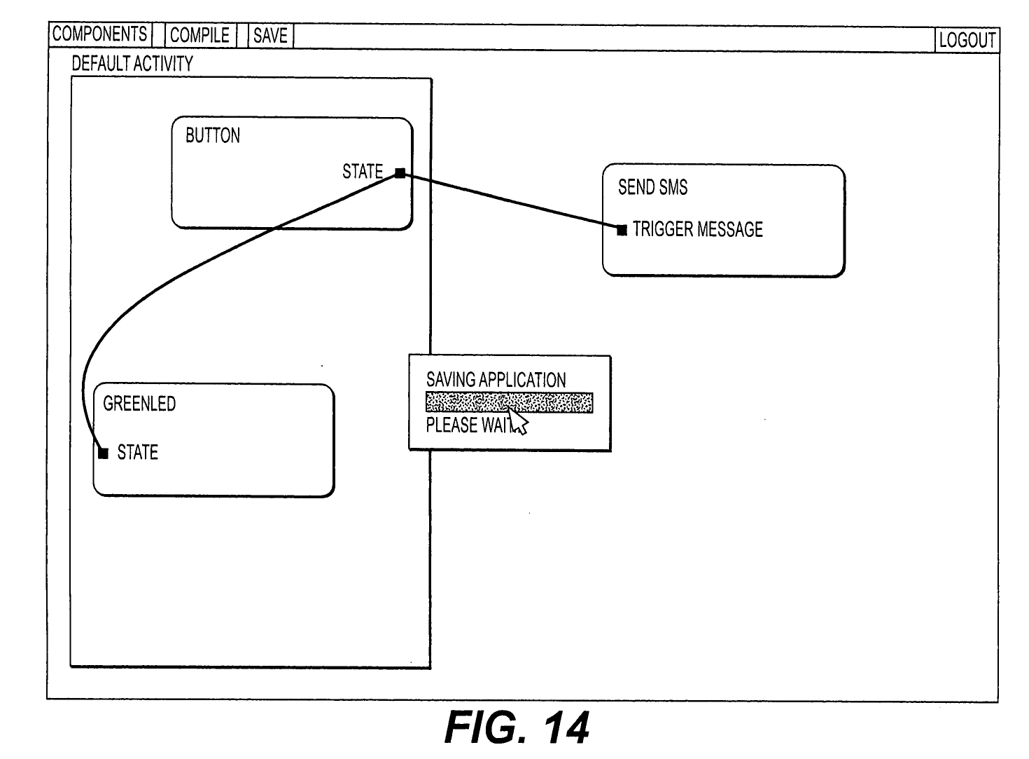

A user may save the progress of the application at any time, and thereafter continue selecting components and setting parameters, compile, or exit the designer workspace. When saving an application, a user may be prompted to enter a Project Name and Description, as shown in FIG. 13. While the system saves the application, a prompt may display to the user stating for example “Saving Application Please Wait” as shown in FIG. 14. Once saving is complete, a prompt may appear indicating “app Saved” to which the user may select an OK button.

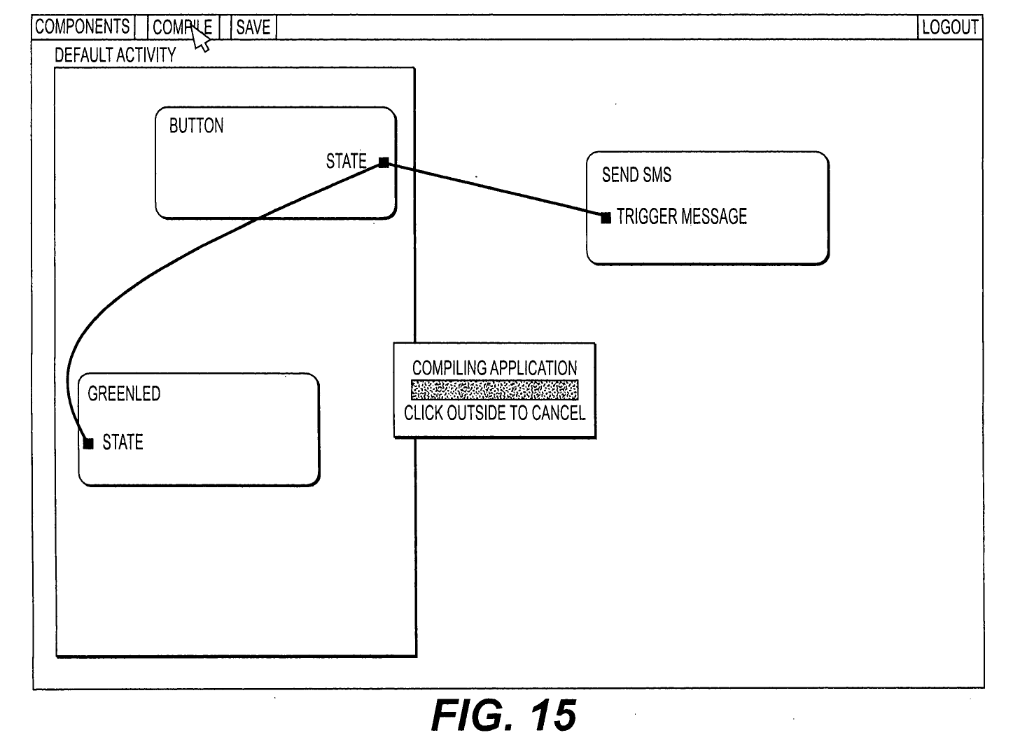

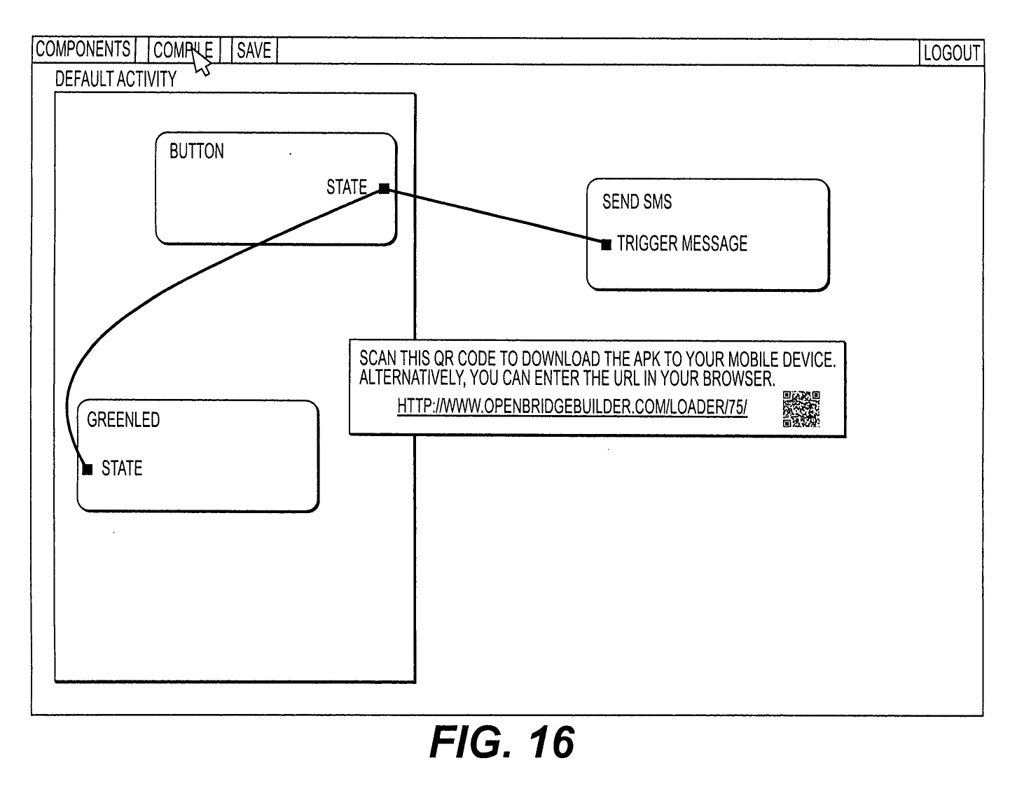

A saved application which is finished being created may be compiled by selecting the Compile button. The Compile button may cause the Application Server to create an APK. Attempting to compile an unsaved application may prompt the user to save the application before compiling takes place. While the system compiles the application, a prompt may display to the user stating, for example, “Compiling Application Click outside to cancel”, as shown in FIG. 15. Once compiled, a prompt may be displayed to the user to download the APK. For example, download of the APK may be performed by displaying a QR Code and/or a URL, as shown in FIG. 16. A URL may be pasted into a web browser of a mobile device and/or a QR Code may be scanned by a mobile device. Alternatively compiling may occur within a web browser such as that used to access the designer workspace.

A user may also select a Manage Account button to view or edit account settings. A user may select the Logout button to exit the system. All buttons, prompts and boxes described herein may be located in various locations in the designer workspace, including, but not limited to, the top left, top right, left panel, and/or right panel of the designer workspace.

### 3. Example

### Creating a Button Message Application

Creating an application called “Button Message” is a simple example to illustrate application creation using the designer workspace. Button Message may send a text message to another mobile device phone number when a button is pressed. For purposes of illustration, an onscreen LED may also display so that one may see when the button is pressed. For example, this simple application may be useful to easily notify family that your flight has landed. In this case the text message may be “My flight just landed, see you soon”.

As in FIG. 7, selecting the Components button and then the User Interface component category may display the components available. As in FIGS. 7-9, the Button component is selected and dragged to the Default Activity window because the Button component is displayed on screen at application execution. The location of the component placed within the Default Activity Window may determine the location of the visible component as it will appear on the screen of the mobile device at application execution. For example, dragging the button component to the top of the default activity window may cause the button to appear at the top of the screen of the mobile device.

FIG. 9 illustrates setting the properties of the Button component. When the button component is selected within the default activity window, a properties box may display in the upper right corner of the designer workspace. For example, for the button component, label refers to the text that appears on the button and size refers to the size of the button in the application. In FIG. 9, for example, the label may be set to “Send Message” and the size may be set to 200.

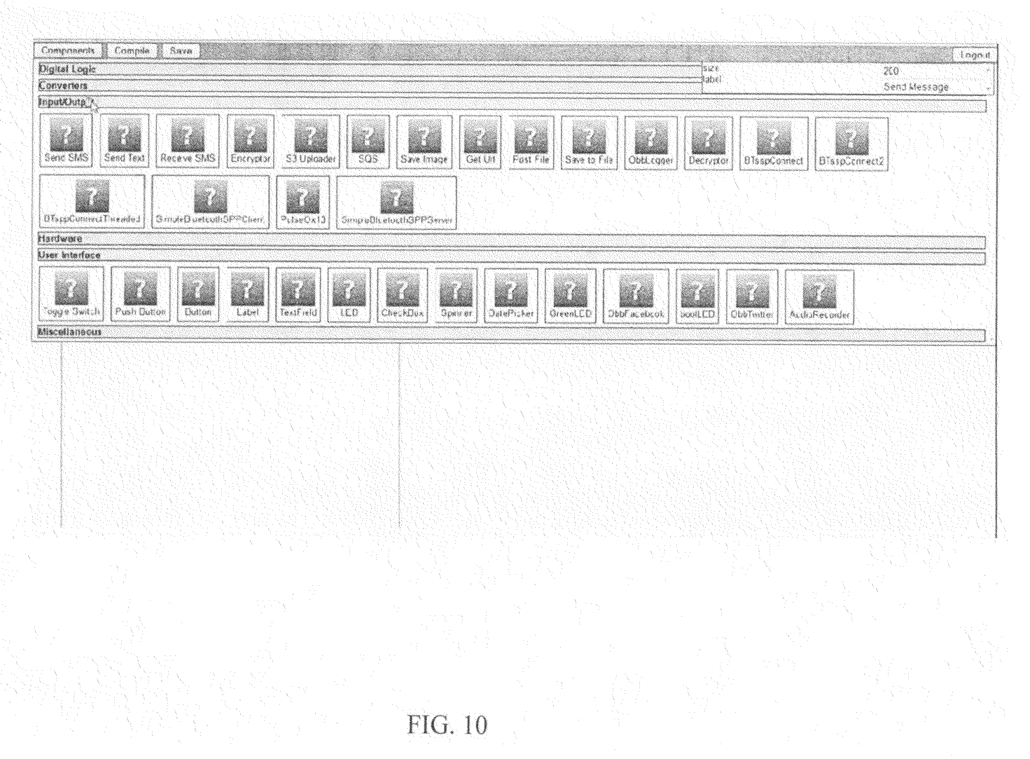

FIGS. 10-12 illustrate adding another component, such as the Send SMS component to the Button Message application. The Component button and next the Input/Output component category may be selected, and the Send SMS component may be selected and dragged into the canvas area of the screen. The Send SMS component is placed on the canvas, because it will not be seen on the screen of the mobile device at application execution. To move a component, the component may be selected and dragged to a new location. To delete a component, the component may be selected and the delete key on the keyboard pressed.

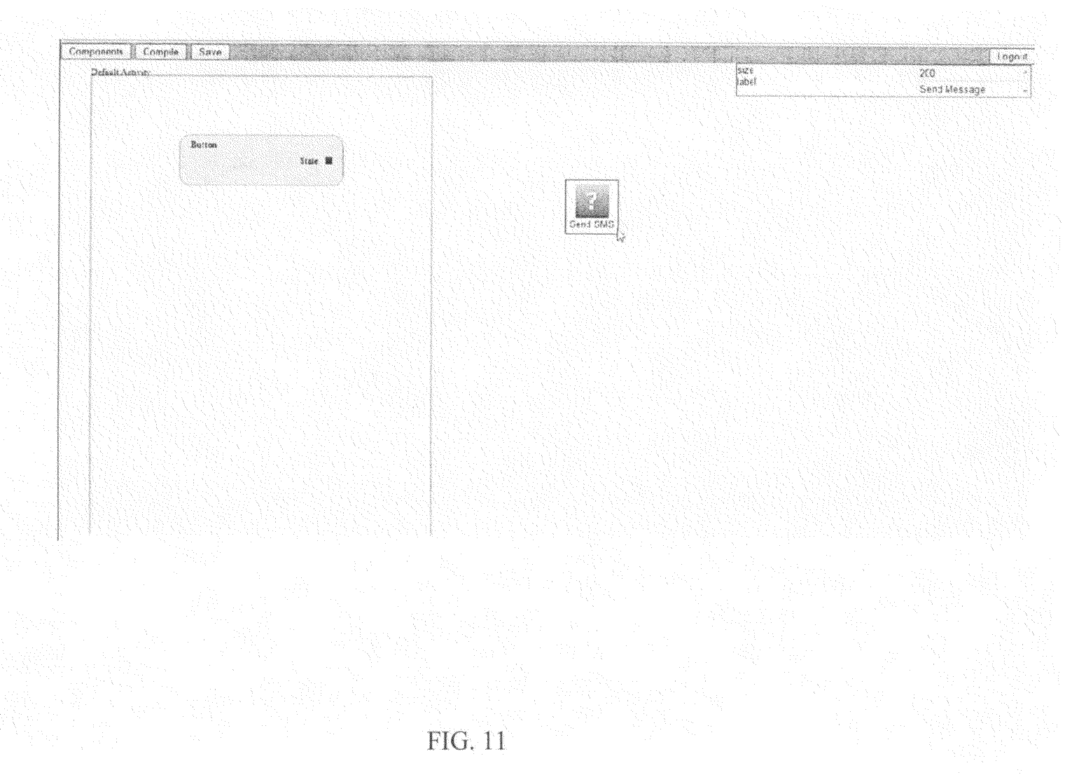

FIG. 12 illustrates the properties box of the designer workspace which displays when the SMS component is selected in the canvas. The properties box for the SMS component shows a number property and a message property which in FIG. 12 for example is set to a phone number 5551234567 and “My flight just landed see you soon” respectively. The properties box may continue to display the properties of the previously selected component, in this case the Button component, while the new component Send SMS is dragged into the designer workspace, as shown in FIG. 11. Once the new component is in place and selected, the properties box may display the properties of the new component, as in FIG. 12.

FIG. 13 illustrates creating a connection between the Button component and the Send SMS component. For example, the input port of the Send SMS component is selected and the output port of the button component is next selected to create a connection between these two components. The connection indicates that the Send SMS component is to be triggered by pressing the button.

FIG. 13 also illustrates the GreenLED component being added by selecting the Components Button and the User Interface component category. The GreenLED component may be selected and dragged to the Default Activity window since it will be displayed on screen of the mobile device upon application execution. A connection between the output of the button component and the input of the GreenLED component may be created. The connection indicates that a green light will display when the button is pressed.

Once all components have been selected, properties for each component have been set, and connections between components have been created, the created application should be saved before compiling. FIG. 14 illustrates saving the Button Message application by selecting the Save button. A user may be prompted to enter a Project Name and a Description for the application being saved. As in FIG. 14, “Button Message” and “Sends a text message” are entered for example at this prompt. The prompt may have a Cancel and Save App button that are selected to cancel saving or to save once the project name and description are entered. A prompt may subsequently appear that indicates for example “Saving Application, Please wait” while the saving takes place. Once saving is complete, a prompt may appear indicating “app Saved” to which the user may select the OK button to make the prompt disappear.

A saved application may be compiled to download an APK. FIG. 15 illustrates selecting the Compile button. Selecting the compile button will finalize the application and may display a prompt indicating “Compiling Application Click outside to cancel” as in FIG. 15. When compiling is complete, a prompt may display allowing download of the APK. FIG. 16, illustrates for example that the prompt may state for example “Scan this QR Code to download the APK to your mobile device. Alternatively, you can enter the URL in your browser.”

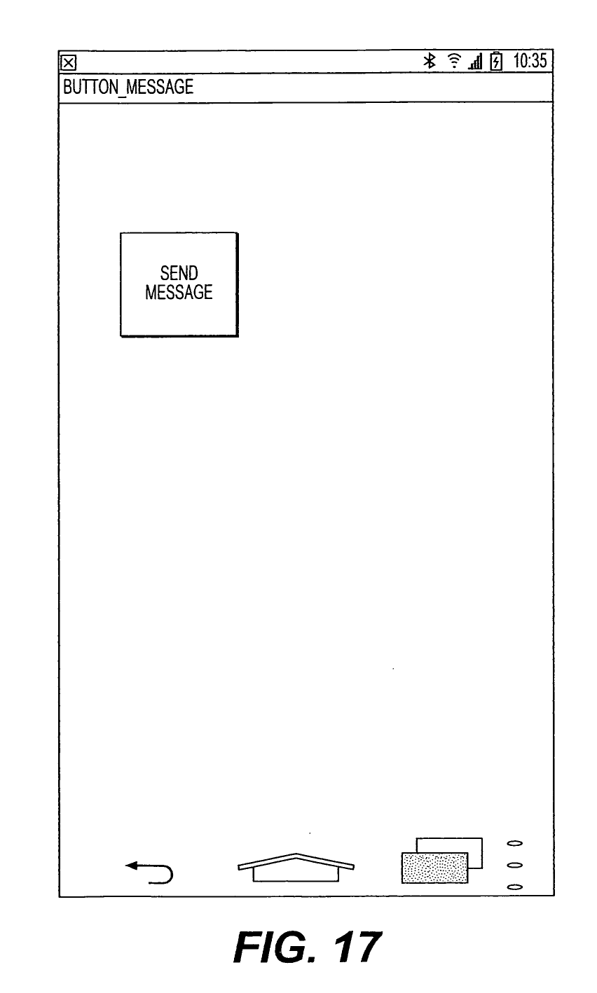

FIG. 17 illustrates the mobile device screen upon application execution. The rectangular box stating “Send Message” is the button, created from the button component in which “Send Message” was the label entered for the property. The property size was set to 200 which refers to the number of pixels the button takes up on the screen. The button may be displayed in the upper left corner because of where it was positioned in the Default Activity window during creation.

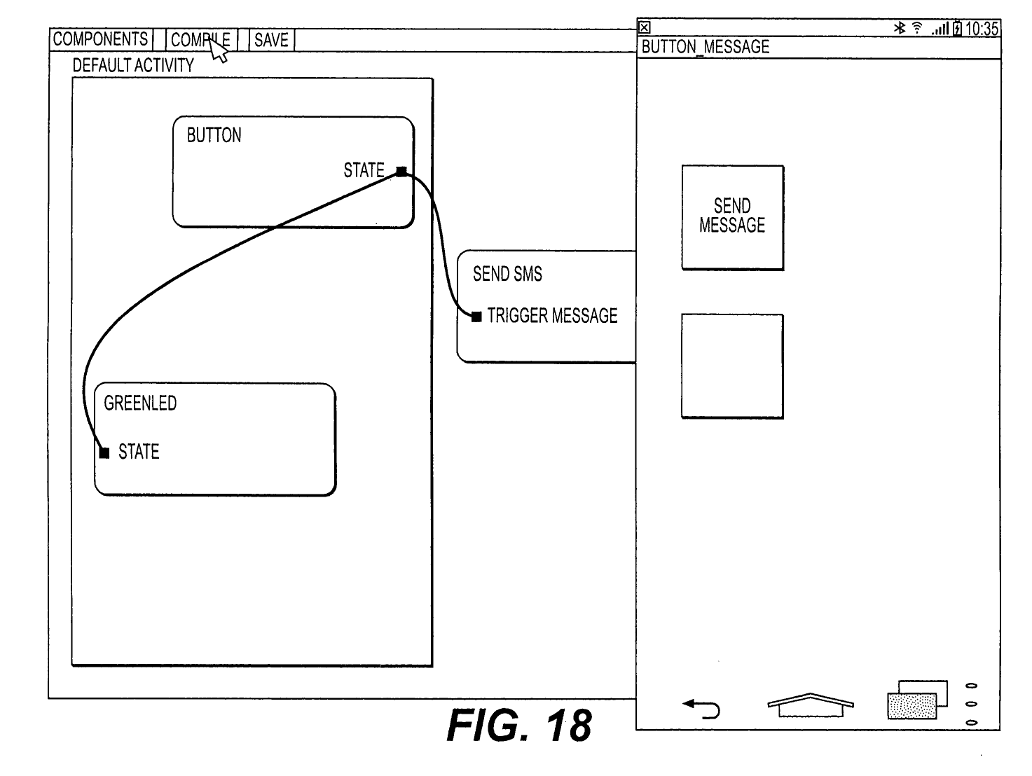

FIG. 18 illustrates the mobile device screen with a green light because the LED was also placed inside the Default Activity window with a size of 200. The LED is illuminated once the button is pressed. The LED was placed just below the button inside the Default Activity window, thus it appears just below the button in the executed application, as shown in FIG. 18. When finished using the application, a user may select the menu button on the mobile device and select “Quit”.

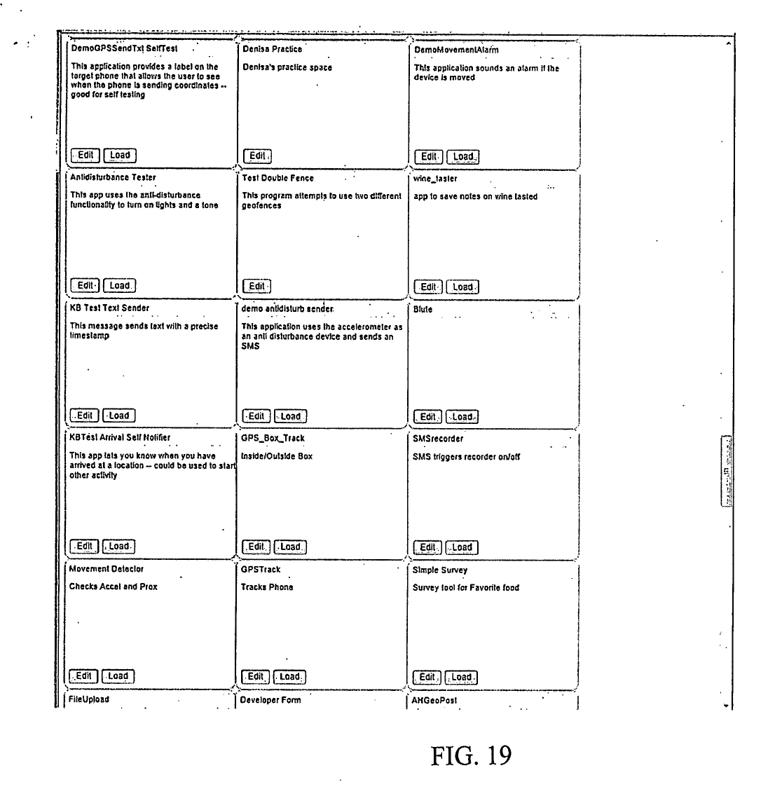

FIG. 19 illustrates a listing of saved applications in the system. The application name and description may be displayed along with an option to edit the application and/or download the application APK. The Load button allows a user to download the application APK and may only display if the application was previously compiled by a user in the designer workspace. A user may select the Edit button to open the application in the designer workspace so that the user may make any changes and/or select the Compile button within the designer workspace. Selecting the Compile button may now display the Load button for that application upon returning to the listing of all saved applications.

### 4. Example of Editing Saved Applications

### GPSTrack Application

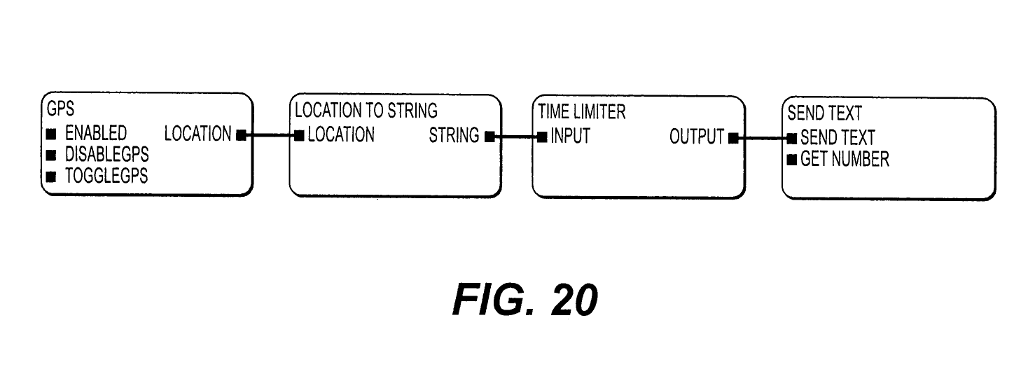

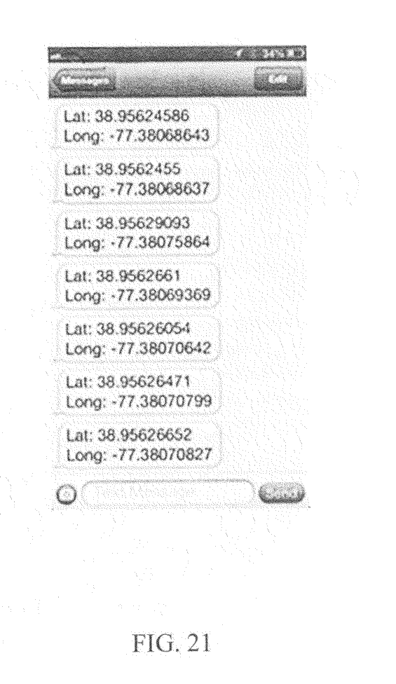

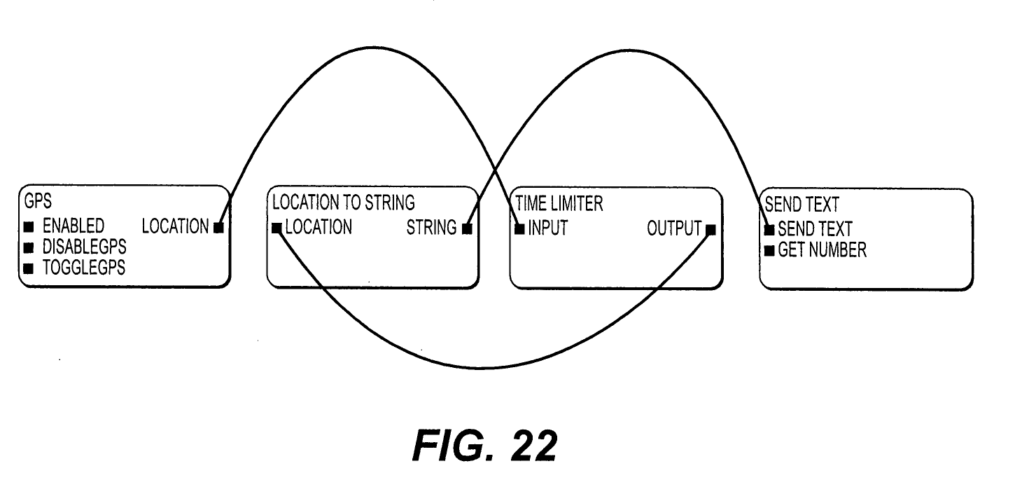

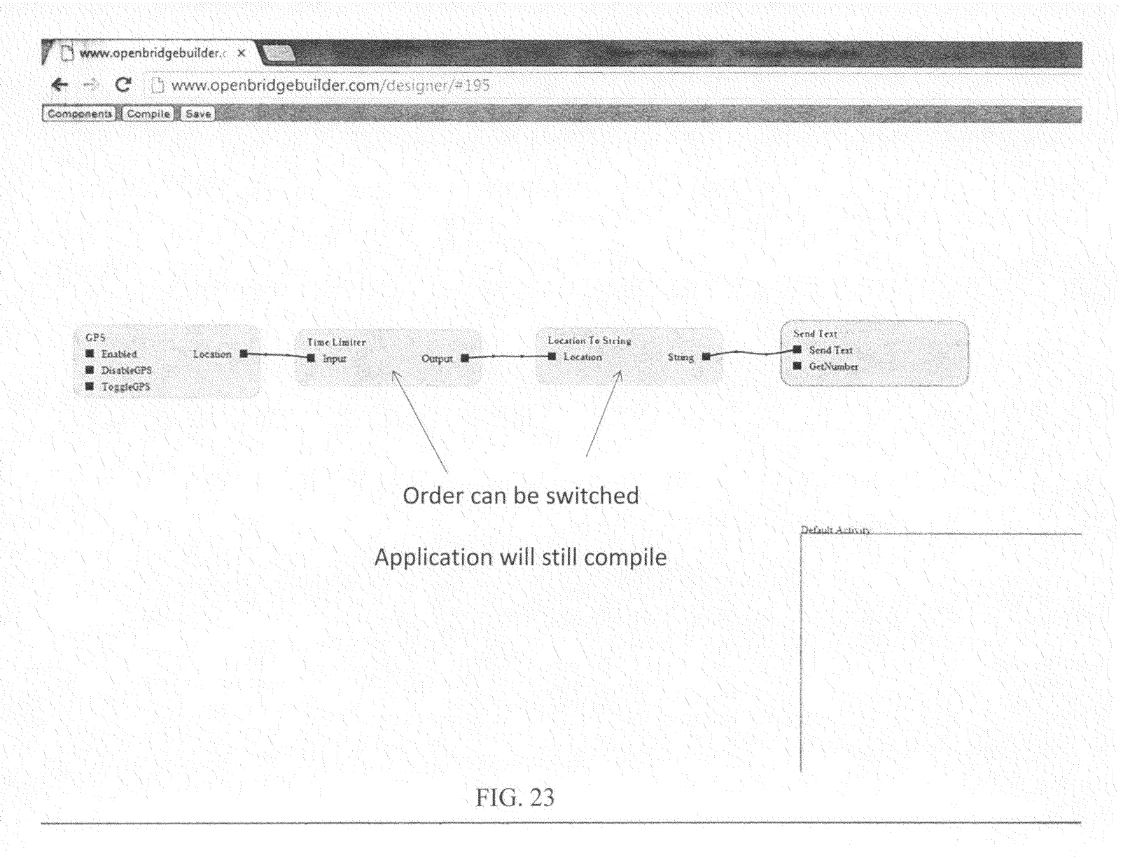

FIG. 19 illustrates GPSTrack as an existing application in the system. GPSTrack allows GPS location to be periodically sent from a mobile device as shown in FIG. 21. This existing application is discussed to illustrate the manner in which a user may edit a saved application. Selecting the Edit button in FIG. 19 for the GPSTrack application may open the application in the designer workspace as shown in FIG. 20. A user may change the application, for example by changing the order of component execution and/or changing the connections between components as shown in FIGS. 22-23. The user may then save the changes and compile the edited application.

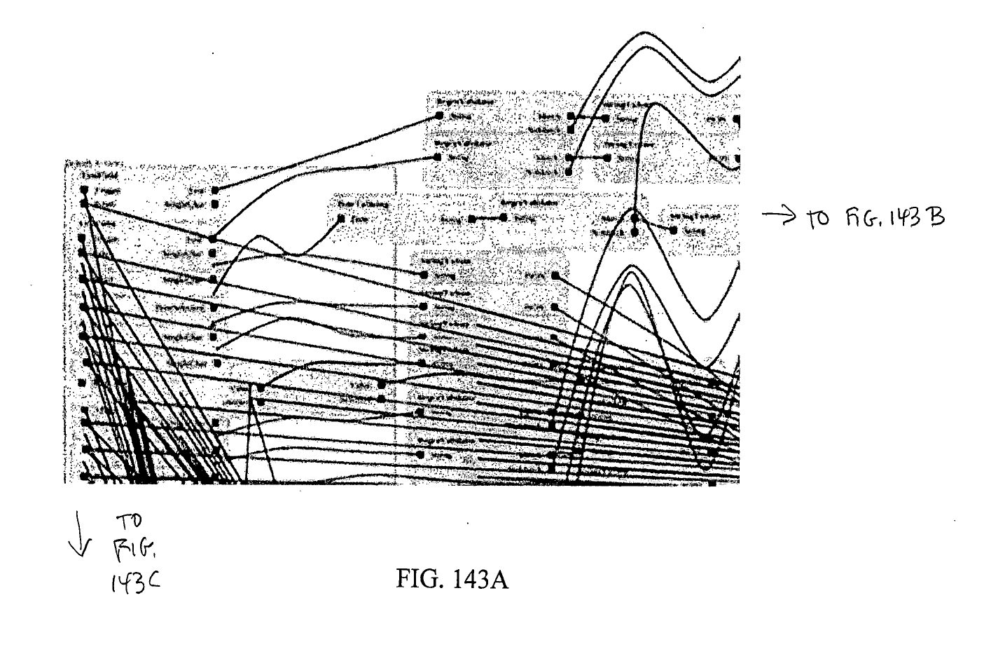

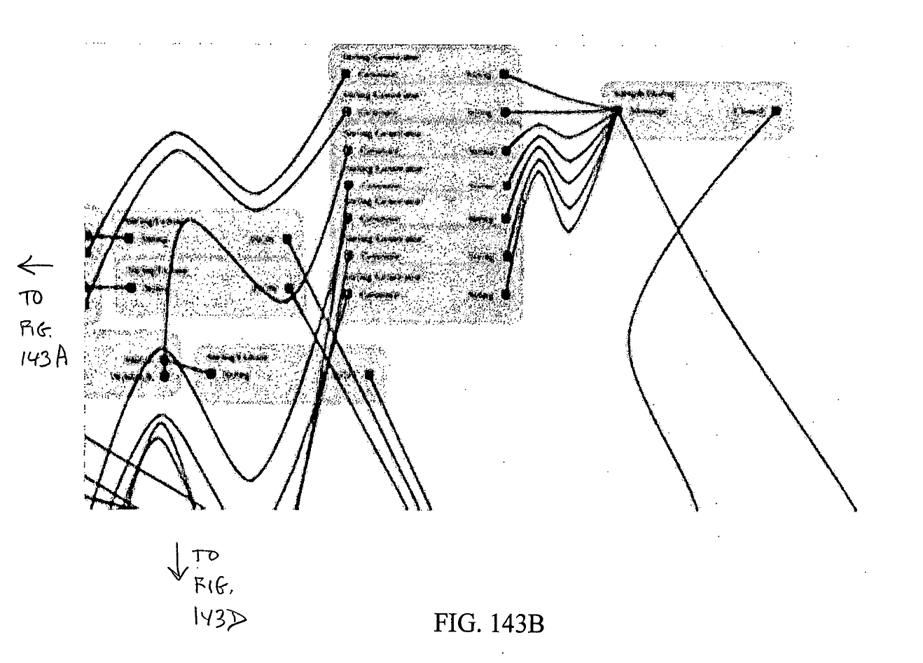

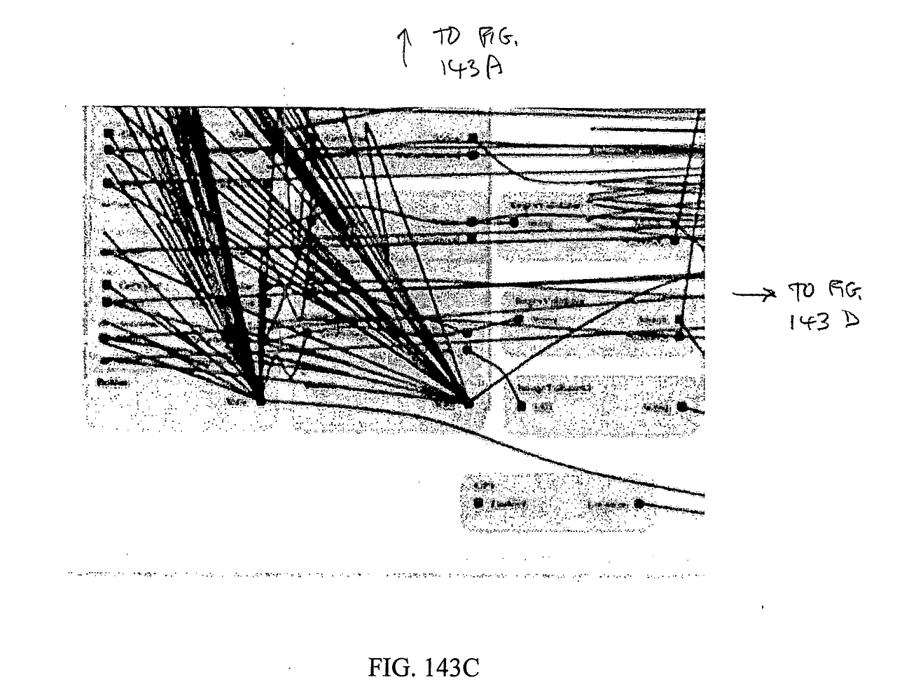

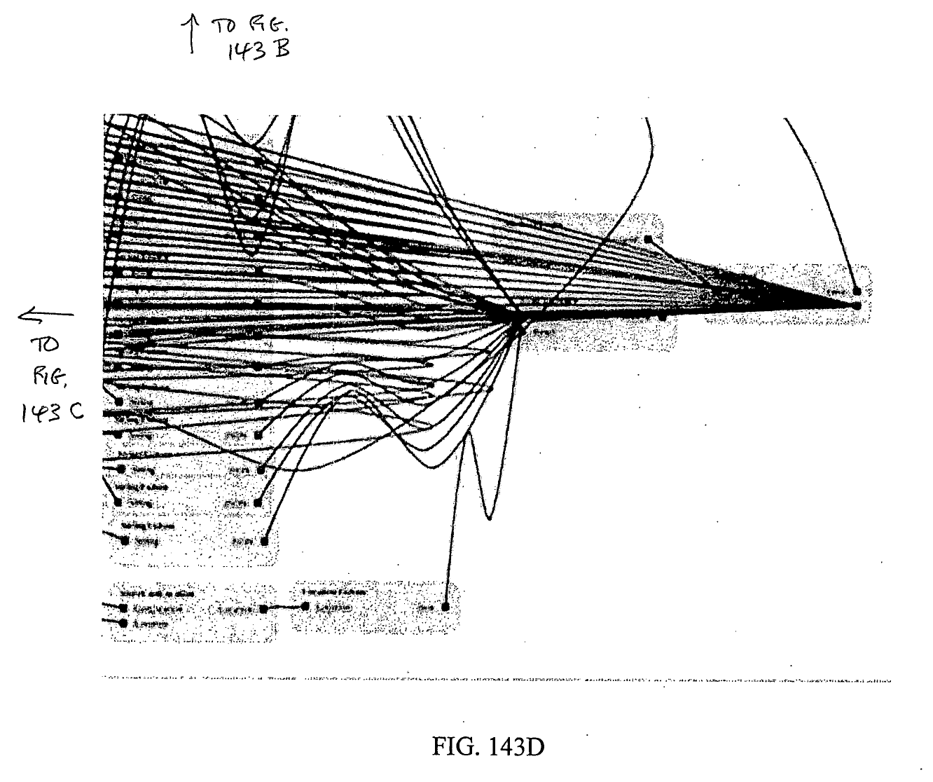

For example, by comparing FIGS. 20, 22, and 23, it may be observed that in FIG. 22, the order of LocationToString and Time Limiter components is not changed from FIG. 20, but the order of connecting them has changed. In contrast, in FIG. 23, the order of LocationToString and Time Limiter components is changed. Thus a user may have more than one approach that may yield the same result. In particular, when building or editing an application, components may be moved around (as needed) and new connections made. This flexibility makes it possible to create a visual layout of an application that assists in comprehending what the application is trying to achieve. As applications become more complex, this flexibility may become more important. One glance at the Medical Triage Application (FIG. 143) suffices to lend credence to that statement.

### 5. Creating Components and Editing Existing Components

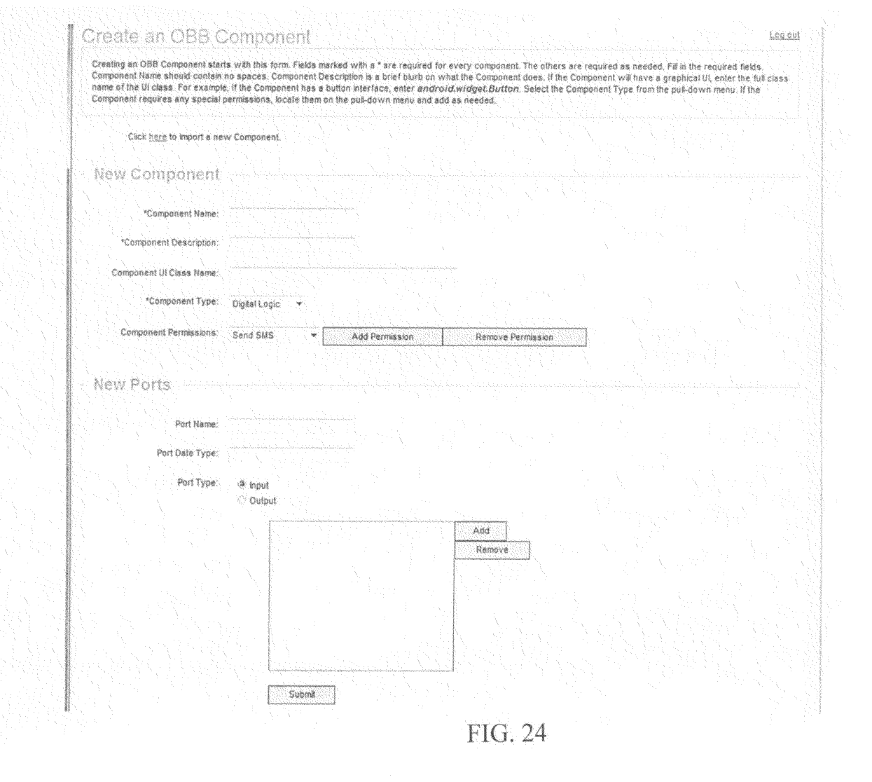

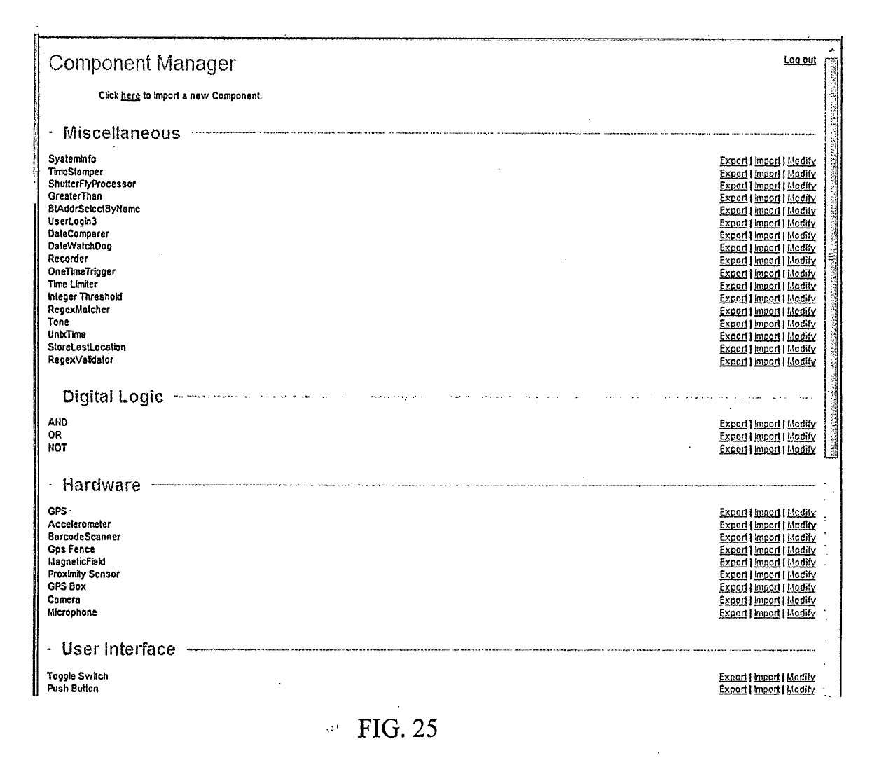

FIG. 24 illustrates the interface at which a user may create a new component. A Component Name, containing no spaces, and Description are first input by the user. If the Component will have a graphical user interface (UI), the user may enter the full class name of the UI class (e.g., for Android a new component with a button interface may enter Android.widget.Button). The component category is selected from the drop down list for Component Type. Component permissions may be added or removed from the drop down list (e.g., Send SMS, Receive SMS, GPS, Camera, Record Audio, Write SD card, Wake lock, Internet, Read Phone State, Read Contacts, Bluetooth, Bluetooth Admin, Access Wifi State, Change Wifi State, and Read SMS). One or more new ports may be created by entering the Port Name, Port Data Type, and Port Type (e.g., Input or Output). This interface creates the underlying structure for the new component only. To add functionality for the new component, a user may open the Component Manager, as shown in FIG. 25, select Export in order to download the source code file for the new component, add source code and then select Import to upload the source code for the new component.

FIG. 25 illustrates the Component Manager which displays a list of all components by component category. A new component created by the interface of FIG. 24 will also be newly added to the list. All listed components will give the user the ability to export, import, and modify the existing component. As discussed above, for newly created components, a user may select Export in order to download the source code file, add source code to impart functionality for the component and then select Import to upload the source code for the new component. Similarly, a user may select Export to download an existing component source code, edit the source code, then select Import to upload the changed source code for the existing component. The Modify button allows a user to edit an existing component's interface, as shown in FIG. 24.

Export and Import of component source code allows different instances of the system to operate on separate server implementations. For example, component source code on one server implementation may be exported and imported to a different server implementation (e.g., a virtual application server). Thus, there is no need to re-create a component. The Export button is selected from the server implementation where the component exists to download the source code for that component and Import is selected at the different server implementation to upload.

### 6. Example Components

### Generally

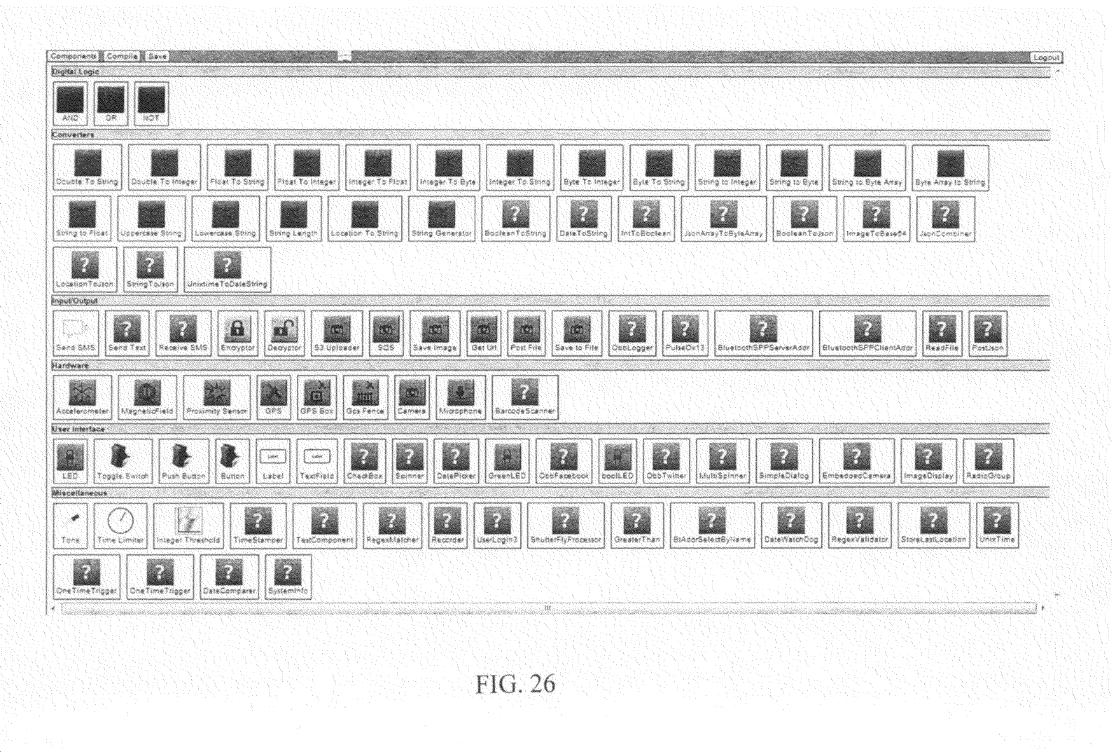

In some example embodiments, the system may include a plurality of components. These components may include, but are not limited to, logic components, converter components, input/output components, hardware components, user interface components, and miscellaneous components. FIG. 26 is a screenshot showing some example embodiments of the plurality of components.

### 7. Example Components

### Logic Components

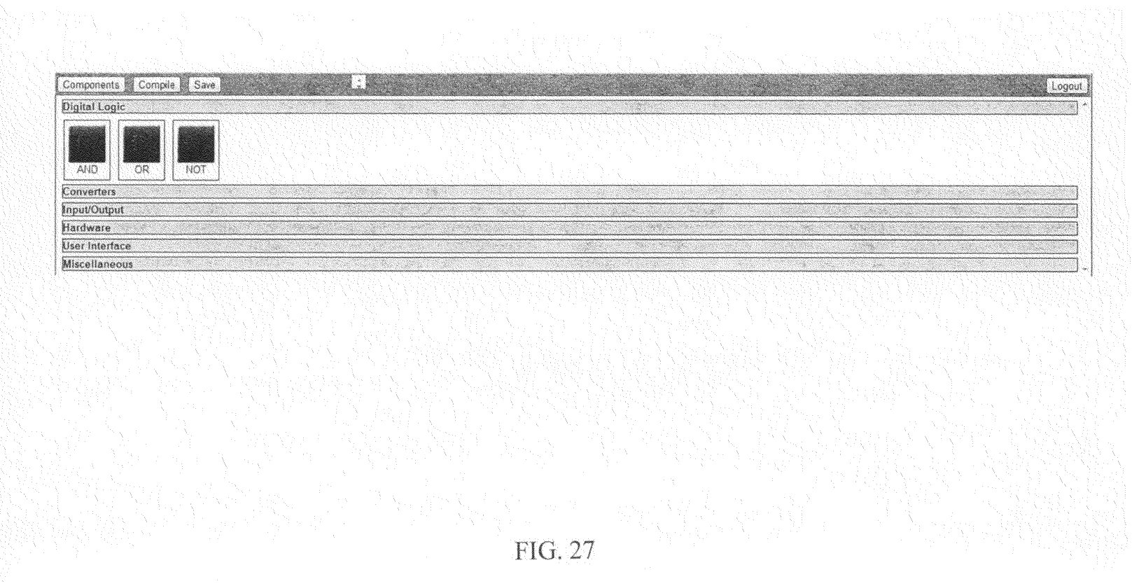

In some example embodiments, logic components may include, but are not limited to, “AND” components, “OR” components, and “NOT” components. FIG. 27 is a screenshot showing some example embodiments of logic components.

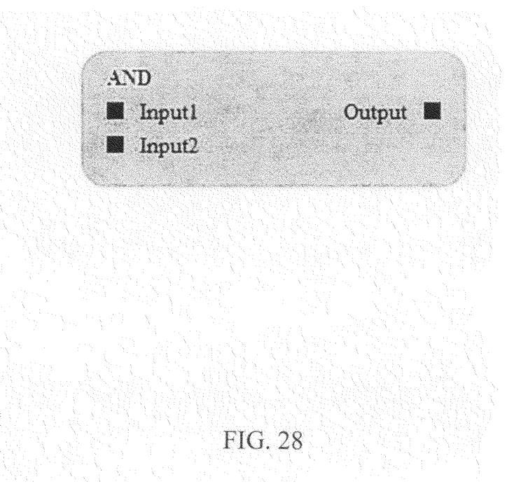

As show n in FIG. 28, “AND” components may include, for example, two input ports. These input ports may include, for example, “Input1” and “Input2”. Data input to “Input1” may be, for example, a “java.lang.Integer” data type. Data input to “Input2” may be, for example, a “java.lang.Integer” data type. As also shown in FIG. 28, “AND” components may include, for example, one output port. This output port may include, for example, “Output”. Data output from “Output” may be, for example, a “java.lang.Integer” data type.

When both values of the data input to “Input1” and “Input2” of “AND” components represent “true”, a value of the data output from “Output” of “AND” components may represent “true”. When one or both values of the data input to “Input1” and “Input2” of “AND” components represent “false”, a value of the data output from “Output” of “AND” components may represent “false”. “AND” components may operate according to truth tables for logical conjunction.

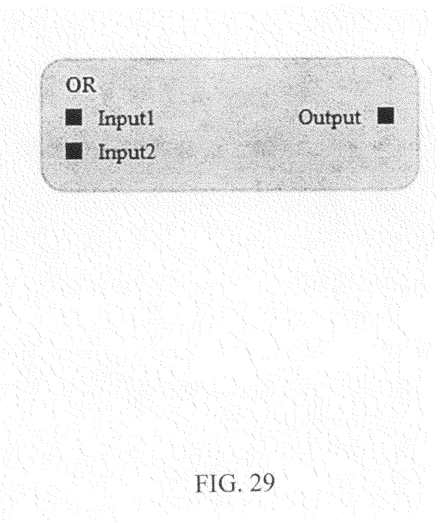

As shown in FIG. L3X, “OR” components may include, for example, two input ports. These input ports may include, for example, “Input1” and “Input2”. Data input to “Input1” may be, for example, a “java.lang.Integer” data type. Data input to “Input2” may be, for example, a “java.lang.Integer” data type. As also shown in FIG. 29, “OR” components may include, for example, one output port. This output port may include, for example, “Output”. Data output from “Output” may be, for example, a “java.lang.Integer” data type.

When one or both values of the data input to “Input1” and “Input2” of “OR” components represent “true”, a value of the data output from “Output” of “OR” components may represent “true”. When both values of the data input to “Input1” and “Input2” of “OR” components represent “false”, a value of the data output from “Output” of “OR” components may represent “false”. “OR” components may operate according to truth tables for logical disjunction.

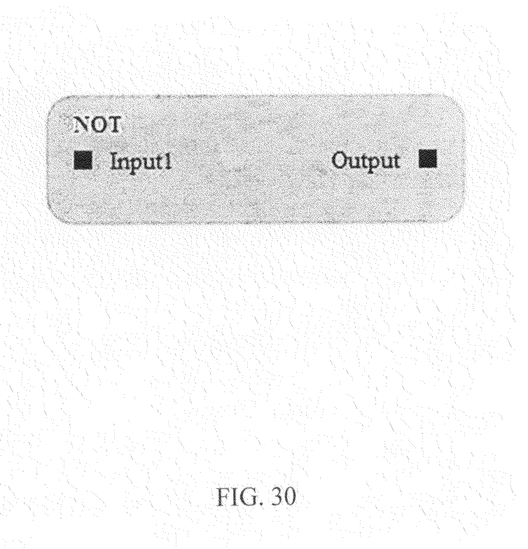

As shown in FIG. 30, “NOT” components may include, for example, one input port. This input port may include, for example, “Input1”. Data input to “Input1” may be, for example, a “java.lang.Integer” data type. As also shown in FIG. 30, “NOT” components may include, for example, one output port. This output port may include, for example, “Output”. Data output from “Output” may be, for example, a “java.lang.Integer” data type.

When a value of the data input to “Input1” of “NOT” components represents “true”, a value of the data output from “Output” of “NOT” components may represent “false”. When the value of the data input to “Input1” of “NOT” components represents “false”, a value of the data output from “Output” of “NOT” components may represent “true”. “NOT” components may operate according to truth tables for logical negation.

Logic components also may include, for example, “exclusive or” (“XOR”) components, “not AND” (“NAND”) components, “not OR” (“NOR”) components, and “exclusive not OR” (“XNOR”) components. Additionally, logic components may include, for example, “AND-OR-Invert” (“AOI”) components and “OR-AND-Invert” (“OAI”) components.

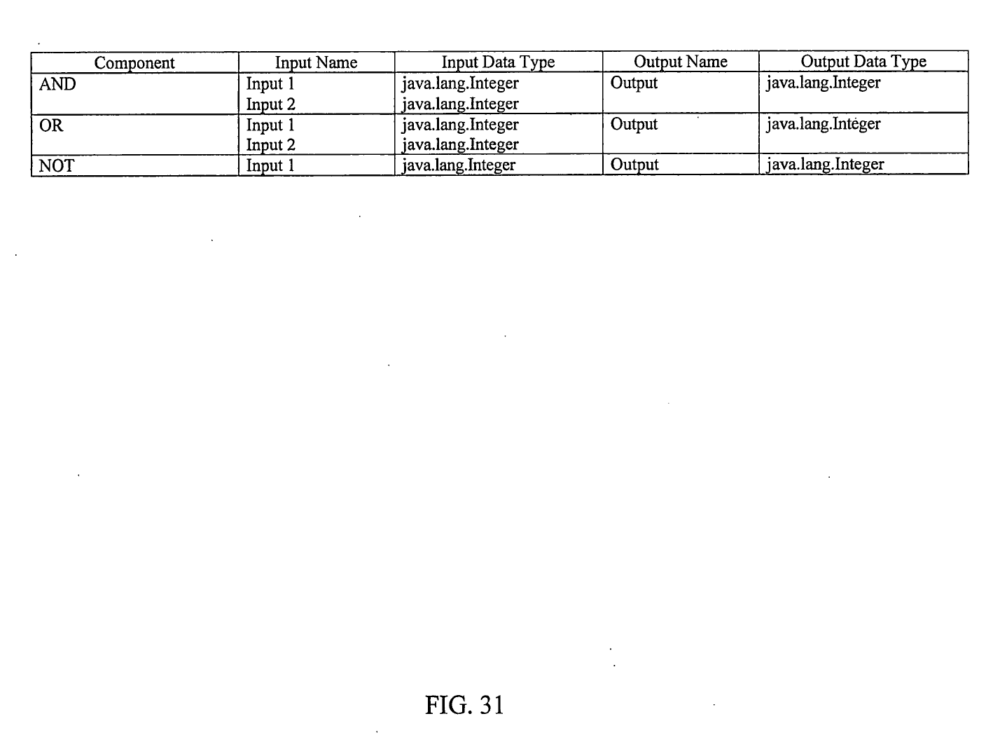

Related information regarding some example embodiments of logic components may be found in the table of FIG. 31.

### 8. Example Components

### Converter Components

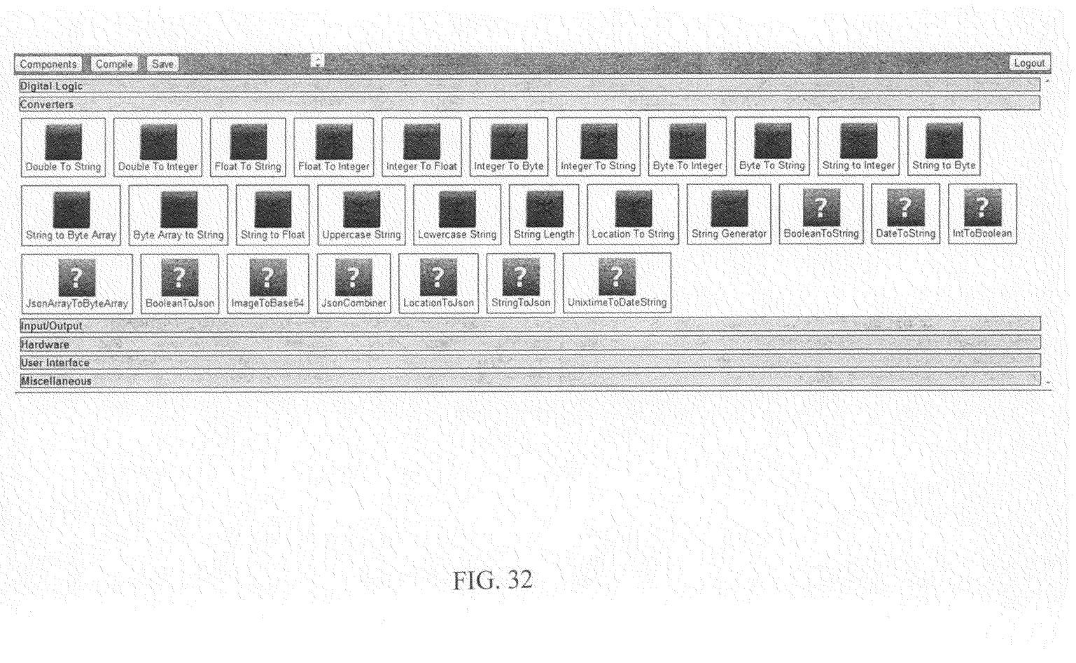

In some example embodiments, converter components may include, but are not limited to, “Boolean to JSON” components, “Boolean to String” components, “Byte Array to String” components, “Byte to Integer” components, “Byte to String” components, “Date to String” components, “Double to Integer” components, “Double to String” components, “Float to Integer” components, “Float to String” components, “Image to Base 64” components, “Integer to Boolean” components, “Integer to Byte” components, “Integer to Float” components, “Integer to String” components, “JSON Array to Byte Array” components, “JSON combiner” components, “Location to JSON” components, “Location to String” components, “Lowercase String” components, “String Generator” components, “String Length” components, “String to Byte” components, “String to Byte Array” components, “String to Float” components, “String to Integer” components, “String to JSON” components, “Unix Time to Date String” components, and “Uppercase String” components. FIG. 32 is a screenshot showing some example embodiments of converter components.

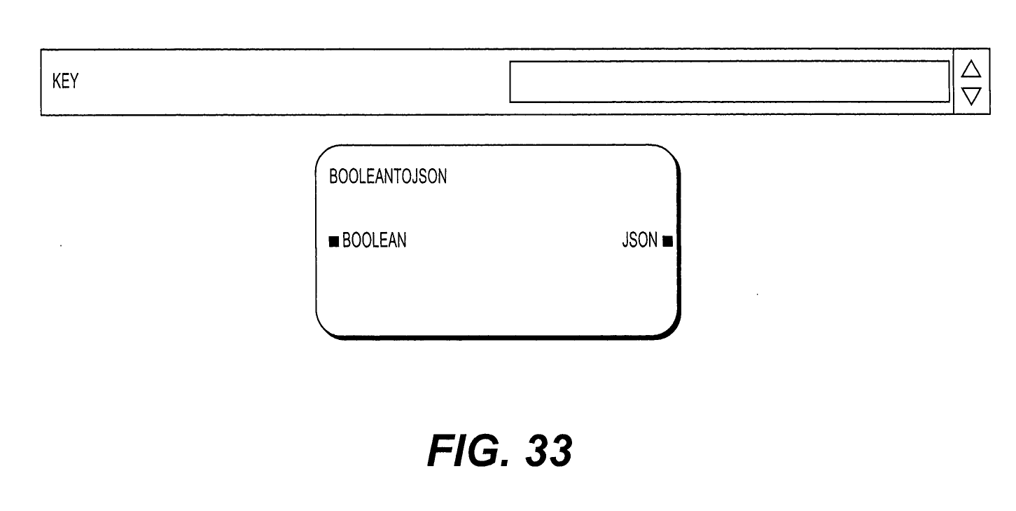

As shown in FIG. 33, “Boolean to JSON” components may include, for example, one input port. This input port may include, for example, “Boolean”. Data input to “Boolean” may be, for example, a “java.lang.Boolean” data type. “Boolean to JSON” components may include, for example, one output port. This output port may include, for example, “JSON”. Data output from “JSON” may be, for example, an “org.json.JSONObject” data type. “Boolean to JSON” components may change data, for example, from a first kind of data (e.g., Boolean value) into a second kind of data (e.g., JSONObject key:value pair).

As also shown in FIG. 33, “Boolean to JSON” components may include configurable properties, set before compilation, displayed above the “Boolean to JSON” components in the Default Activity Window (e.g., defining keys for key:value pairs).

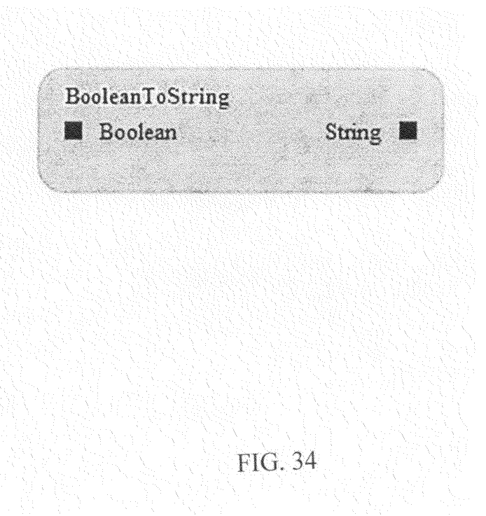

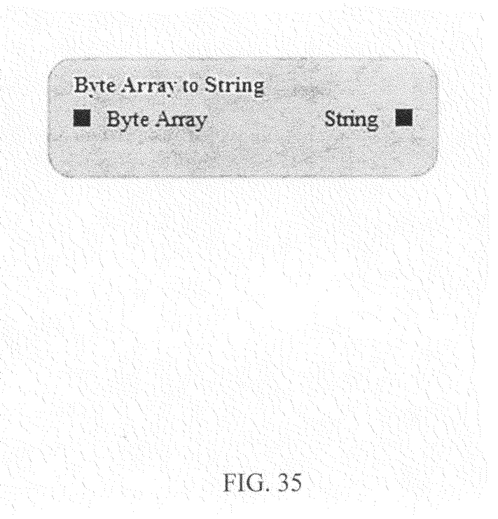

As shown in FIG. 34, “Boolean to String” components may include, for example, one input port. This input port may include, for example, “Boolean”. Data input to “Boolean” may be, for example, a “java.lang.Boolean” data type. “Boolean to String” components may include, for example, one output port. This output port may include, for example, “String”. Data output from “String” may be, for example, a “java.lang.String” data type. “Boolean to String” components may change data, for example, from a first kind of data (e.g., Boolean value) into a second kind of data (e.g., String).

As shown in FIG. 35, “Byte Array to String” components may include, for example, one input port. This input port may include, for example, “Byte Array”. Data input to “Byte Array” may be, for example, a “byte[ ]” data type. “Byte Array to String” components may include, for example, one output port. This output port may include, for example, “String”. Data output from “String” may be, for example, a “java.lang.String” data type. “Byte Array to String” components may change data, for example, from a first kind of data (e.g., byte[ ]) into a second kind of data (e.g., String).

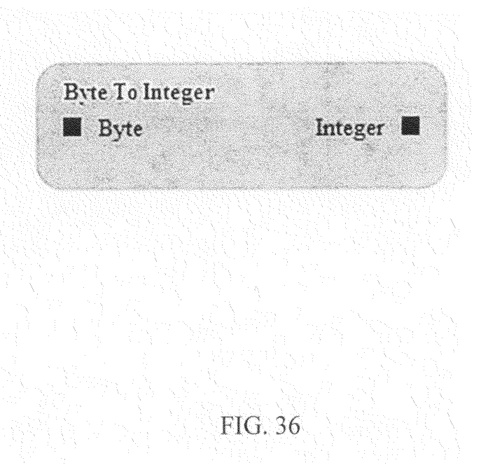

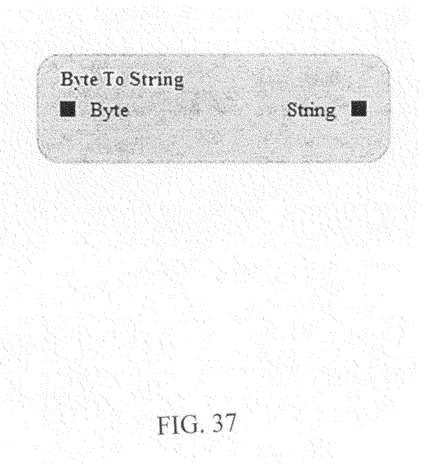

As shown in FIG. 36, “Byte to Integer” components may include, for example, one input port. This input port may include, for example, “Byte”. Data input to “Byte” may be, for example, a “java.lang.Byte” data type. “Byte to Integer” components may include, for example, one output port. This output port may include, for example, “Integer”. Data output from “Integer” may be, for example, a “java.lang.Integer” data type. “Byte to Integer” components may change data, for example, from a first kind of data (e.g., Byte) into a second kind of data (e.g., Integer).

As shown in FIG. 37, “Byte to String” components may include, for example, one input port. This input port may include, for example, “Byte”. Data input to “Byte” may be, for example, a “java.lang.Byte” data type. “Byte to String” components may include, for example, one output port. This output port may include, for example, “String”. Data output from “String” may be, for example, a “java.lang.String” data type. “Byte to String” components may change data, for example, from a first kind of data (e.g., Byte) into a second kind of data (e.g., String).

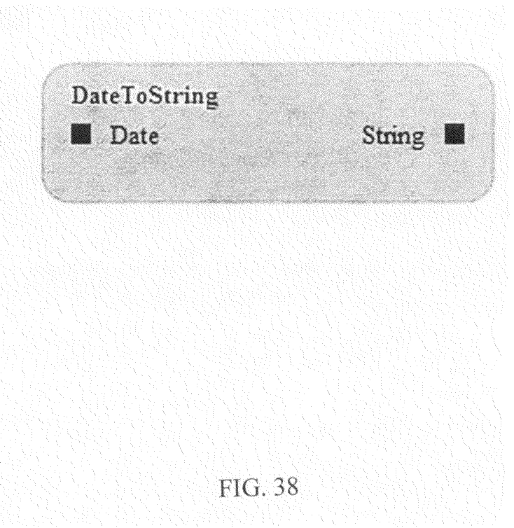

As shown in FIG. 38, “Date to String” components may include, for example, one input port. This input port may include, for example, “Date”. Data input to “Date” may be, for example, a “java.util.Date” data type. “Date to String” components may include, for example, one output port. This output port may include, for example, “String”. Data output from “String” may be, for example, a “java.lang.String” data type. “Date to String” components may change data, for example, from a first kind of data (e.g., Date Object) into a second kind of data (e.g., String).

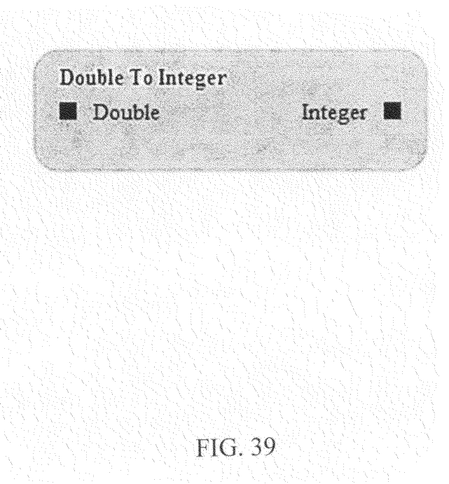

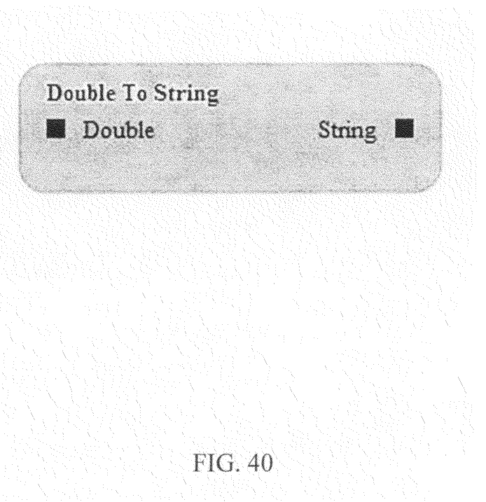

As shown in FIG. 39, “Double to Integer” components may include, for example, one input port. This input port may include, for example, “Double”. Data input to “Double” may be, for example, a “java.lang.Double” data type. “Double to Integer” components may include, for example, one output port. This output port may include, for example, “Integer”. Data output from “Integer” may be, for example, a “java.lang.Integer” data type. “Double to Integer” components may change data, for example, from a first kind of data (e.g., Double; double-precision floating-point format as defined, for example, in IEEE Standard 754) into a second kind of data (e.g., Integer).

As shown in FIG. 40, “Double to String” components may include, for example, one input port. This input port may include, for example, “Double”. Data input to “Double” may be, for example, a “java.lang.Double” data type. “Double to String” components may include, for example, one output port. This output port may include, for example, “String”. Data output from “String” may be, for example, a “java.lang.String” data type. “Double to String” components may change data, for example, from a first kind of data (e.g., Double) into a second kind of data (e.g., String).

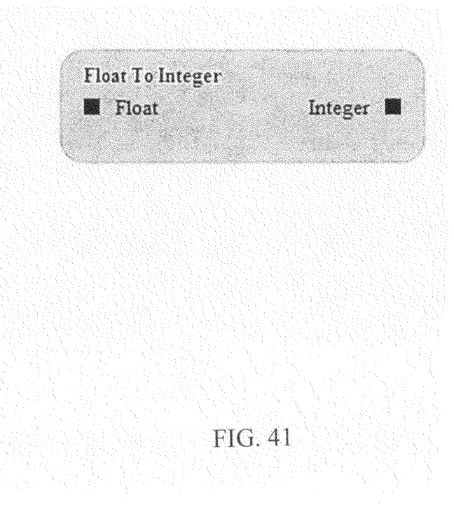

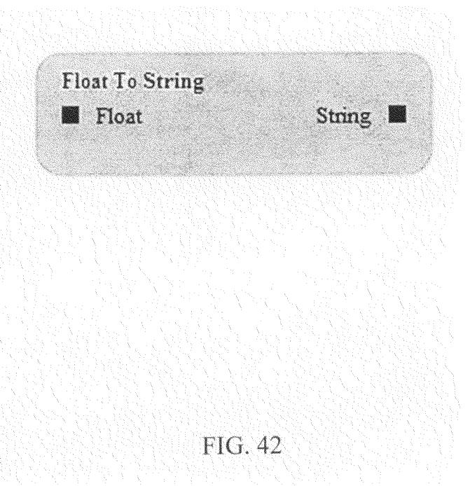

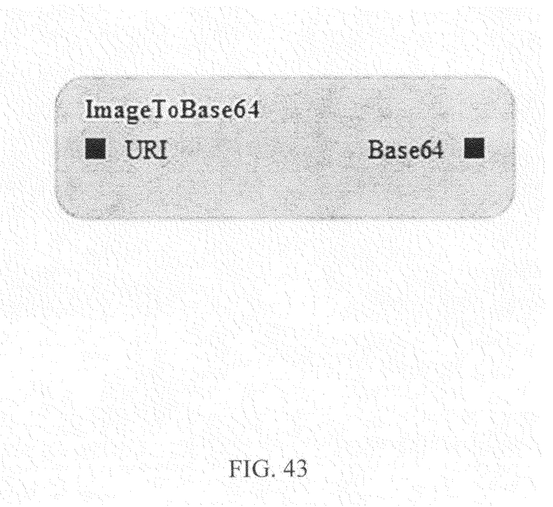

As shown in FIG. 41, “Float to Integer” components may include, for example, one input port. This input port may include, for example, “Float”. Data input to “Float” may be, for example, a “java.lang.Float” data type. “Float to Integer” components may include, for example, one output port. This output port may include, for example, “Integer”. Data output from “Integer” may be, for example, a “java.lang.Integer” data type. “Float to Integer” components may change data, for example, from a first kind of data (e.g., Float; floating-point format as defined, for example, in IEEE Standard 754) into a second kind of data (e.g., Integer).

As shown in FIG. 42, “Float to String” components may include, for example, one input port. This input port may include, for example, “Float”. Data input to “Float” may be, for example, a “java.lang.Float” data type. “Float to String” components may include, for example, one output port. This output port may include, for example, “String”. Data output from “String” may be, for example, a “java.lang.String” data type. “Float to String” components may change data, for example, from a first kind of data (e.g., Float) into a second kind of data (e.g., String).

As shown in FIG. 43, “Image to Base 64” components may include, for example, one input port. This input port may include, for example, “URI”. Data input to “URI” may be, for example, an “android.net.Uri” data type. “Image to Base 64” components may include, for example, one output port. This output port may include, for example, “Base64”. Data output from “Base64” may be, for example, a “java.lang.String” data type. “Image to Base 64” components may change data, for example, from a first kind of data referenced by a Uniform Resource Identifier (“URI”) into a second kind of data (e.g., String in base 64).

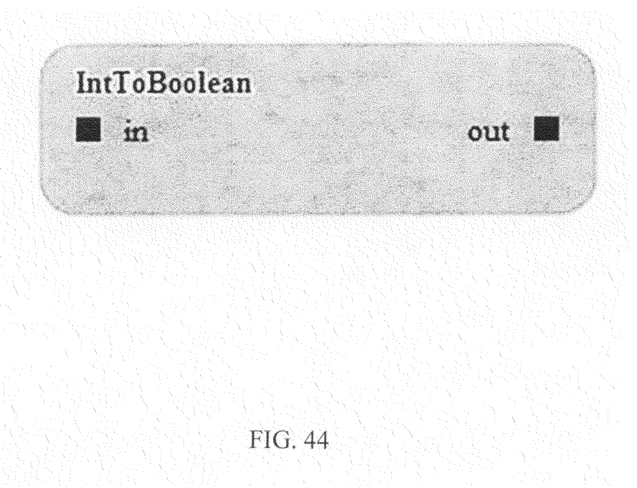

As shown in FIG. 44, “Integer to Boolean” components may include, for example, one input port. This input port may include, for example, “In”. Data input to “In” may be, for example, a “java.lang.Integer” data type. “Integer to Boolean” components may include, for example, one output port. This output port may include, for example, “Out”. Data output from “Out” may be, for example, a “java.lang.Boolean” data type. “Integer to Boolean” components may change data, for example, from a first kind of data (e.g., Integer) into a second kind of data (e.g., Boolean value).

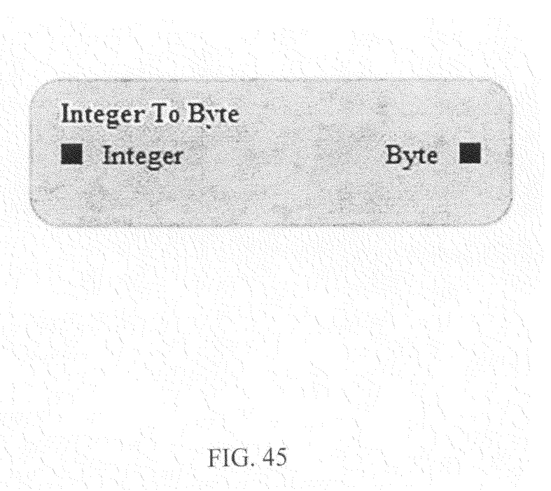

As shown in FIG. 45, “Integer to Byte” components may include, for example, one input port. This input port may include, for example, “Integer”. Data input to “Integer” may be, for example, a “java.lang.Integer” data type. “Integer to Byte” components may include, for example, one output port. This output port may include, for example, “Byte”. Data output from “Byte” may be, for example, a “java.lang.Byte” data type. “Integer to Byte” components may change data, for example, from a first kind of data (e.g., Integer) into a second kind of data (e.g., Byte).

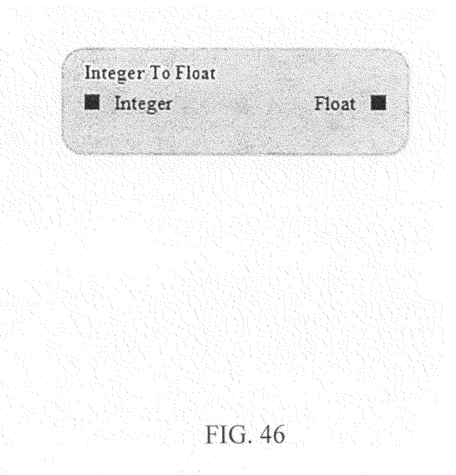

As shown in FIG. 46, “Integer to Float” components may include, for example, one input port. This input port may include, for example, “Integer”. Data input to “Integer” may be, for example, a “java.lang.Integer” data type. “Integer to Float” components may include, for example, one output port. This output port may include, for example, “Float”. Data output from “Float” may be, for example, a “java.lang.Float” data type. “Integer to Float” components may change data, for example, from a first kind of data (e.g., Integer) into a second kind of data (e.g., Float).

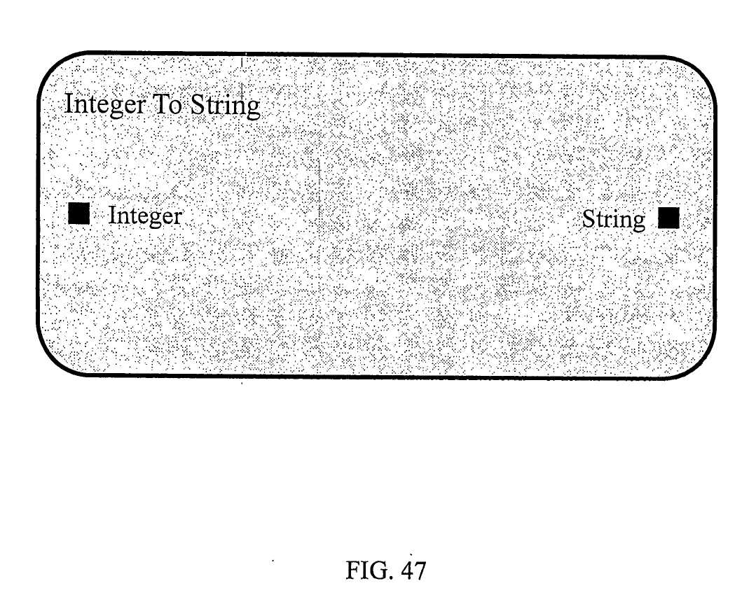

As shown in FIG. 47, “Integer to String” components may include, for example, one input port. This input port may include, for example, “Integer”. Data input to “Integer” may be, for example, a “java.lang.Integer” data type. “Integer to String” components may include, for example, one output port. This output port may include, for example, “String”. Data output from “String” may be, for example, a “java.lang.String” data type. “Integer to String” components may change data, for example, from a first kind of data (e.g., Integer) into a second kind of data (e.g., String).

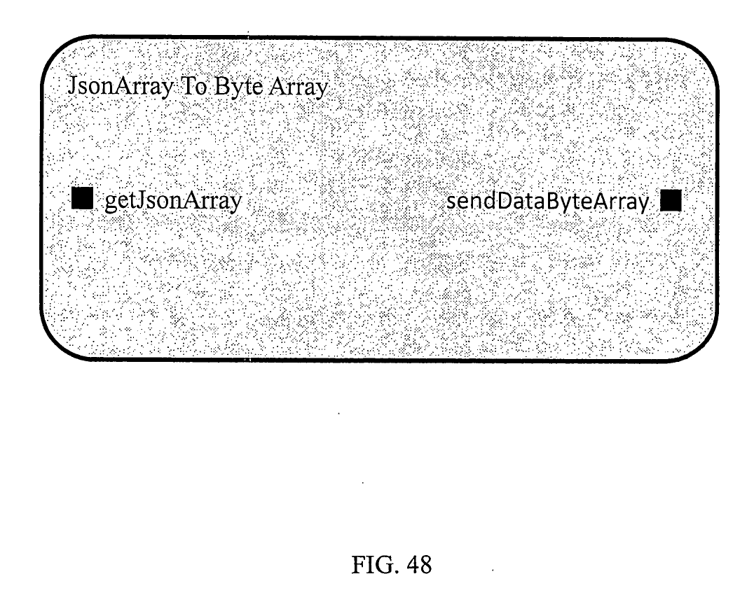

As shown in FIG. 48, “JSON Array to Byte Array” components may include, for example, one input port. This input port may include, for example, “Get JSON Array”. Data input to “Get JSON Array” may be, for example, a “org.json.JSONArray” data type. “JSON Array to Byte Array” components may include, for example, one output port. This output port may include, for example, “Send Data Byte Array”. Data output from “Send Data Byte Array” may be, for example, a “byte[ ]” data type. “JSON Array to Byte Array” components may receive a first kind of data (e.g., arbitrary data with keys) and may output a second kind of data (e.g., byte[ ]).

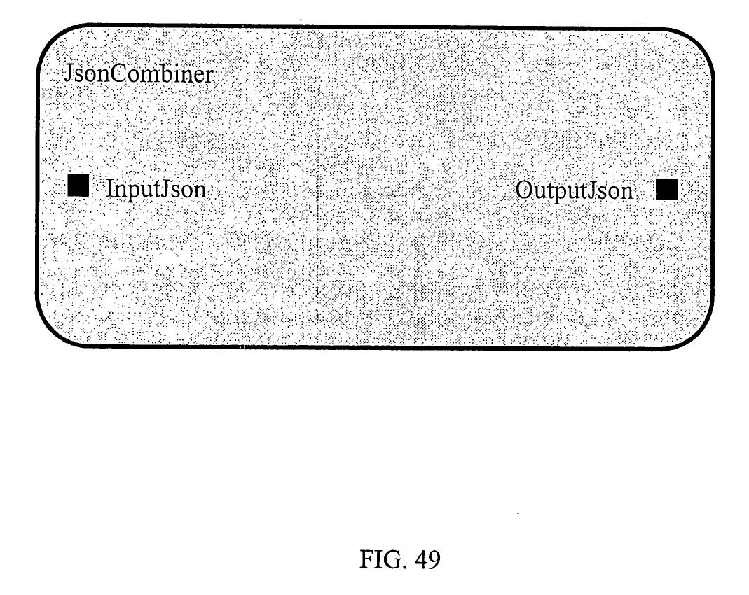

As shown in FIG. 49, “JSON combiner” components may include, for example, one input port. This input port may include, for example, “Input JSON”. Data input to “Input JSON” may be, for example, an “org.json.JSONObject” data type. “JSON combiner” components may include, for example, one output port. This output port may include, for example, “Output JSON”. Data output from “Output JSON” may be, for example, an “org.json.JSONObject” data type. “JSON combiner” components may receive a plurality of a first kind of data (e.g., JSONObject key:value pairs) and may combine them into a single second kind of data (e.g., one JSONObject key:value pair).

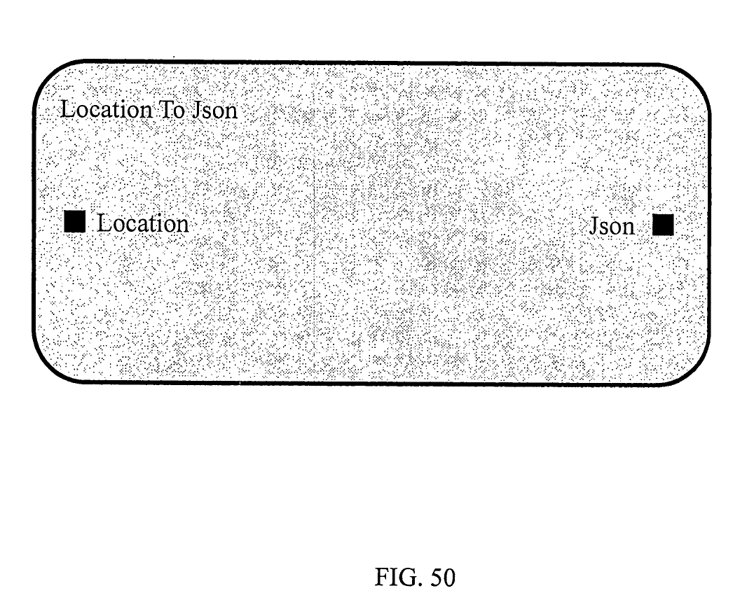

As shown in FIG. 50, “Location to JSON” components may include, for example, one input port. This input port may include, for example, “Location”. Data input to “Location” may be, for example, an “android.location.Location” data type. “Location to JSON” components may include, for example, one output port. This output port may include, for example, “JSON”. Data output from “JSON” may be, for example, an “org.json.JSONObject” data type. “Location to JSON” components may change data, for example, from a first kind of data (e.g., Location Object) into a second kind of data (e.g., JSONObject key:value pair).

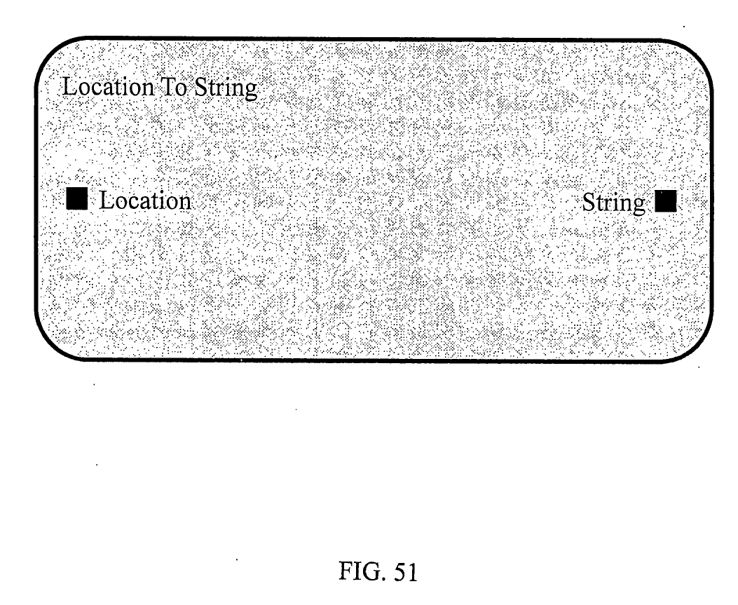

As shown in FIG. 51, “Location to String” components may include, for example, one input port. This input port may include, for example, “Location”. Data input to “Location” may be, for example, an “android.location.Location” data type. “Location to String” components may include, for example, one output port. This output port may include, for example, “String”. Data output from “String” may be, for example, a “java.lang.String” data type. “Location to String” components may change data, for example, from a first kind of data (e.g., Location Object) into a second kind of data (e.g., String including Latitude/Longitude information or other information with location functionality).

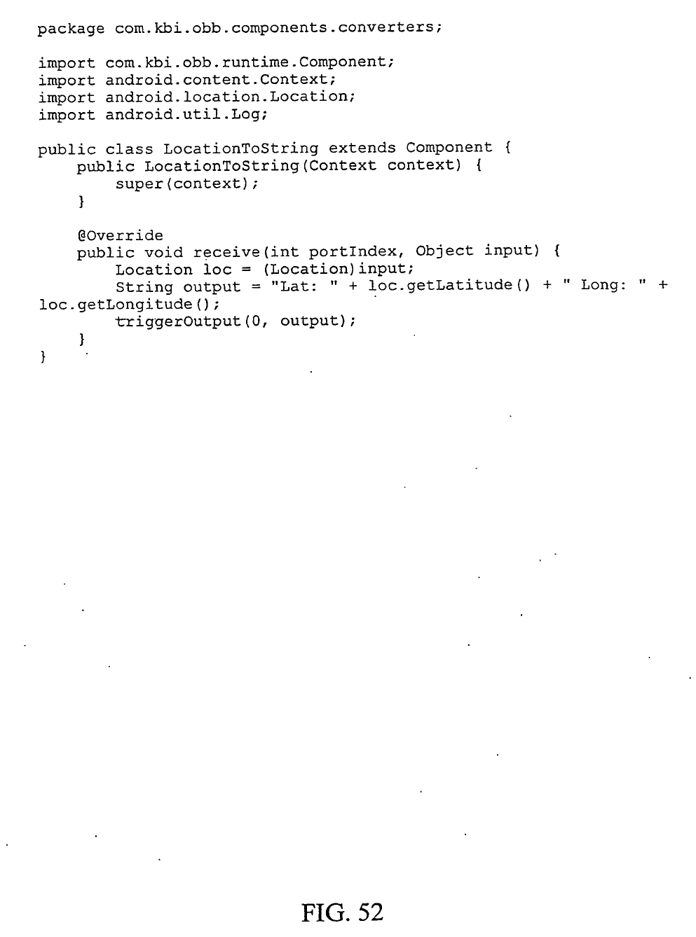

FIG. 52 provides an example of source code, written in the Java programming language, for “Location to String” components.

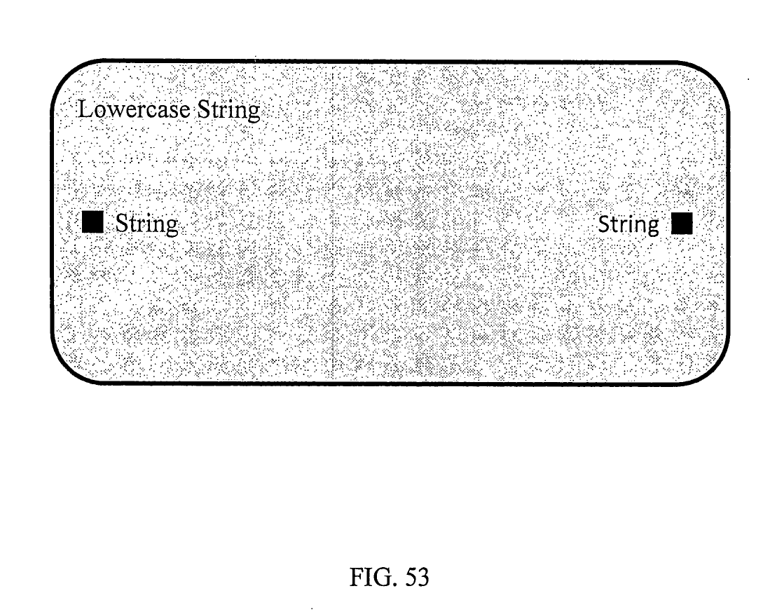

As shown in FIG. 53, “Lowercase String” components may include, for example, one input port. This input port may include, for example, “String”. Data input to “String” may be, for example, a “java.lang.String” data type. “Lowercase String” components may include, for example, one output port. This output port may include, for example, “String”. Data output from “String” may be, for example, a “java.lang.String” data type. “Lowercase String” components may change data, for example, from a first kind of data (e.g., String in any combination of case) into a second kind of data (e.g., String in lower case).

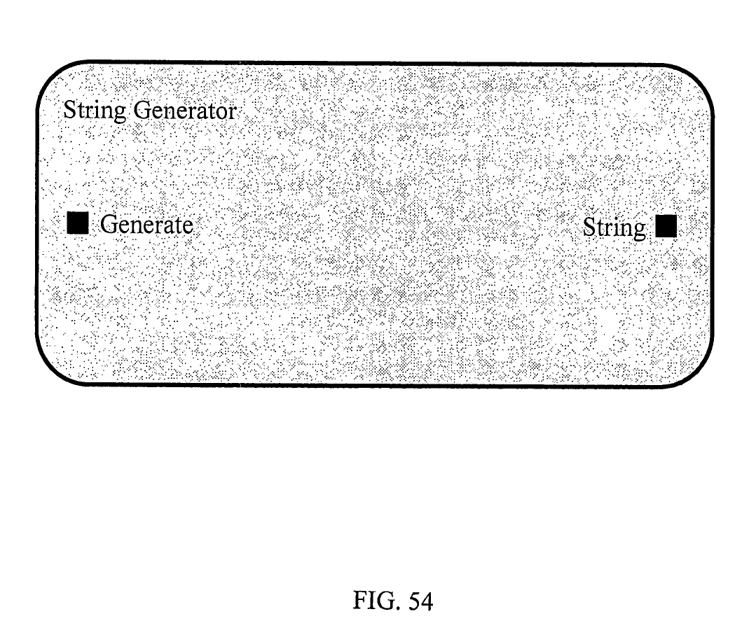

As shown in FIG. 54, “String Generator” components may include, for example, one input port. This input port may include, for example, “Generate”. Data input to “Generate” may be, for example, a “java.lang.Integer” data type. “String Generator” components may include, for example, one output port. This output port may include, for example, “String”. Data output from “String” may be, for example, a “java.lang.String” data type. “String Generator” components, when triggered by receiving as input a first kind of data (e.g., Integer), may output a second kind of data (e.g., desired Strings that may be set as configurable properties of “String Generator” components before compilation).

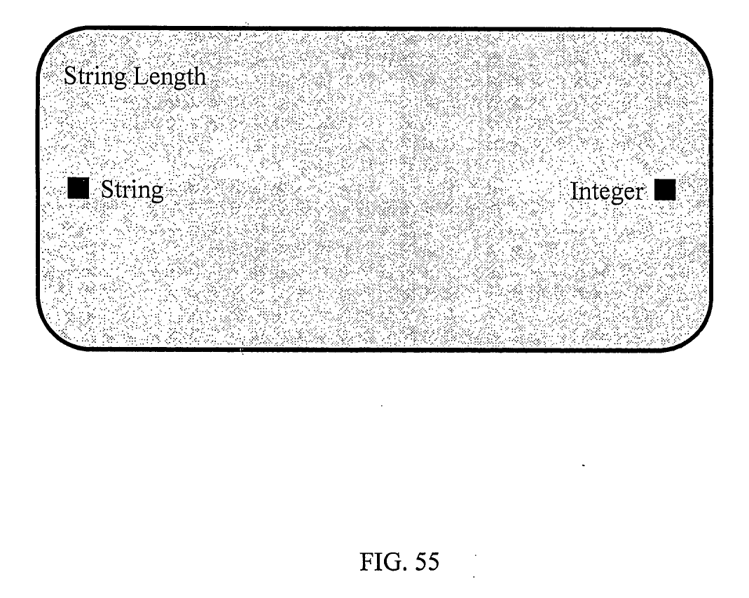

As shown in FIG. 55, “String Length” components may include, for example, one input port. This input port may include, for example, “String”. Data input to “String” may be, for example, a “java.lang.String” data type. “String Length” components may include, for example, one output port. This output port may include, for example, “Integer”. Data output from “Integer” may be, for example, a “java.lang.Integer” data type. “String Length” components may measure the length of a first kind of data (e.g., String) and output the length as a second kind of data (e.g., Integer).

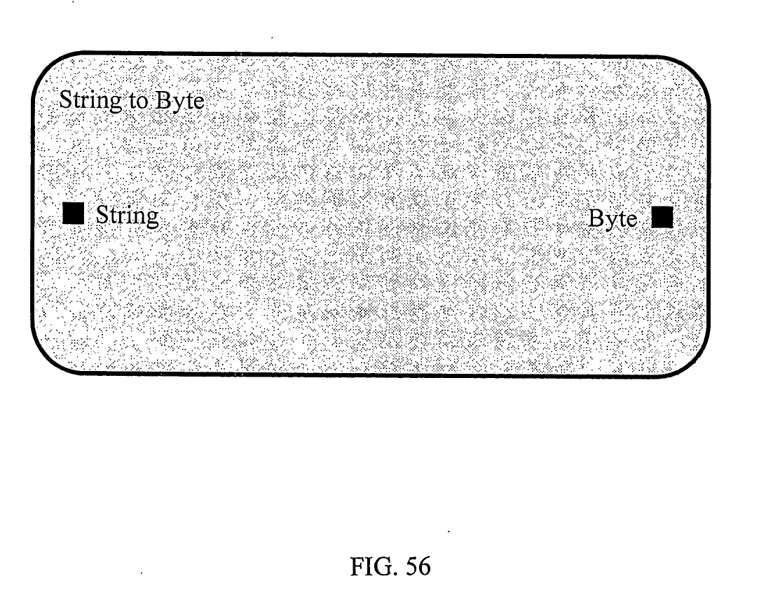

As shown in FIG. 56, “String to Byte” components may include, for example, one input port. This input port may include, for example, “String”. Data input to “String” may be, for example, a “java.lang.String” data type. “String to Byte” components may include, for example, one output port. This output port may include, for example, “Byte”. Data output from “Byte” may be, for example, a “java.lang.Byte” data type. “String to Byte” components may change data, for example, from a first kind of data (e.g., String) into a second kind of data (e.g., Byte).

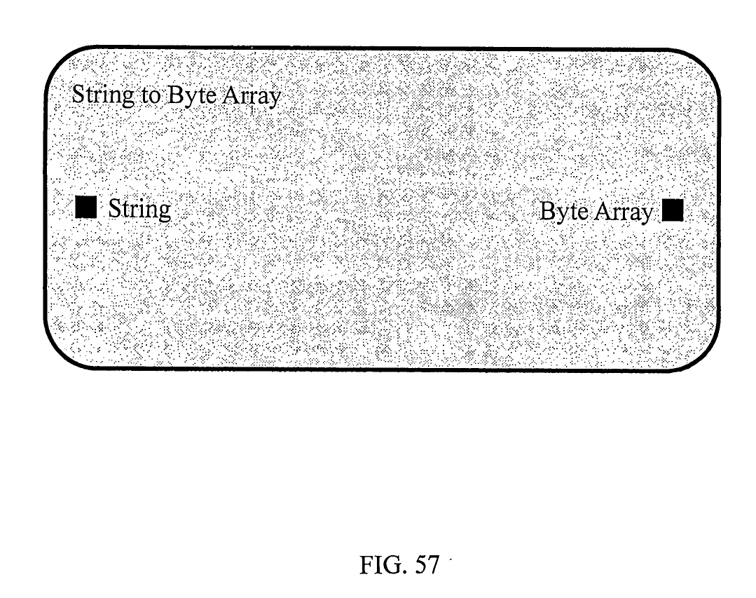

As shown in FIG. 57, “String to Byte Array” components may include, for example, one input port. This input port may include, for example, “String”. Data input to “String” may be, for example, a “java.lang.String” data type. “String to Byte Array” components may include, for example, one output port. This output port may include, for example, “Byte Array”. Data output from “Byte Array” may be, for example, a “byte[ ]” data type. “String to Byte Array” components may change data, for example, from a first kind of data (e.g., String) into a second kind of data (e.g., byte[ ]).

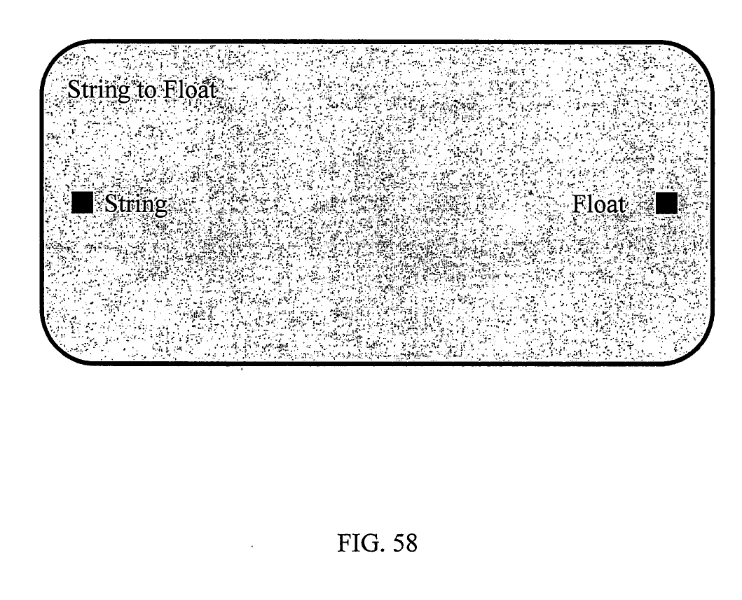

As shown in FIG. 58, “String to Float” components may include, for example, one input port. This input port may include, for example, “String”. Data input to “String” may be, for example, a “java.lang.String” data type. “String to Float” components may include, for example, one output port. This output port may include, for example, “Float”. Data output from “Float” may be, for example, a “java.lang.Float” data type. “String to Float” components may change data, for example, from a first kind of data (e.g., String) into a second kind of data (e.g., Float).

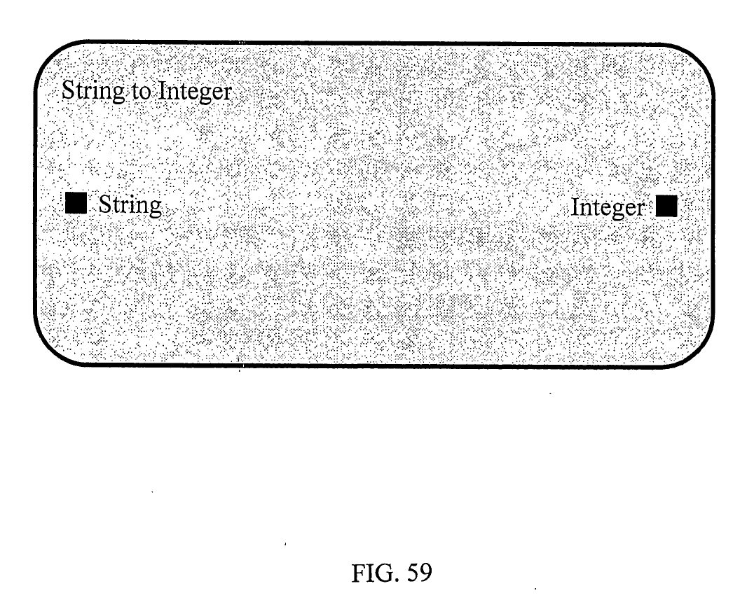

As shown in FIG. 59, “String to Integer” components may include, for example, one input port. This input port may include, for example, “String”. Data input to “String” may be, for example, a “java.lang.String” data type. “String to Integer” components may include, for example, one output port. This output port may include, for example, “Integer”. Data output from “Integer” may be, for example, a “java.lang.Integer” data type. “String to Integer” components may change data, for example, from a first kind of data (e.g., String) into a second kind of data (e.g., Integer).

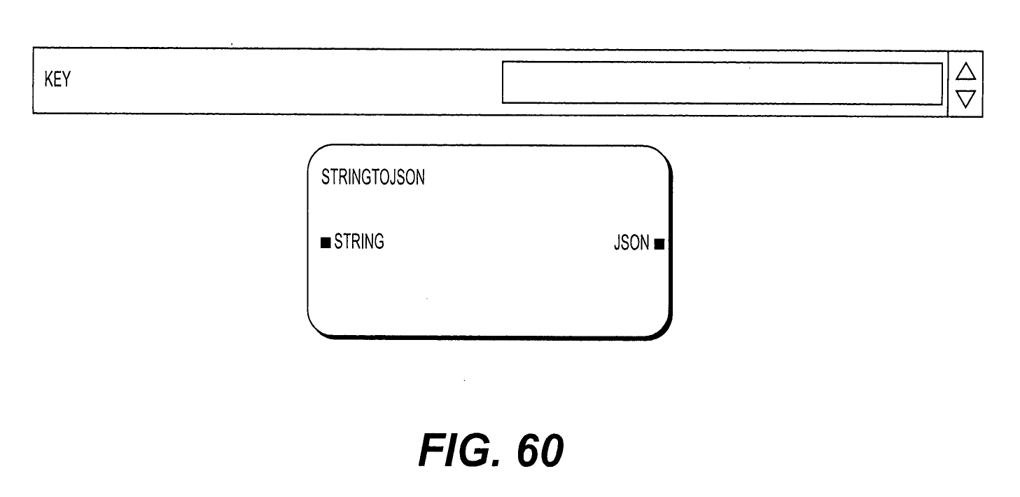

As shown in FIG. 60, “String to JSON” components may include, for example, one input port. This input port may include, for example, “String”. Data input to “String” may be, for example, a “java.lang.String” data type. “String to JSON” components may include, for example, one output port. This output port may include, for example, “JSON”. Data output from “JSON” may be, for example, an “org.json.JSONObject” data type. “String to JSON” components may change data, for example, from a first kind of data (e.g., String value) into a second kind of data (e.g., JSONObject key:value pair).

As also shown in FIG. 60, “String to JSON” components may include configurable properties, set before compilation, displayed above the “String to JSON” components in the Default Activity Window (e.g., defining keys for key:value pairs).

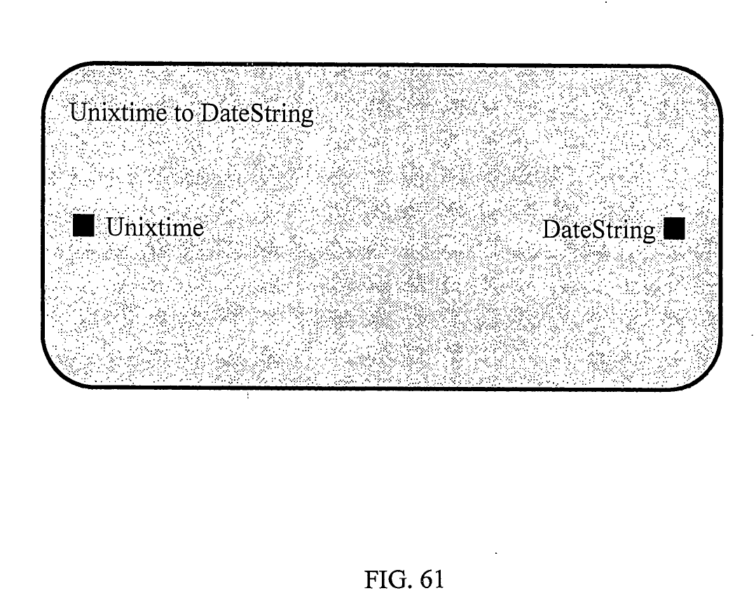

As shown in FIG. 61, “Unix Time to Date String” components may include, for example, one input port. This input port may include, for example, “Unix Time”. Data input to “Unix Time” may be, for example, a “java.lang.Integer” data type. “Unix Time to Date String” components may include, for example, one output port. This output port may include, for example, “Date String”. Data output from “Date String” may be, for example, a “java.lang.String” data type. “Unix Time to Date String” components may change data, for example, from a first kind of data (e.g., Unix Time in standard integer format) into a second kind of data (e.g., Date String in human-readable format).

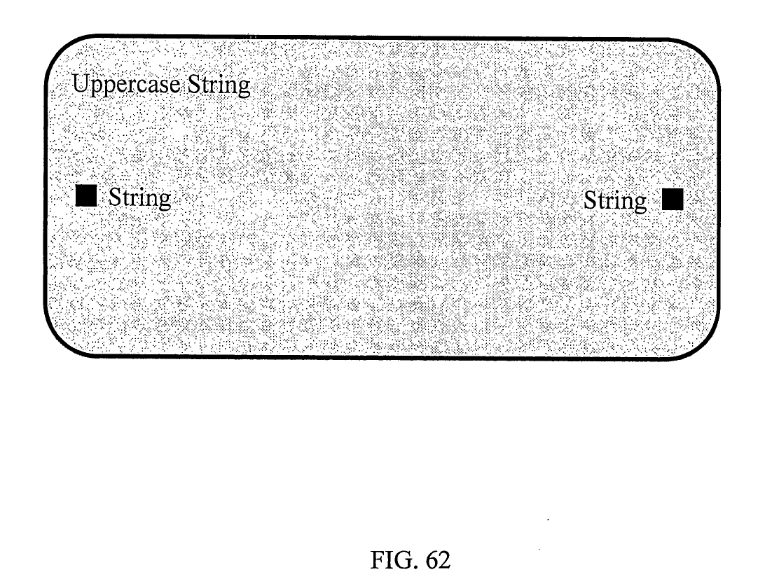

As shown in FIG. 62, “Uppercase String” components may include, for example, one input port. This input port may include, for example, “String”. Data input to “String” may be, for example, a “java.lang.String” data type. “Uppercase String” components may include, for example, one output port. This output port may include, for example, “String”. Data output from “String” may be, for example, a “java.lang.String” data type. “Uppercase String” components may change data, for example, from a first kind of data (e.g., String in any combination of case) into a second kind of data (e.g., String in upper case).

Converter components also may include, for example, “Boolean to Integer” components.

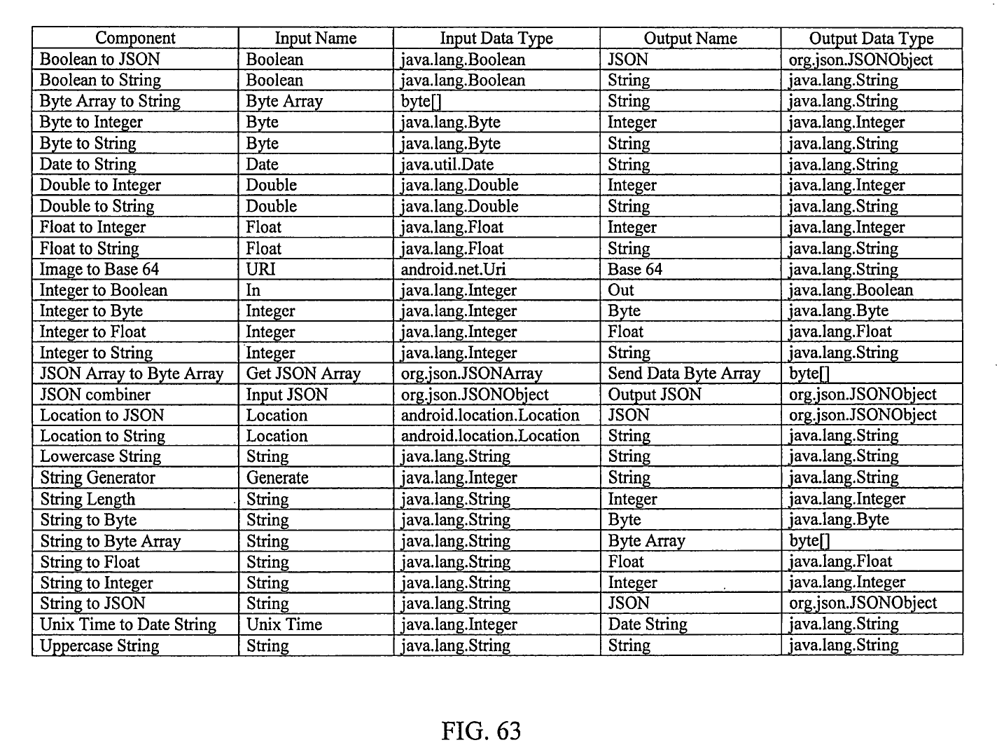

Related information regarding some example embodiments of converter components may be found in the table of FIG. 63.

### 9. Example Components

### Input/Output Components

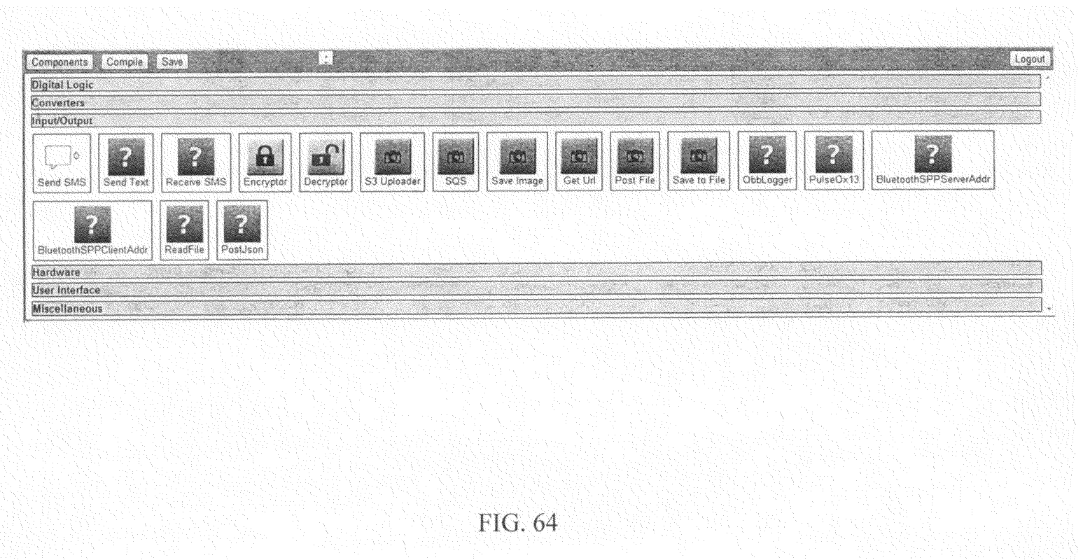

In some example embodiments, input/output components may include, but are not limited to, “BluetoothSPPClientAddr” components, “BluetoothSPPServerAddr” components, “Decryptor” components, “Encryptor” components, “Get Uniform Resource Locator” (“Get URL”) components, “ObbLogger” components, “Post File” components, “Post JSON” components, “PulseOx13” components, “Read File” components, “Receive Short Message Service” (“Receive SMS”) components, “Save Image” components, “Save to File” components, “Send SMS” components, “Send Text” components, “Simple Queue Service” (“SQS”) components, and “S3 Uploader” components. FIG. 64 is a screenshot showing some example embodiments of converter components.

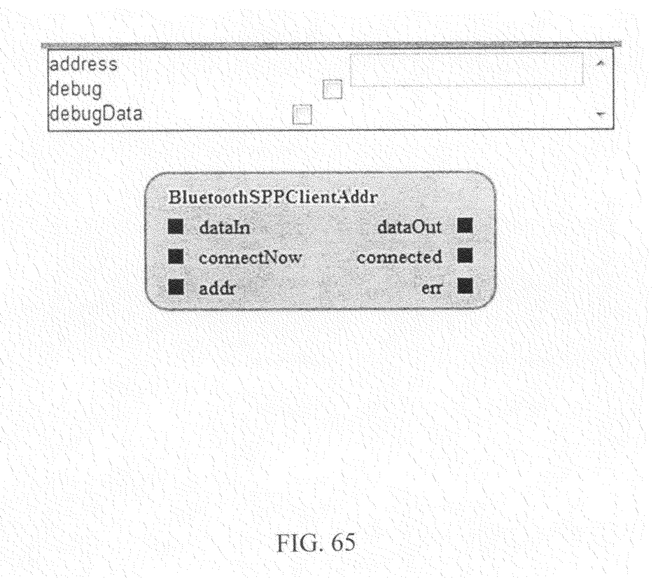

As shown in FIG. 65, “BluetoothSPPClientAddr” components may include, for example, three input ports. These input ports may include, for example, “Data In”, “Connect Now”, and “Address”. Data input to “Data In” may be, for example, a “byte[ ]” data type. Data input to “Connect Now” may be, for example, a “java.lang.Boolean” data type. Data input to “Address” may be, for example, a “java.lang.String” data type. “BluetoothSPPClientAddr” components may include, for example, three output ports. These output ports may include, for example, “Data Out”, “Connected”, and “Error”. Data output from “Data Out” may be, for example, a “byte[ ]” data type. Data output from “Connected” may be, for example, an “java.lang.Boolean” data type. Data output from “Error” may be, for example, a “java.lang.String” data type.

“BluetoothSPPClientAddr” components may allow an associated device to access a Bluetooth server using, for example, the Bluetooth Serial Port Profile (“SPP”). Data input to “Address” may provide, for example, a Bluetooth address of a server. Data input to “Connect Now” may provide, for example, a trigger to cause the associated device to access the Bluetooth server. Data input to “Data In” may provide, for example, a flowpath for data from the associated device to the Bluetooth server. Data output from “Connected” may provide, for example, an indication that access to the Bluetooth server has occurred. Data output from “Error” may provide, for example, an indication that access to the Bluetooth server has not occurred or that another error exists. Data output from “Data Out” may provide, for example, a flowpath for data from the Bluetooth server to the associated device.

As also shown in FIG. 65, “BluetoothSPPClientAddr” components may include configurable properties set before compilation—but neither are displayed in the Default Activity Window. The configurable properties may, for example, provide the Bluetooth address of the server, and indicate whether debugging should occur if an error exists or whether the data itself should be debugged. The configurable properties may, for example, be respectively designated as “address”, “debug”, and “debug Data”.

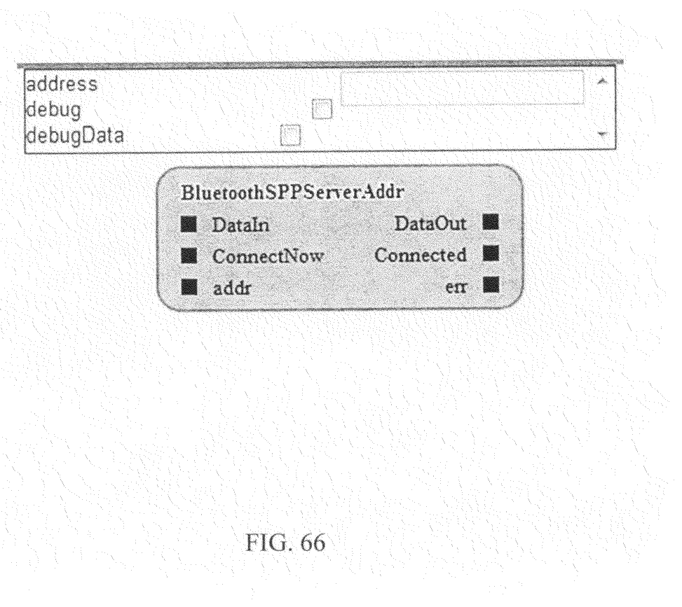

As shown in FIG. 66, “BluetoothSPPServerAddr” components may include, for example, three input ports. These input ports may include, for example, “Data In”, “Connect Now”, and “Address”. Data input to “Data In” may be, for example, a “byte[ ]” data type. Data input to “Connect Now” may be, for example, a “java.lang.Boolean” data type. Data input to “Address” may be, for example, a “java.lang.String” data type. “BluetoothSPPServerAddr” components may include, for example, three output ports. These output ports may include, for example, “Data Out”, “Connected”, and “Error”. Data output from “Data Out” may be, for example, a “byte[ ]” data type. Data output from “Connected” may be, for example, a “java.lang.Boolean” data type. Data output from “Error” may be, for example, a “java.lang.String” data type.

“BluetoothSPPServerAddr” components may allow an associated device to provide a Bluetooth server using, for example, the Bluetooth Serial Port Profile (“SPP”). Data input to “Address” may provide, for example, a Bluetooth address of a server. Data input to “Connect Now” may provide, for example, a trigger to cause the associated device to access the Bluetooth server. Data input to “Data In” may provide, for example, a flowpath for data from the associated device to the Bluetooth server. Data output from “Connected” may provide, for example, an indication that access to the Bluetooth server has occurred. Data output from “Error” may provide, for example, an indication that access to the Bluetooth server has not occurred or that another error exists. Data output from “Data Out” may provide, for example, a flowpath for data from the Bluetooth server to the associated device.

As also shown in FIG. 66, “BluetoothSPPServerAddr” components may include configurable properties set before compilation—but neither are displayed in the Default Activity Window. The configurable properties may, for example, provide the Bluetooth address of the server, and indicate whether debugging should occur if an error exists or whether the data itself should be debugged. The configurable properties may, for example, be respectively designated as “address”, “debug”, and “debug Data”.

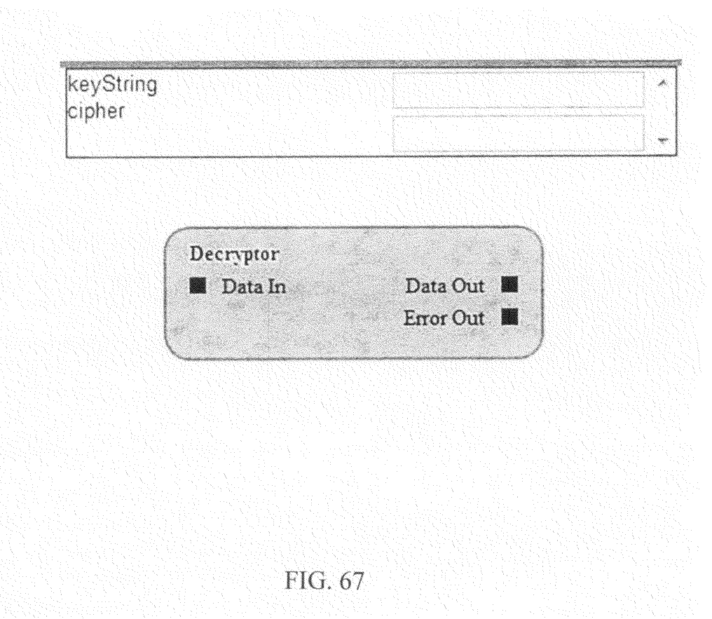

As shown in FIG. 67, “Decryptor” components may include, for example, one input port. This input port may include, for example, “Data In”. Data input to “Data In” may be, for example, a “byte[ ]” data type. “Decryptor” components may include, for example, two output ports. These output ports may include, for example, “Data Out” and “Error Out”. Data output from “Data Out” may be, for example, a “byte[ ]” data type. Data output from “Error Out” may be, for example, a “java.lang.String” data type.

Data input to “Data In” may provide, for example, a flowpath for data from an associated device to a decryption system. Data output from “Data Out” may provide, for example, a flowpath for data from the decryption system to the associated device. Data output from “Error Out” may describe, for example, errors that occurred during decryption.

As also shown in FIG. 67, “Decryptor” components may include configurable properties set before compilation—but neither are displayed in the Default Activity Window. The configurable properties may, for example, provide an algorithm for decryption, such as the Rivest, Shamir, and Adleman (“RSA”) algorithm, and identify a key that the algorithm may use. The configurable properties may, for example, be respectively designated as “cipher” and “keyString”. The decryption algorithm may be, for example, a symmetric-key algorithm.

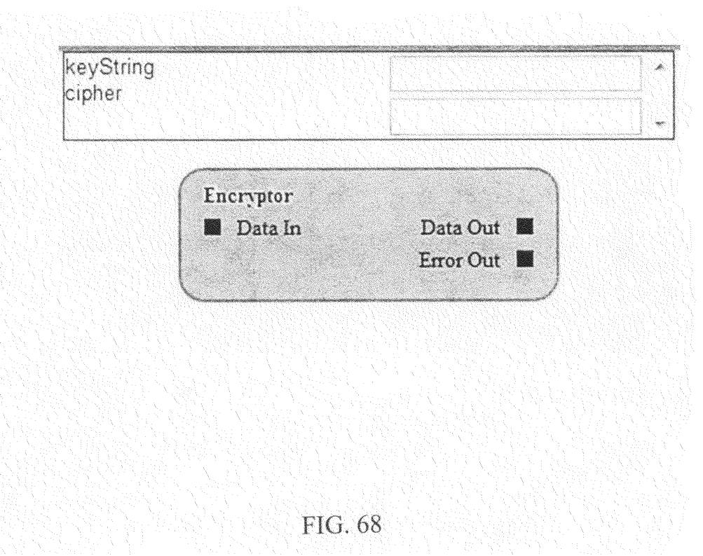

As shown in FIG. 68, “Encryptor” components may include, for example, one input port. This input port may include, for example, “Data In”. Data input to “Data In” may be, for example, a “byte[ ]” data type. “Encryptor” components may include, for example, two output ports. These output ports may include, for example, “Data Out” and “Error Out”. Data output from “Data Out” may be, for example, a “byte[ ]” data type. Data output from “Error Out” may be, for example, a “java.lang.String” data type.

Data input to “Data In” may provide, for example, a flowpath for data from an associated device to an encryption system. Data output from “Data Out” may provide, for example, a flowpath for data from the encryption system to the associated device. Data output from “Error Out” may describe, for example, errors that occurred during encryption.

As also shown in FIG. 68, “Encryptor” components may include configurable properties set before compilation—but neither are displayed in the Default Activity Window. The configurable properties may, for example, provide an algorithm for encryption, such as the RSA algorithm, and identify a key that the algorithm may use. The configurable properties may, for example, be respectively designated as “cipher” and “keyString”. The encryption algorithm may be, for example, a symmetric-key algorithm.

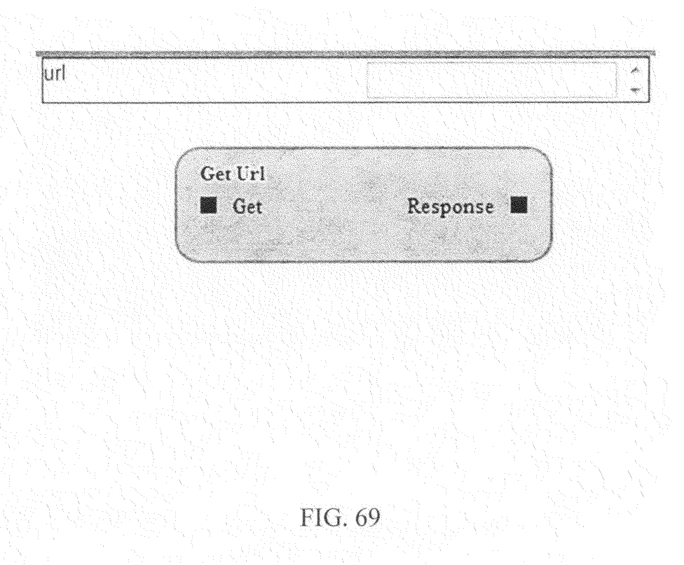

As shown in FIG. 69, “Get URL” components may include, for example, one input port. This input port may include, for example, “Get”. Data input to “Get” may be, for example, a “java.lang.Integer” data type. “Get URL” components may include, for example, one output port. This output port may include, for example, “Response”. Data output from “Response” may be, for example, a “byte[ ]” data type.

When triggered by data input to “Get”, “Get URL” components may output byte arrays, for example, reflecting what is at the specific URL.

As also shown in FIG. 69, “Get URL” components may include configurable properties set before compilation—but neither are displayed in the Default Activity Window. The configurable properties may, for example, identify the URL. The configurable properties may, for example, be may be designated as “url”.

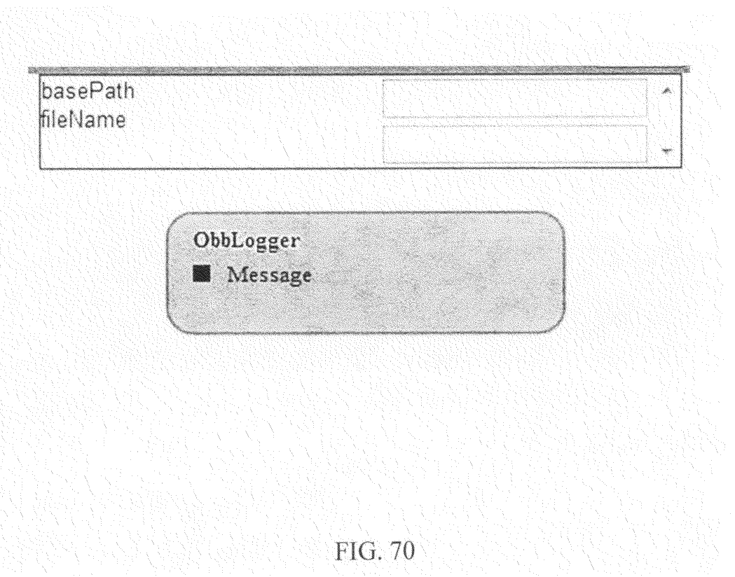

As shown in FIG. 70, “ObbLogger” components may include, for example, one input port. This input port may include, for example, “Message”. Data input to “Message” may be, for example, a “java.lang.String” data type. “ObbLogger” components may include, for example, no output ports.

“ObbLogger” components may, for example, create a text file from data input to “Message”.

As also shown in FIG. 70, “ObbLogger” components may include configurable properties set before compilation—but neither are displayed in the Default Activity Window. The configurable properties may, for example, identify a path to the database, and provide a name for the text file. The configurable properties may, for example, be respectively designated as “basePath” and “fileName”.

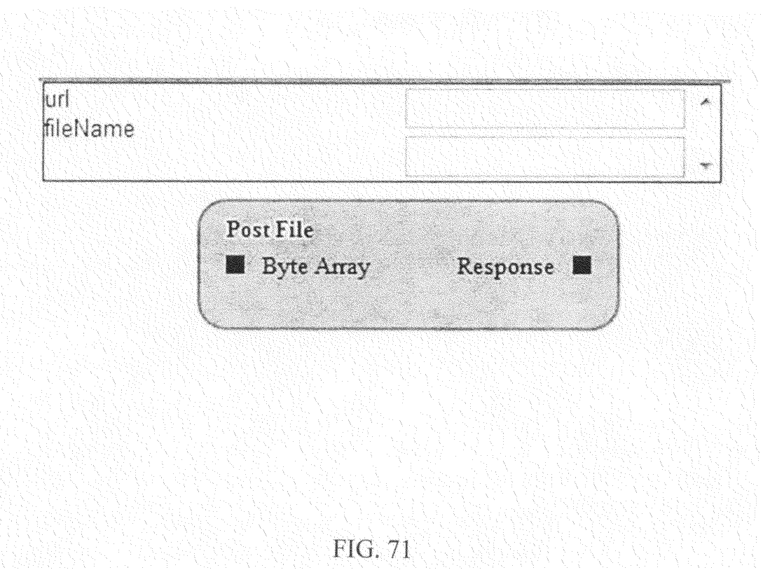

As shown in FIG. 71, “Post File” components may include, for example, one input port. This input port may include, for example, “Byte Array”. Data input to “Byte Array” may be, for example, a “byte[ ]” data type. “Post File” components may include, for example, one output port. This output port may include, for example, “Response”. Data output from “Response” may be, for example, a “byte[ ]” data type.

“Post File” components may, for example, upload a file from data input to “Byte Array” to a URL.

As also shown in FIG. 71, “Post File” components may include configurable properties set before compilation—but neither are displayed in the Default Activity Window. The configurable properties may, for example, identify the URL/recipient server of the file, and provide a name for the file. The configurable properties may, for example, be respectively designated as “url” and “fileName”.

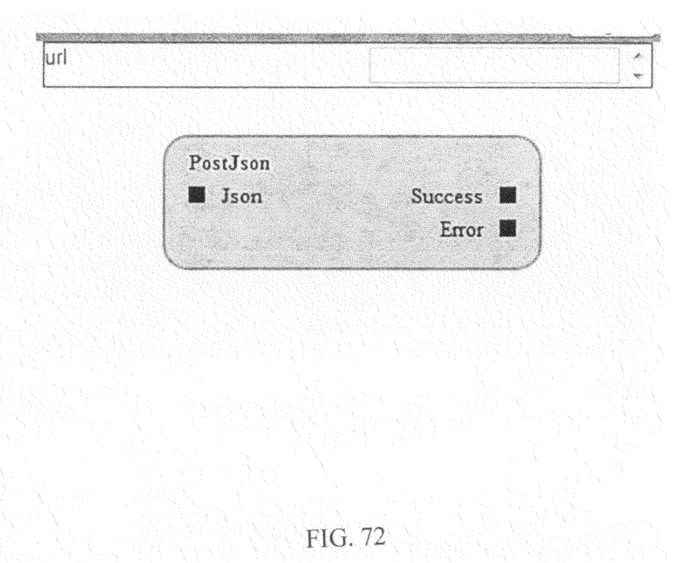

As shown in FIG. 72, “Post JSON” components may include, for example, one input port. This input port may include, for example, “JSON”. Data input to “JSON” may be, for example, an “org.json.JSONObject” data type. “Post JSON” components may include, for example, two output ports. These output ports may include, for example, “Success” and “Error”. Data output from “Success” may be, for example, a “java.lang.Object” data type. Data output from “Error” may be, for example, a “java.lang.String” data type.

“Post JSON” components may, for example, upload a file from data input to “JSON” to a URL.

As also shown in FIG. 72, “Post JSON” components may include configurable properties set before compilation—but neither are displayed in the Default Activity Window. The configurable properties may, for example, identify the URL/recipient server of the file. The configurable properties may, for example, be designated as “url”.

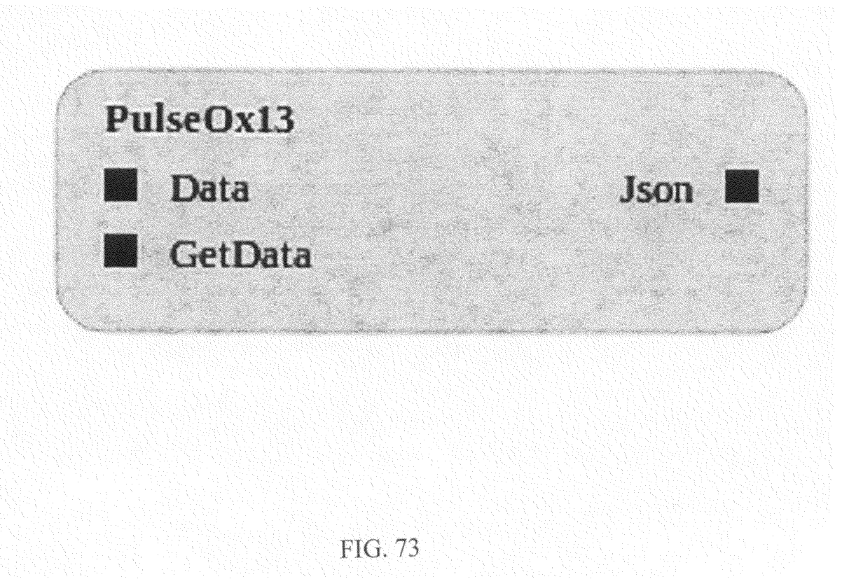

As shown in FIG. 73, “PulseOx13” components may include, for example, two input ports. These input ports may include, for example, “Data” and “Get Data”. Data input to “Data” may be, for example, a “byte[ ]” data type. Data input to “Get Data” may be, for example, a “java.lang.Object” data type. “PulseOx13” components may include, for example, one output port. This output port may include, for example, “JSON”. Data output from “JSON” may be, for example, a “org.json.JSONObject” data type.

When triggered by data input to “Get Data”, “PulseOx13” components may read current values of saturation of patients' hemoglobin using pulse oximeters. The current values may be communicated from the pulse oximeters over Bluetooth to an associated device. “PulseOx13” components may output the current values through “JSON”.

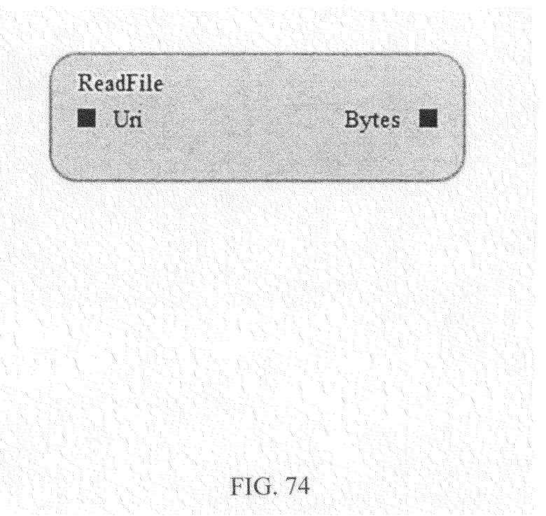

As shown in FIG. 74, “Read File” components may include, for example, one input port. This input port may include, for example, “URI”. Data input to “URI” may be, for example, an “android.net.Uri” type. “Read File” components may include, for example, one output port. This output port may include, for example, “Bytes”. Data output from “Bytes” may be, for example, a “byte[ ]” data type.

“Read File” components may, for example, read a file based on a Uniform Resource Identifier (“URI”) and output the contents of the file as a byte array.

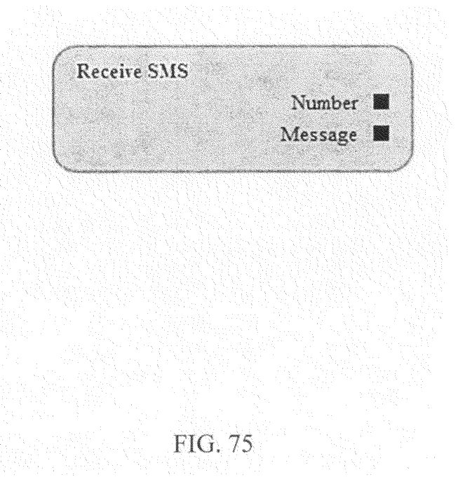

As shown in FIG. 75, “Receive SMS” components may include, for example, no input ports. “Receive SMS” components may include, for example, two output ports. These output ports may include, for example, “Number” and “Message”. Data output from “Number” may be, for example, a “java.lang.String” data type. Data output from “Message” may be, for example, a “java.lang.String” data type.

“Receive SMS” components may, for example, raise an event that the associated device has received a text message.

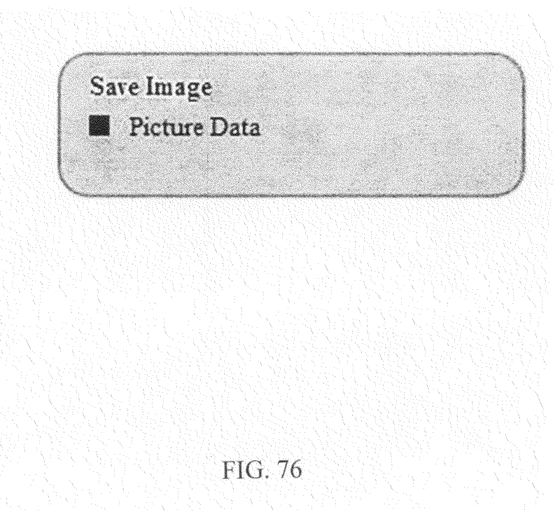

As shown in FIG. 76, “Save Image” components may include, for example, one input port. This input port may include, for example, “Picture Data”. Data input to “Picture Data” may be, for example, a “byte[ ]” data type. “Save Image” components may include, for example, no output ports.

“Save Image” components may, for example, save data input to “Picture Data” as a file on the associated device.

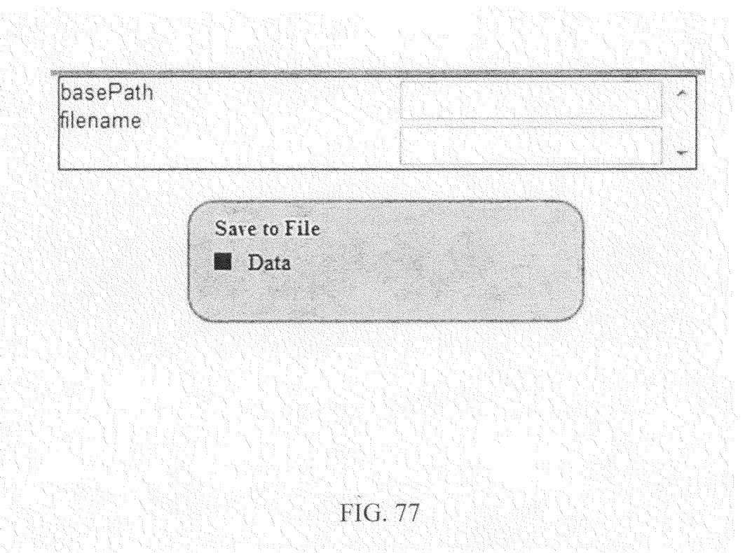

As shown in FIG. 77, “Save to File” components may include, for example, one input port. This input port may include, for example, “Data”. Data input to “Data” may be, for example, a “byte[ ]” data type. “Save to File” components may include, for example, no output ports.

“Save to File” components may, for example, save data input to “Data” as a file on the associated device. “Save to File” components may be similar to “Save Image” components, but may be generic to all file types.

As also shown in FIG. 77, “Save to File” components may include configurable properties set before compilation—but neither are displayed in the Default Activity Window. The configurable properties may, for example, identify a path to the database, and provide a name for the file. The configurable properties may, for example, be respectively designated as “basePath” and “fileName”.

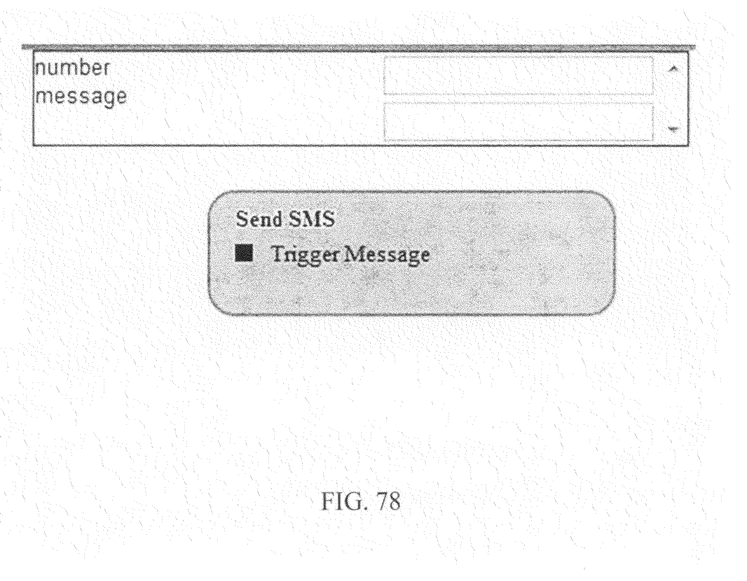

As shown in FIG. 78, “Send SMS” components may include, for example, one input port. This input port may include, for example, “Trigger Message”. Data input to “Trigger Message” may be, for example, a “java.lang.Integer” data type. “Send SMS” components may include, for example, no output ports.

When triggered by data input to “Trigger Message”, “Send SMS” components may, for example, forward messages set before compilation of an associated application to telephone numbers set before compilation of the associated application.

As also shown in FIG. 78, “Send SMS” components may include configurable properties set before compilation—but neither are displayed in the Default Activity Window. The configurable properties may, for example, identify the telephone number and message. The configurable properties may, for example, be respectively designated as “number” and “message”.

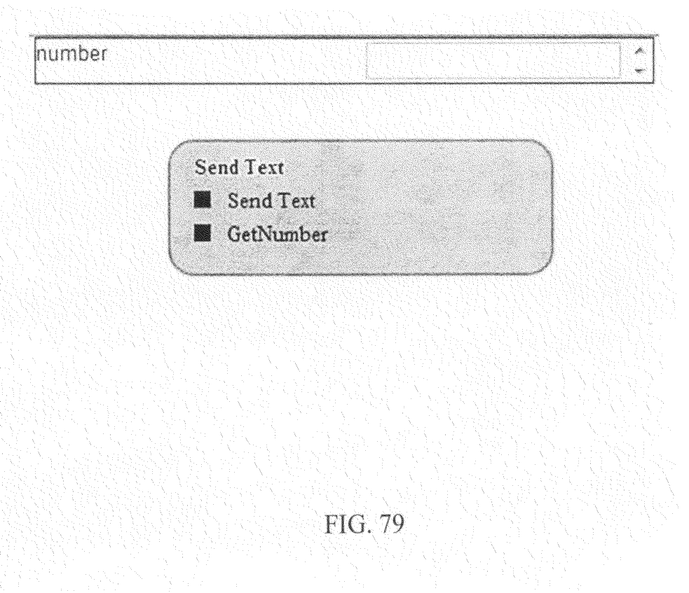

As shown in FIG. 79, “Send Text” components may include, for example, two input ports. These input ports may include, for example, “Send Text” and “Get Number”. Data input to “Send Text” may be, for example, a “java.lang.String” data type. Data input to “Get Number” may be, for example, a “java.lang.String” data type. “Send Text” components may include, for example, no output ports.

“Send Text” components may, for example, forward messages set at run time of an associated application to telephone numbers set before compilation of the associated application. “Send Text” components may, for example, forward messages set at run time of the associated application to telephone numbers set at run time of the associated application.

As also shown in FIG. 79, “Send Text” components may include configurable properties set before compilation—but neither are displayed in the Default Activity Window. The configurable properties may, for example, identify the telephone number. The configurable properties may, for example, be designated as “number”.

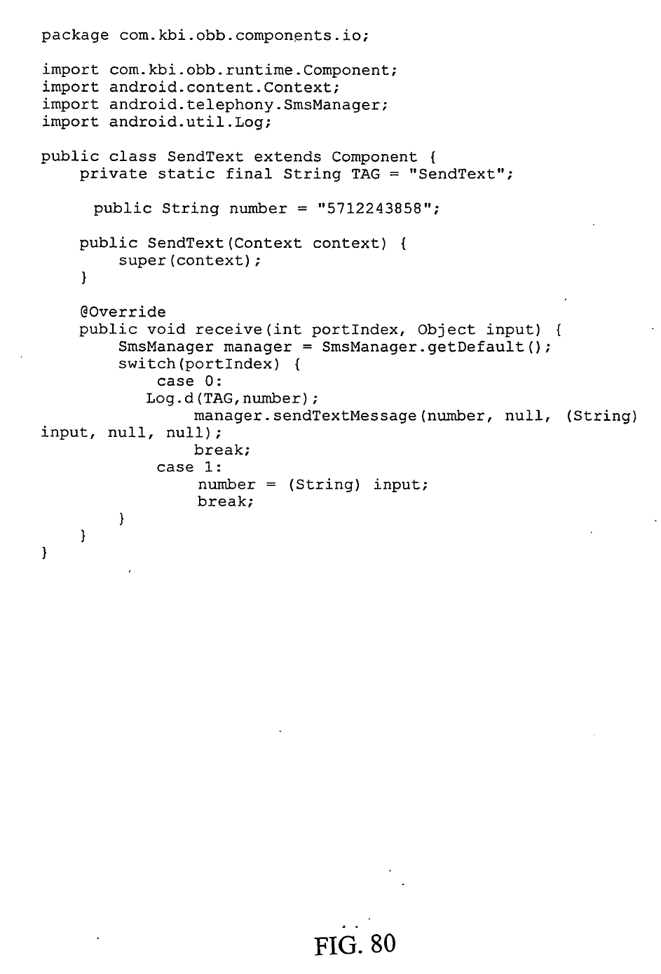

FIG. 80 provides an example of source code, written in the Java programming language, for “Send Text” components.

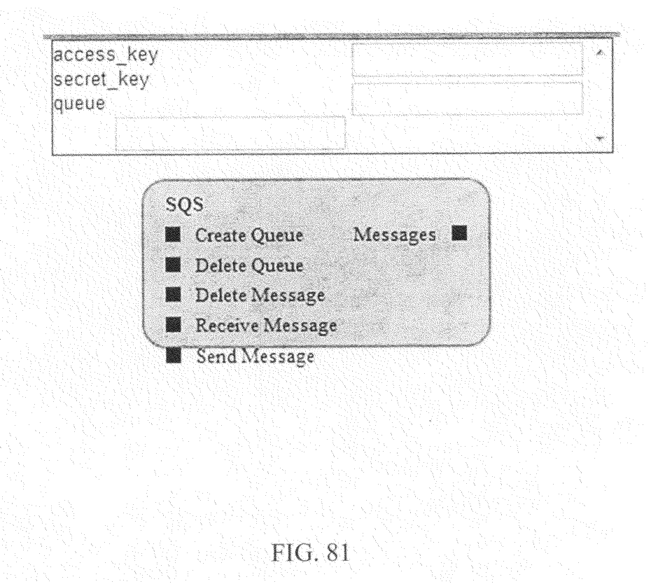

As shown in FIG. 81, “SQS” components may include, for example, five input ports. These input ports may include, for example, “Create Queue”, “Delete Queue”, “Delete Message”, “Receive Message”, and “Send Message”. Data input to “Create Queue” may be, for example, a “java.lang.String” data type. Data input to “Delete Queue” may be, for example, a “java.lang.String” data type. Data input to “Delete Message” may be, for example, a “java.lang.String” data type. Data input to “Receive Message” may be, for example, a “java.lang.Integer” data type. Data input to “Send Message” may be, for example, a “java.lang.String” data type. “SQS” components may include, for example, one output port. This output port may include, for example, “Messages”. Data output from “Messages” may be, for example, a “java.util.List<com.amazonaws.services.sqs.model.Message” data type.

“SQS” components may, for example, provide interfaces to the Amazon SQS.

As also shown in FIG. 81, “SQS” components may include configurable properties set before compilation—but neither are displayed in the Default Activity Window. The configurable properties may, for example, provide access and secret keys, and identify a queue. The configurable properties may, for example, be respectively designated as “access_key”, “secret_key”, and “queue”.

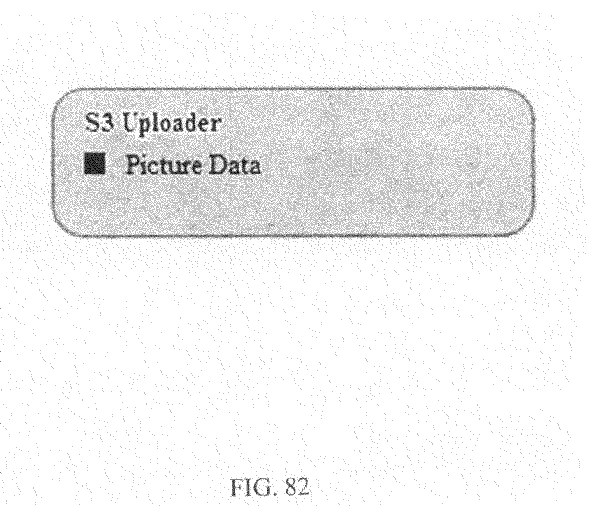

As shown in FIG. 82, “S3 Uploader” components may include, for example, one input port. This input port may include, for example, “Picture Data”. Data input to “Picture Data” may be, for example, a “byte[ ]” data type. “S3 Uploader” components may include, for example, no output ports.

“S3 Uploader” components may, for example, allow upload of picture data to the Amazon SQS.

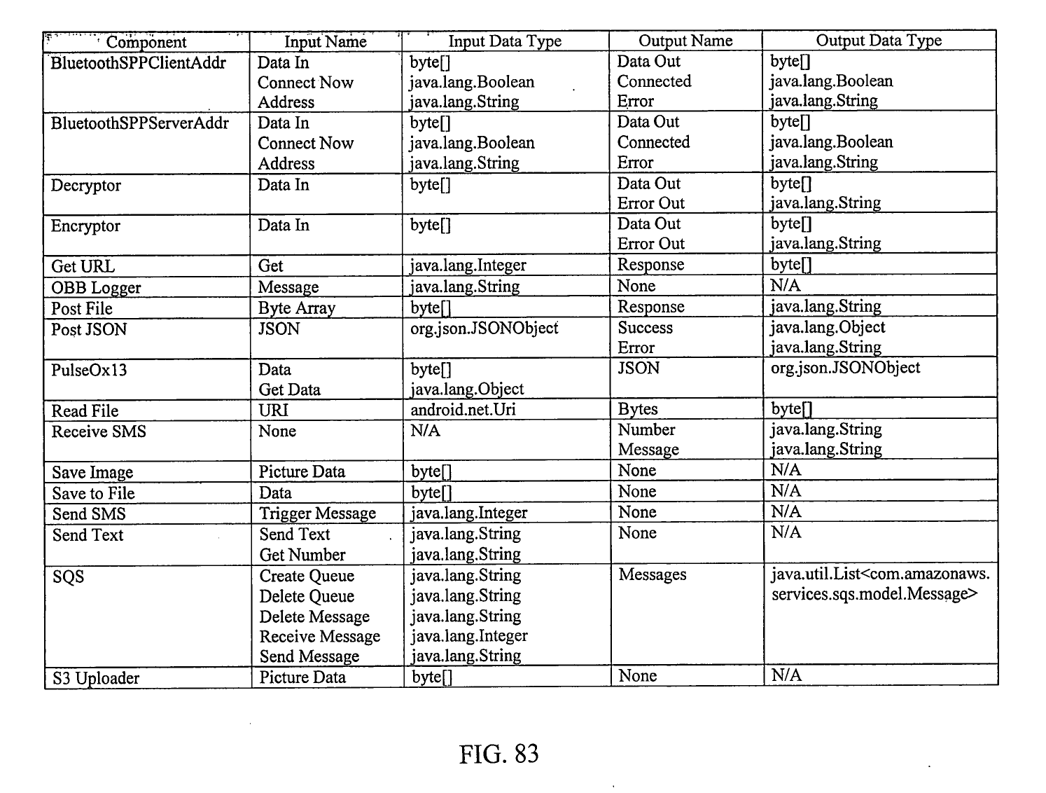

Related information regarding some example embodiments of input/output components may be found in the table of FIG. 83.

### 10. Example Components

### Hardware Components

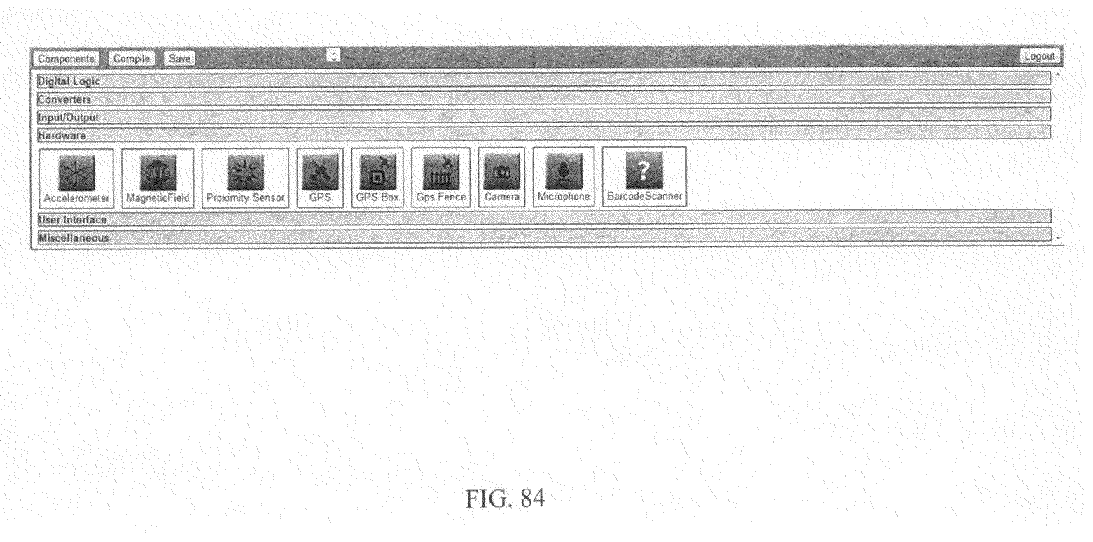

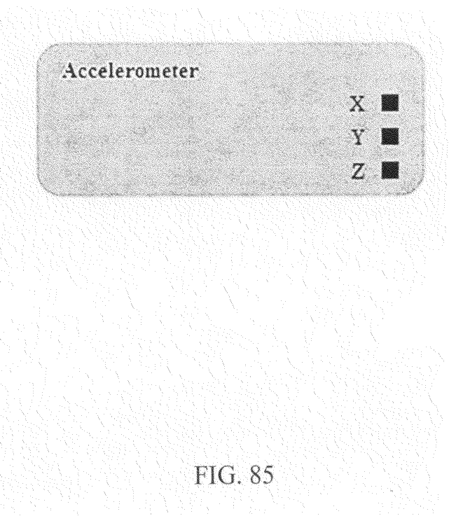

In some example embodiments, hardware components may include, but are not limited to, “Accelerometer” components, “Barcode Scanner” components, “Camera” components, “Global Positioning System” (“GPS”) components, “GPS Box” components, “GPS Fence” components, “Magnetic Field” components, “Microphone” components, and “Proximity Sensor” components. FIG. 84 is a screenshot showing some example embodiments of hardware components.

As shown in FIG. 85, “Accelerometer” components may include, for example, no input ports. “Accelerometer” components may include, for example, three output ports. These output ports may include, for example, “X”, “Y”, and “Z”. Data output from “X” may be, for example, a “java.lang.Float” data type. Data output from “Y” may be, for example, a “java.lang.Float” data type. Data output from “Z” may be, for example, a “java.lang.Float” data type.

“Accelerometer” components may output data, for example, corresponding to sensed accelerations in an orthogonal coordinate system (e.g., an XYZ coordinate system) of an associated accelerometer of a device.

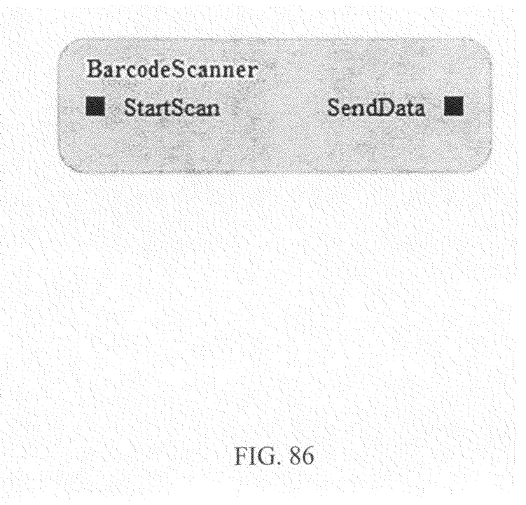

As shown in FIG. 86, “Barcode Scanner” components may include, for example, one input port. This input port may include, for example, “Start Scan”. Data input to “Start Scan” may be, for example, a “java.lang.Object” data type. “Barcode Scanner” components may include, for example, one output port. This output port may include, for example, “Send Data”. Data output from “Send Data” may be, for example, an “org.json.JSONArray” data type.

“Barcode Scanner” components may receive a trigger input to “Start Scan” causing, for example, a scanning-capable device to scan a bar code, QR code, or similar object. “Barcode Scanner” components may output whatever data the bar code, QR code, or similar object represents.

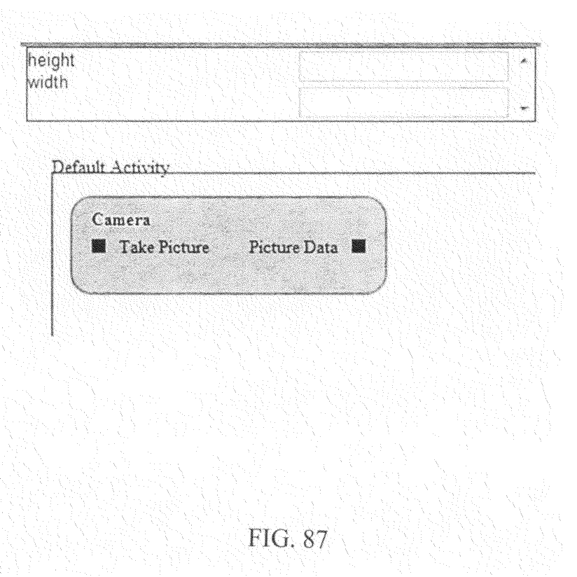

As shown in FIG. 87, “Camera” components may include, for example, one input port. This input port may include, for example, “Take Picture”. Data input to “Take Picture” may be, for example, an “java.lang.Integer” data type. “Camera” components may include, for example, one output port. This output port may include, for example, “Picture Data”. Data output from “Picture Data” may be, for example, a “byte[ ]” data type.

When triggered by data input to “Take Picture”, “Camera” components may output data, for example, corresponding to the picture taken. The picture taken may appear on a viewing display of the associated device. “Camera” components may be different than “Embedded Camera” components.

As shown in FIG. 87, “Camera” components—displayed in the Default Activity Window, may include configurable properties set before compilation—but not displayed in the Default Activity Window. The configurable properties may, for example, define the height and width of the picture on the viewing display. The configurable properties may, for example, be respectively designated as “height” and “width”. Height may be set, for example, in pixels. Width may be set, for example, in pixels.

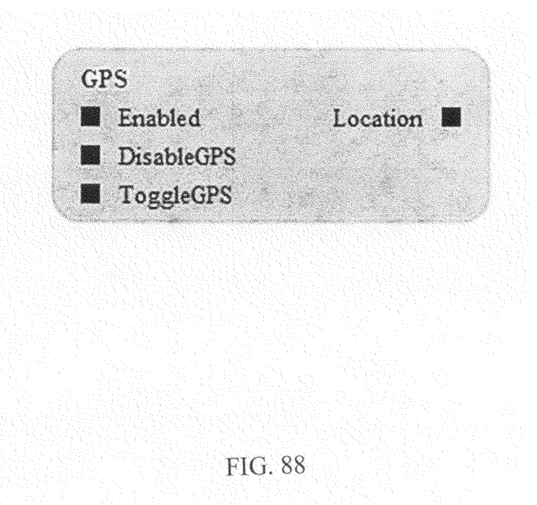

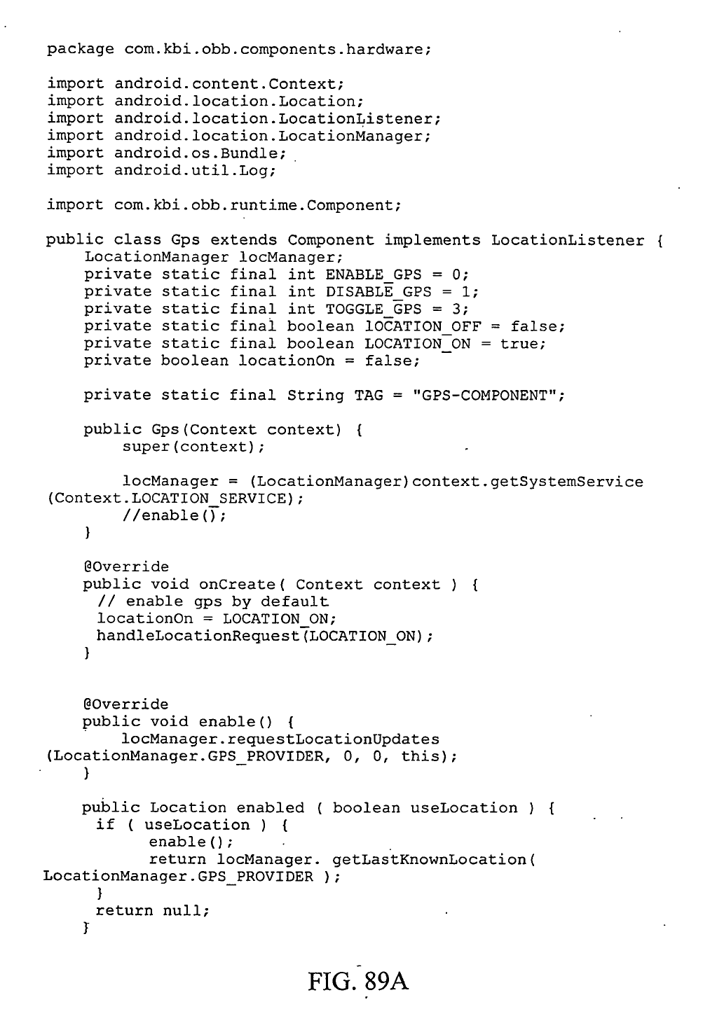

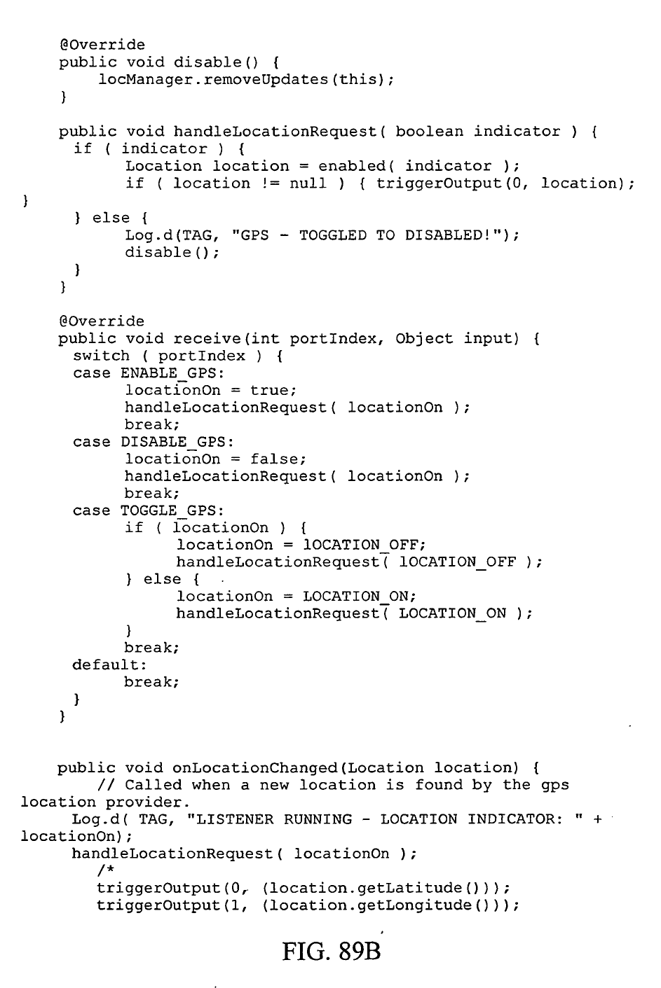

As shown in FIG. 88, “GPS” components may include, for example, three input ports. These input ports may include, for example, “Enabled”, “Disable GPS”, and “Toggle GPS”. Data input to “Enabled” may be, for example, a “java.lang.Integer” data type. Data input to input to “Disable GPS” may be, for example, a “java.lang.Integer” data type. Data input to “Toggle GPS” may be, for example, a “java.lang.Integer” data type. “GPS” components may include, for example, one output port. This output port may include, for example, “Location”. Data output from “Location” may be, for example, an “android.location.Location” data type.

When in an enabled state, “GPS” components may output data, for example, corresponding to a GPS location of an associated device. If “GPS” components are in a disabled state, data input to “Enabled” may trigger “GPS” components to an enabled state. If “GPS” components are in an enabled state, data input to “Disable GPS” may trigger “GPS” components to a disabled state. If “GPS” components are in an enabled state, data input to “Toggle GPS” may trigger “GPS” components to a disabled state. If “GPS” components are in a disabled state, data input to “Toggle GPS” may trigger “GPS” components to an enabled state.

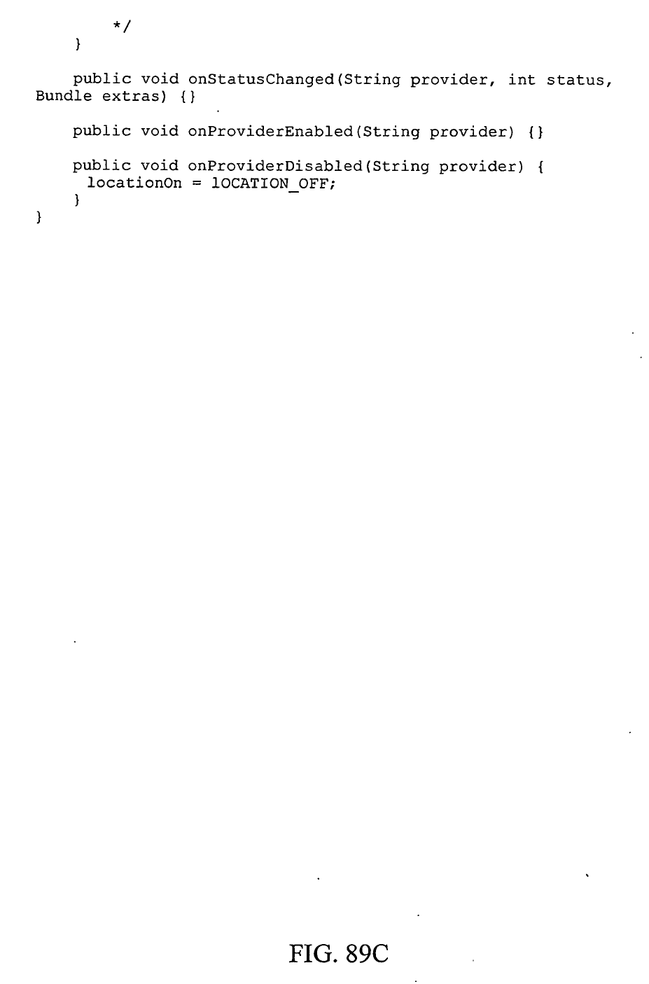

FIGS. 89A-89C provide an example of source code, written in the Java programming language, for “GPS” components.

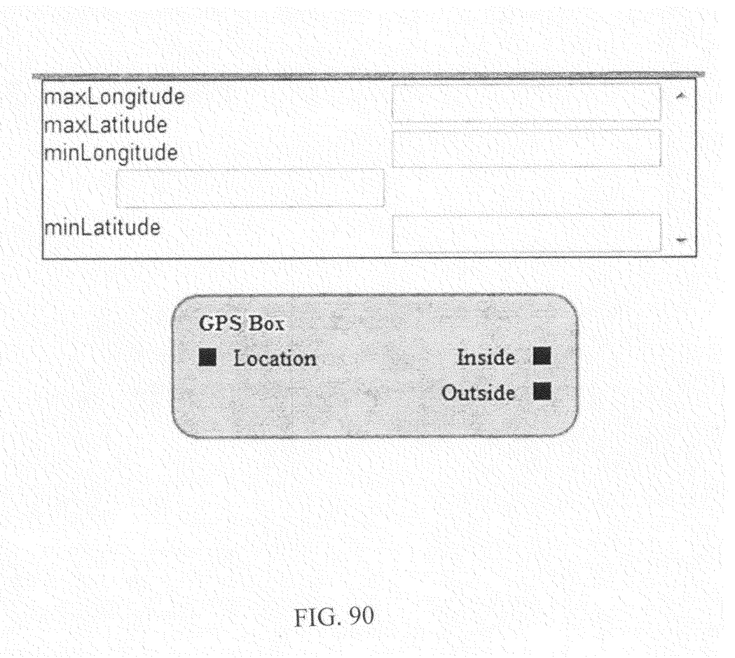

As shown in FIG. 90, “GPS Box” components may include, for example, one input port. This input port may include, for example, “Location”. Data input to “Location” may be, for example, an “android.location.Location” data type. “GPS Box” components may include, for example, two output ports. These output ports may include, for example, “Inside” and “Outside”. Data output from “Inside” may be, for example, a “java.lang.Integer” data type. Data output from “Outside” may be, for example, a “java.lang.Integer” data type.

“GPS Box” components may output data, for example, corresponding to whether an associated device is inside or outside of a rectangular box defined by configurable properties based on the data input to “Location”.

As also shown in FIG. 90, “GPS Box” components—displayed in the Default Activity Window, may include configurable properties set before compilation—but not displayed in the Default Activity Window. The configurable properties may, for example, define the rectangular box based on maximum longitude, maximum latitude, minimum longitude, and minimum latitude. The configurable properties may, for example, be respectively designated as “maxLongitude”, “maxLatitude”, “minLongitude”, and “minLatitude”.

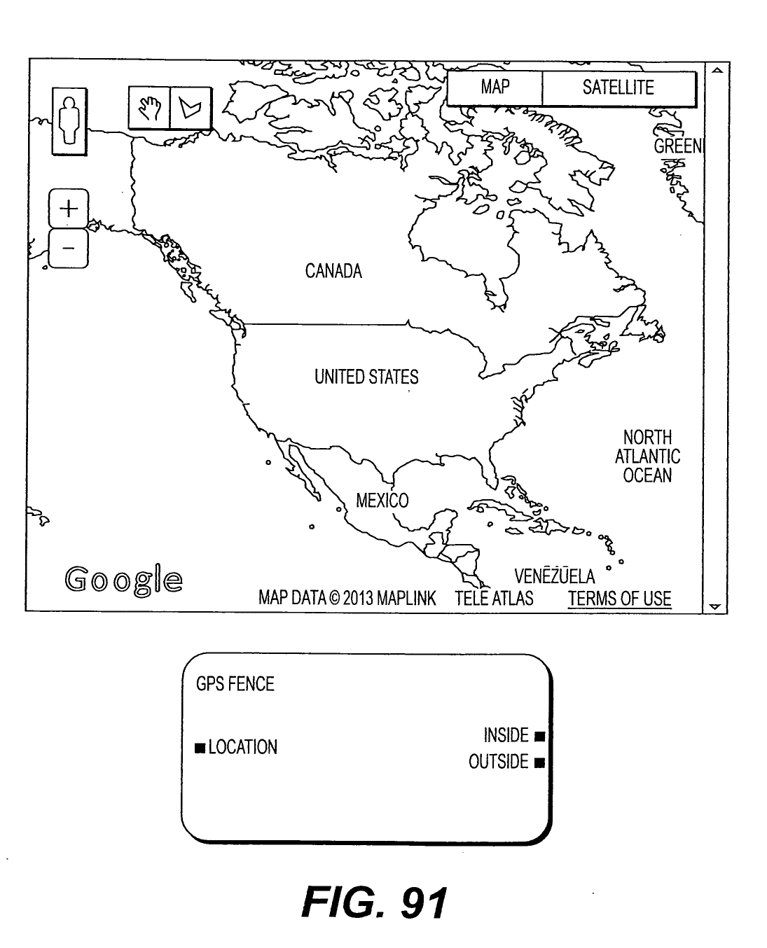

As shown in FIG. 91, “GPS Fence” components may include, for example, one input port. This input port may include, for example, “Location”. Data input to “Location” may be, for example, an “android.location.Location” data type. “GPS Fence” components may include, for example, two output ports. These output ports may include, for example, “Inside” and “Outside”. Data output from “Inside” may be, for example, a “java.lang.Integer” data type. Data output from “Outside” may be, for example, a “java.lang.Integer” data type.

“GPS Fence” components may output data, for example, corresponding to whether an associated device is inside or outside of a polygon defined by configurable properties based on the data input to “Location”.

As also shown in FIG. 91, “GPS Fence” components may include configurable properties, set before compilation, using, for example, a mapping program (e.g., Google Maps™, OpenStreetMap). The configurable properties (e.g., pointing and clicking) may allow definition of a geographic polygon with any shape (does not have to be a regular polygon) and any number of sides (three or more).

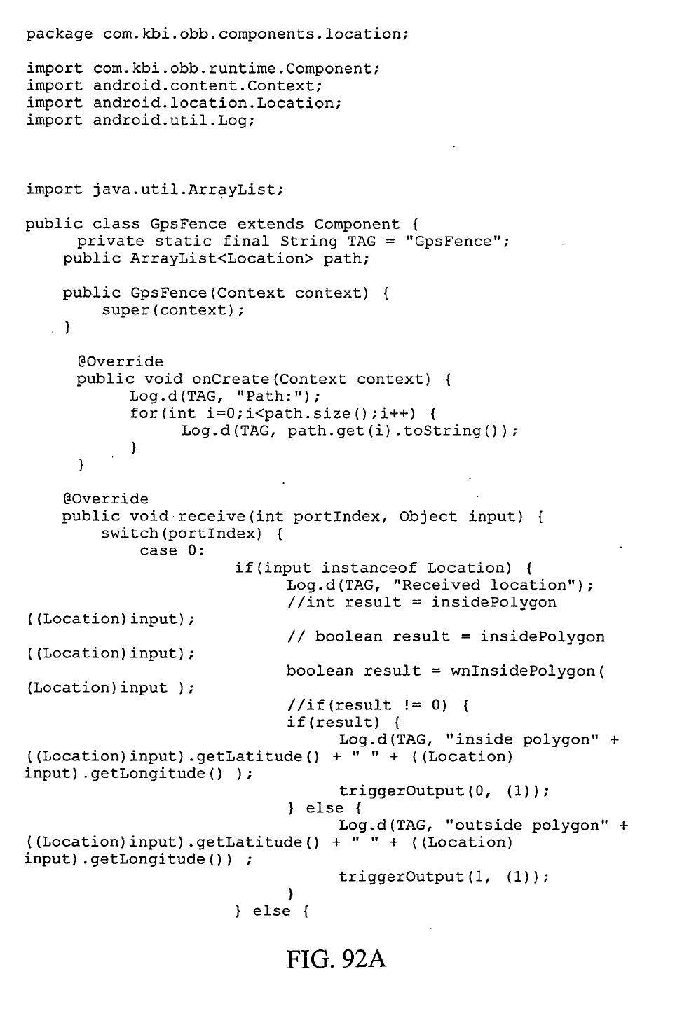

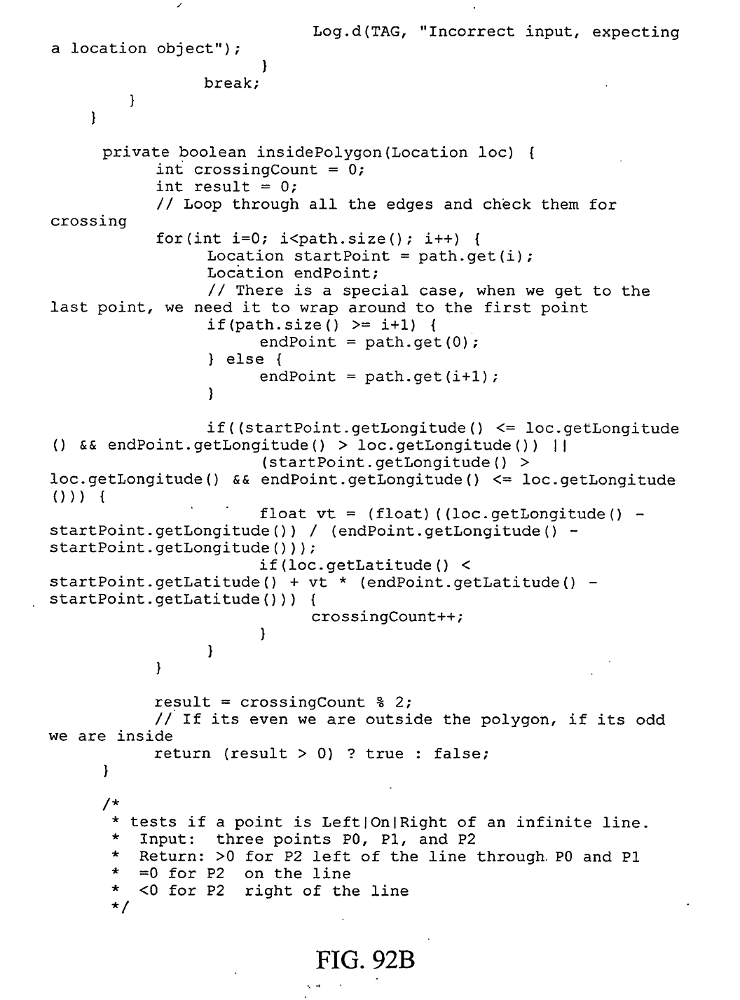

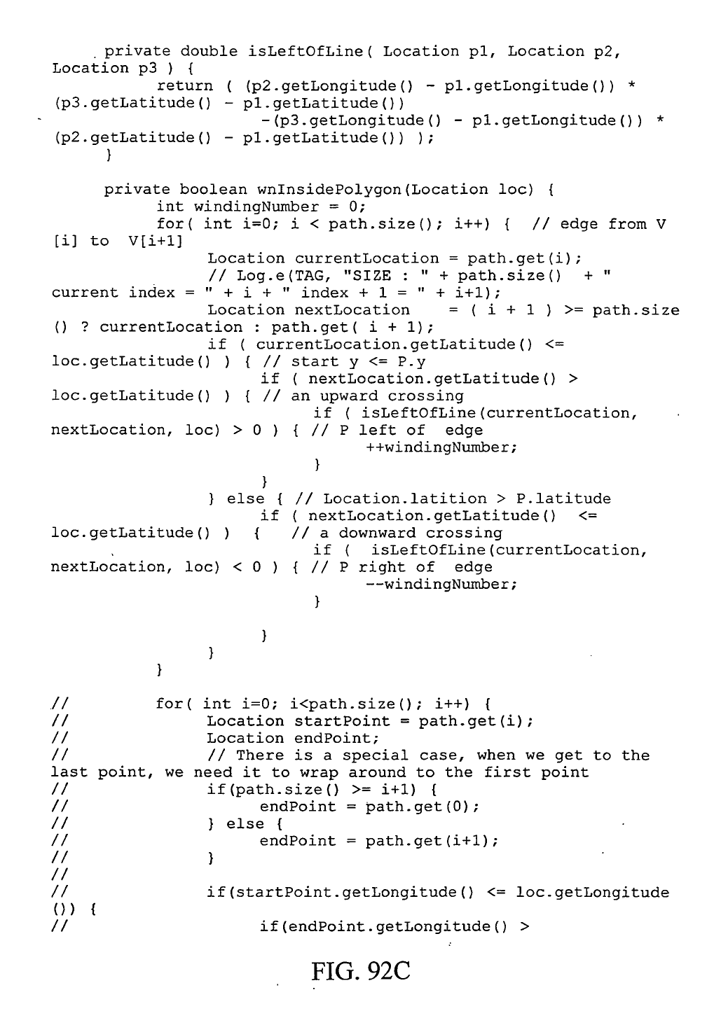

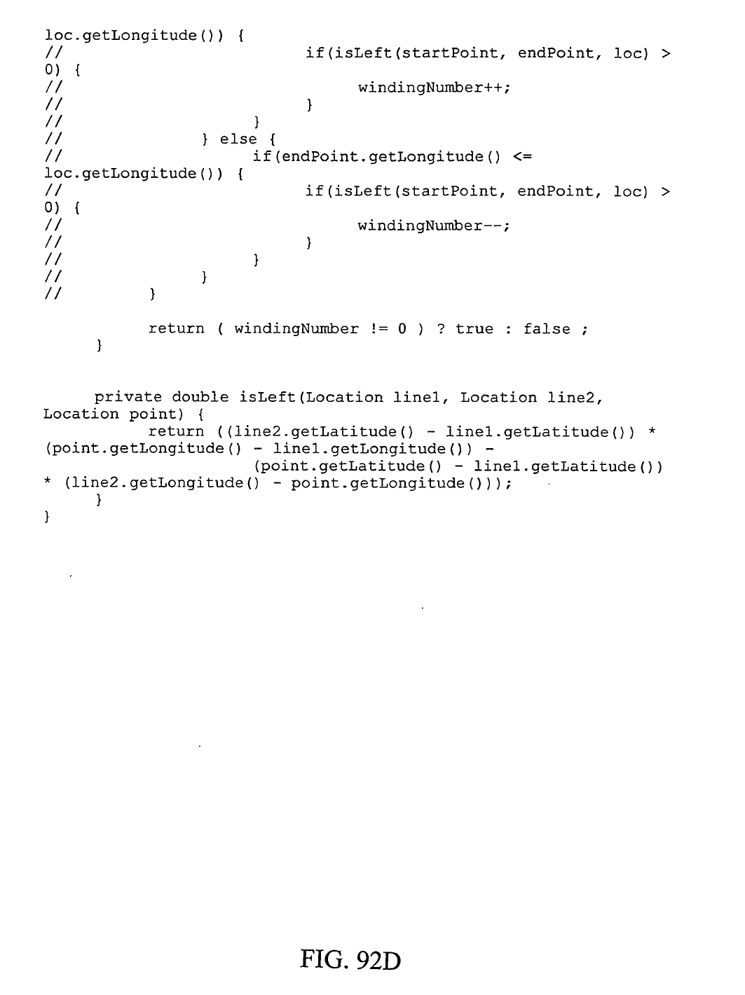

FIGS. 92A-92D provide an example of source code, written in the Java programming language, for “GPS Fence” components.

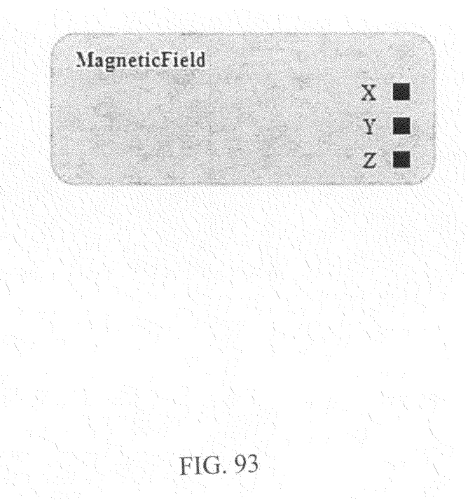

As shown in FIG. 93, “Magnetic Field” components may include, for example, no input ports. “Magnetic Field” components may include, for example, three output ports. These output ports may include, for example, “X”, “Y”, and “Z”. Data output from “X” may be, for example, a “java.lang.Float” data type. Data output from “Y” may be, for example, a “java.lang.Float” data type. Data output from “Z” may be, for example, a “java.lang.Float” data type.

“Magnetic Field” components may output data, for example, corresponding to sensed magnetic fields in an orthogonal coordinate system (e.g., an XYZ coordinate system) of an associated magnetic field sensor of a device.

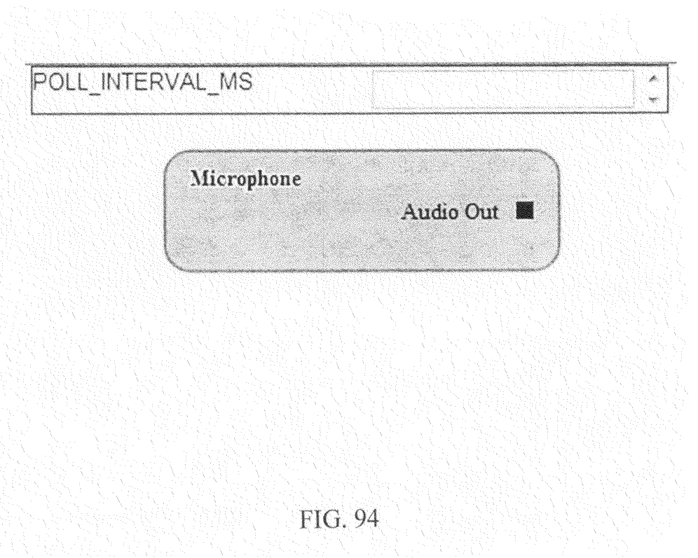

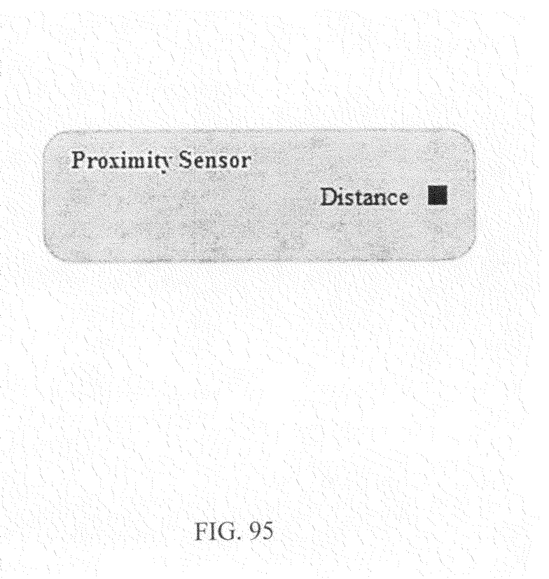

As shown in FIG. 94, “Microphone” components may include, for example, no input ports. “Microphone” components may include, for example, one output port. This output port may include, for example, “Audio Out”. Data output from “Audio Out” may be, for example, a “java.lang.Double” data type.

“Microphone” components may output data, for example, corresponding to sensed audio level (e.g., in decibels) of an microphone of a device.

As also shown in FIG. 94, “Microphone” components—displayed in the Default Activity Window, may include configurable properties set before compilation—but not displayed in the Default Activity Window. The configurable properties may, for example, indicate how often audio level is sampled (e.g., in milliseconds). The configurable properties may, for example, be designated as “POLL_INTERVAL_MS”).

As shown in FIG. 95, “Proximity Sensor” components may include, for example, no input ports. “Proximity Sensor” components may include, for example, one output port. This output port may include, for example, “Distance”. Data output from “Distance” may be, for example, a “java.lang.Float” data type.

“Proximity Sensor” components may output data, for example, that causes an associated device to change a mode of operation (e.g., using output of a light sensor associated with a cellphone to turn off its video display when the cellphone is placed near the ear of a user; light sensor detects lower level of received ambient light due to user's head blocking light sensor).

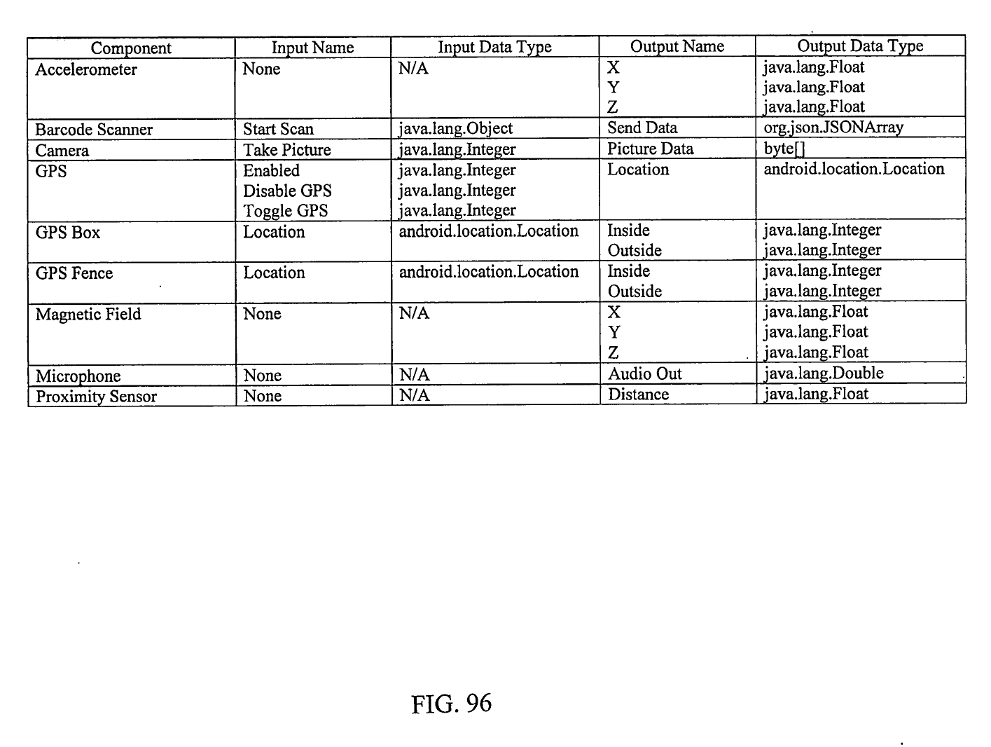

Related information regarding some example embodiments of hardware components may be found in the table of FIG. 96.

### 11. Example Components

### User Interface Components

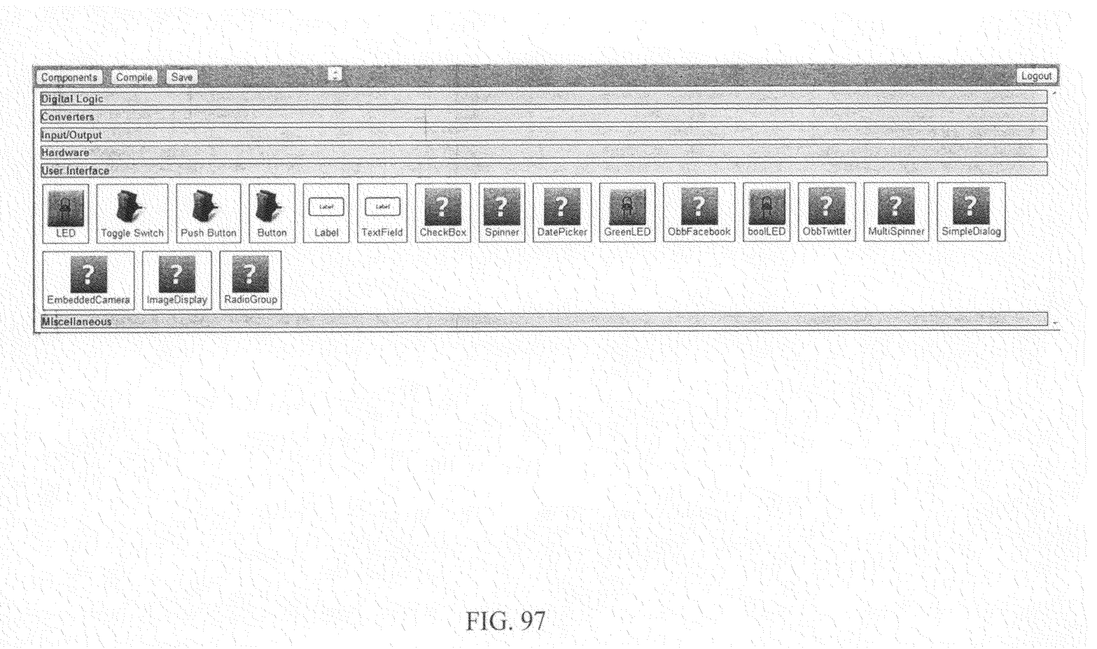

In some example embodiments, user interface components may include, but are not limited to, “Boolean LED” components, “Button” components, “Check Box” components, “Date Picker” components, “Embedded Camera” components, “Green LED” components, “Image Display” components, “Label” components, “LED” components, “Multi Spinner” components, “ObbFacebook” components, “ObbTwitter” components, “Push Button” components, “Radio Group” components, “Simple Dialog” components, “Spinner” components, “Text Field” components, and “Toggle Switch” components. FIG. 97 is a screenshot showing some example embodiments of user interface components.

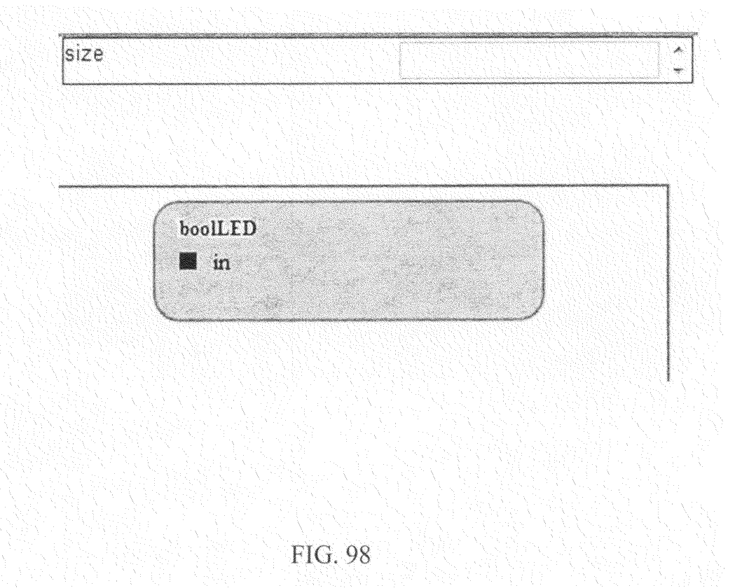

As shown in FIG. 98, “Boolean LED” components may include, for example, one input port. This input port may include, for example, “In”. Data input to “In” may be, for example, a “java.lang.Boolean” data type. “Boolean LED” components may include, for example, no output ports.

When triggered by data input to “In”, “Boolean LED” components may turn “on” or “off”. Conventionally, triggering by data input of “True” to “In” turns “LED” components “on”, while triggering by data input of “False” to “In” turns “Boolean LED” components “off”. However, other combinations may be used, such as triggering by data input of “True” to “In” turns “Boolean LED” components “off”, while triggering by data input of “False” to “In” turns “Boolean LED” components “on”.

“Boolean LED” components may, for example, serve diagnostic functions among other uses.

As also shown in FIG. 98, “Boolean LED” components—displayed in the Default Activity Window, may include configurable properties set before compilation—but not displayed in the Default Activity Window. The configurable properties may, for example, identify an LED size on a viewing display of the associated device. The configurable properties may, for example, be designated as “size”.

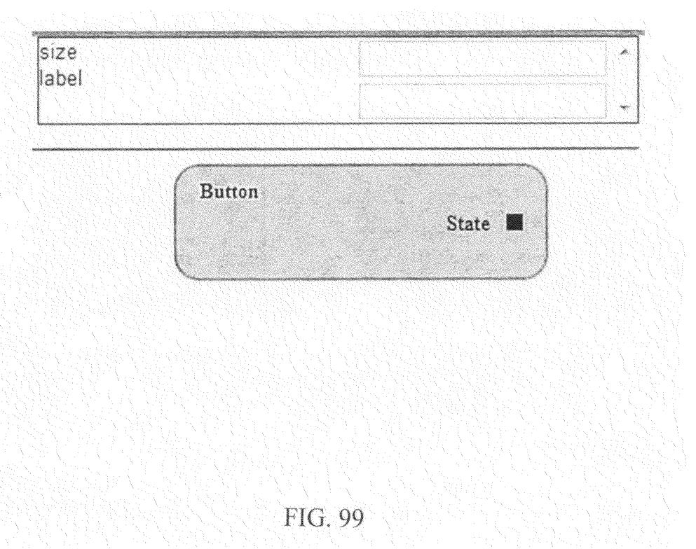

As shown in FIG. 99, “Button” components may include, for example, no input ports. “Button” components may include, for example, one output port. This output port may include, for example, “State”. Data output from “State” may be, for example, a “java.lang.Integer” data type.

“Button” components may, for example, provide a single output when pressed or when pressed and released.

As also shown in FIG. 99, “Button” components—displayed in the Default Activity Window, may include configurable properties set before compilation—but not displayed in the Default Activity Window. The configurable properties may, for example, identify a button size on a viewing display of the associated device and a label describing button function. The configurable properties may, for example, be respectively designated as “size” and “label”.

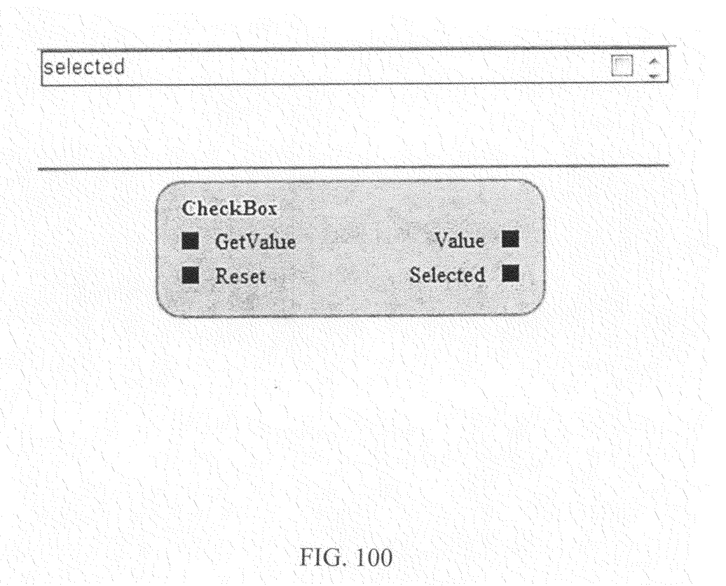

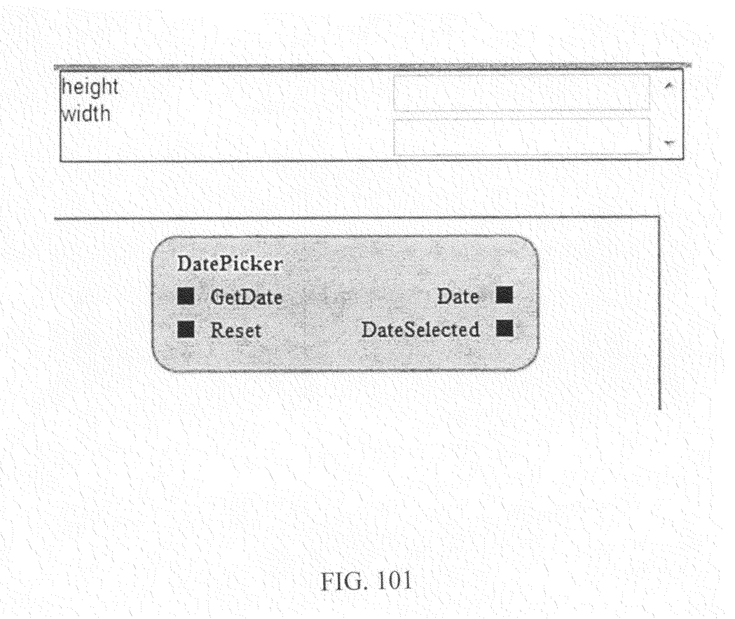

As shown in FIG. 100, “Check Box” components may include, for example, two input ports. These input ports may include, for example, “Get Value” and “Reset”. Data input to “Get Value” may be, for example, a “java.lang.Object” data type. Data input to “Reset” may be, for example, a “java.lang.Object” data type. “Check Box” components may include, for example, two output ports. These output ports may include, for example, “Value” and “Selected”. Data output from “Value” may be, for example, a “java.lang.Boolean” data type. Data output from “Selected” may be, for example, a “java.lang.Boolean” data type.

“Check Box” components may allow, for example, a check box to be shown on a viewing display of an associated device. “Check Box” components also may allow, for example, a user to select and deselect the check box.

As also shown in FIG. 100, “Check Box” components—displayed in the Default Activity Window, may include configurable properties set before compilation—but not displayed in the Default Activity Window. The configurable properties may, for example, provide a way to select and deselect the check box. The configurable properties may, for example, be designated as “selected”.

As shown in FIG. 101, “Date Picker” components may include, for example, two input ports. These input ports may include, for example, “Get Date” and “Reset”. Data input to “Get Date” may be, for example, a “java.lang.Object” data type. Data input to “Reset” may be, for example, a “java.lang.Object” data type. “Date Picker” components may include, for example, two output ports. These output ports may include, for example, “Date” and “Date Selected”. Data output from “Date” may be, for example, a “java.util.Date” data type. Data output from “Date Selected” may be, for example, a “java.util.Date” data type.

“Date Picker” components may provide, for example, a widget—to be shown on a viewing display of an associated device—for selecting a date.

As also shown in FIG. 101, “Date Picker” components—displayed in the Default Activity Window, may include configurable properties set before compilation—but not displayed in the Default Activity Window. The configurable properties may, for example, define the height and width of the widget displayed on the viewing display of the associated device. The configurable properties may, for example, be respectively designated as “height” and “width”. Height may be set, for example, in pixels. Width may be set, for example, in pixels.

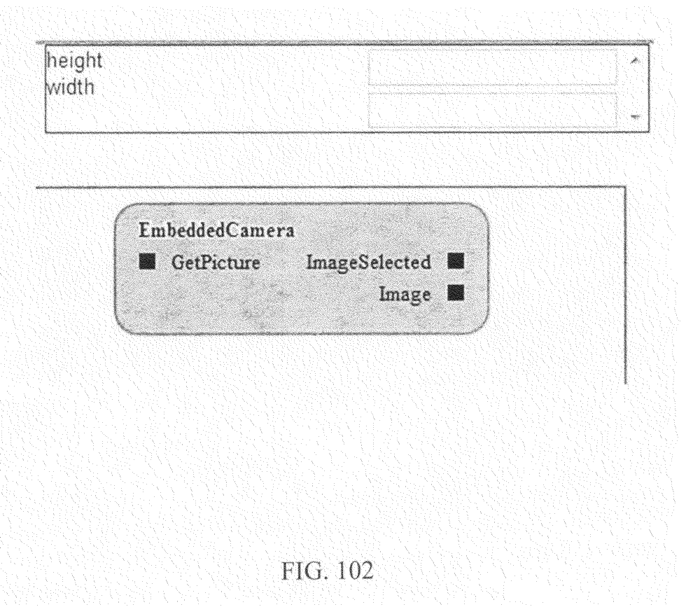

As shown in FIG. 102, “Embedded Camera” components may include, for example, one input port. This input port may include, for example, “Get Picture”. Data input to “Get Picture” may be, for example, a “java.lang.Object” data type. “Embedded Camera” components may include, for example, two output ports. These output ports may include, for example, “Image Selected” and “Image”. Data output from “Image Selected” may be, for example, a “android.net.Uri” data type. Data output from “Image” may be, for example, a “android.net.Uri” data type.

When triggered by data input to “Get Picture”, “Embedded Camera” components may output data, for example, corresponding to picture taken by a camera application of the associated device. The picture taken may appear on a viewing display of the associated device.

As also shown in FIG. 102, “Embedded Camera components—displayed in the Default Activity Window, may include configurable properties set before compilation—but not displayed in the Default Activity Window. The configurable properties may, for example, define the height and width of the picture on the viewing display of the associated device. The configurable properties may, for example, be respectively designated as “height” and “width”. Height may be set, for example, in pixels. Width may be set, for example, in pixels.

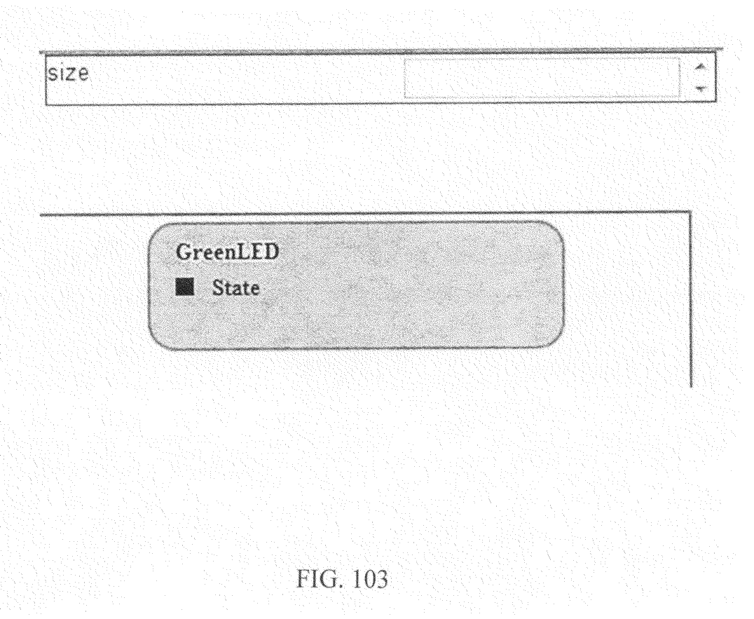

As shown in FIG. 103, “Green LED” components may include, for example, one input port. This input port may include, for example, “State”. Data input to “State” may be, for example, a “java.lang.Integer” data type. “Green LED” components may include, for example, no output ports.

When triggered by data input to “State”, “Green LED” components may turn “on” or “off”. Conventionally, triggering by data input of “1” to “State” turns “LED” components “on”, while triggering by data input of “0” to “State” turns “Green LED” components “off”. However, other combinations may be used, such as triggering by data input of “1” to “State” turns “Green LED” components “off”, while triggering by data input of “0” to “State” turns “Green LED” components “on”.

“Green LED” components may, for example, serve diagnostic functions among other uses.

As also shown in FIG. 103, “Green LED” components—displayed in the Default Activity Window, may include configurable properties set before compilation—but not displayed in the Default Activity Window. The configurable properties may, for example, identify an LED size on a viewing display of the associated device. The configurable properties may, for example, be designated as “size”.

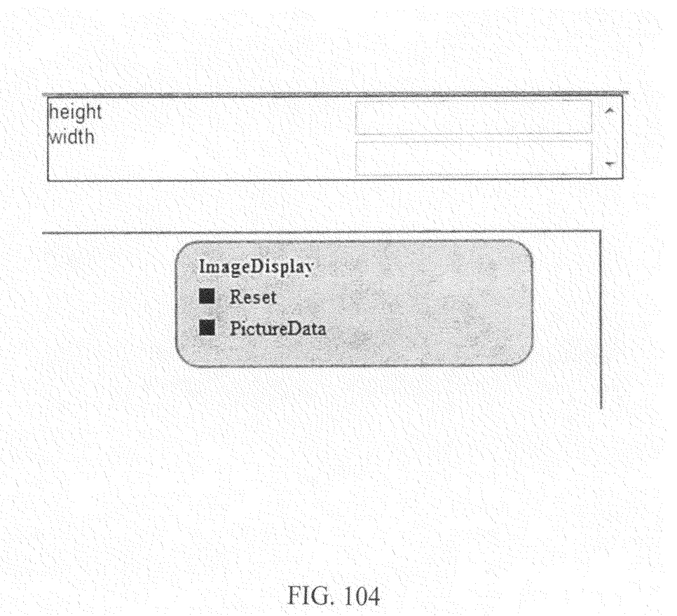

As shown in FIG. 104, “Image Display” components may include, for example, two input ports. These input ports may include, for example, “Reset” and “Picture Data”. Data input to “Reset” may be, for example, a “java.lang.Object” data type. Data input to “Picture Data” may be, for example, an “android.net.Uri” data type. “Image Display” components may include, for example, no output ports.

Data input to “Reset” may, for example, clear current display. A URI input to “Picture Data” may, for example, display a picture at the URI.

As also shown in FIG. 104, “Image Display” components—displayed in the Default Activity Window, may include configurable properties set before compilation—but not displayed in the Default Activity Window. The configurable properties may, for example, define the height and width of images displayed on the viewing display of the associated device. The configurable properties may, for example, be respectively designated as “height” and “width”. Height may be set, for example, in pixels. Width may be set, for example, in pixels.

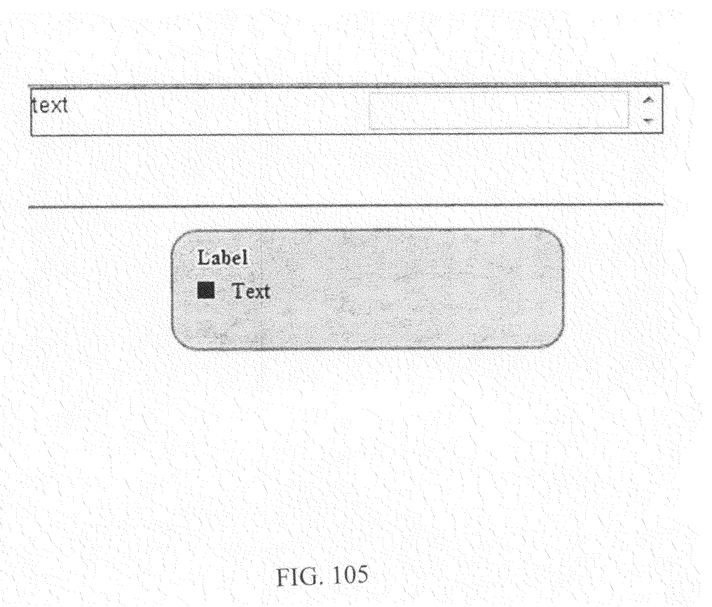

As shown in FIG. 105, “Label” components may include, for example, one input port. This input port may include, for example, “Text”. Data input to “Text” may be, for example, a “java.lang.String” data type. “Label” components may include, for example, no output ports.

Data input to “Text” may set the text of labels at run time of an associated application. Data input to “Text” may override configurable properties, set before compilation, such as default values.

“Label” components may, for example, provide labels on a viewing display of the associated device.

As also shown in FIG. 105, “Label” components—displayed in the Default Activity Window, may include configurable properties set before compilation—but not displayed in the Default Activity Window. The configurable properties may, for example, identify text of labels on a viewing display of the associated device. The configurable properties may, for example, be designated as “text”.

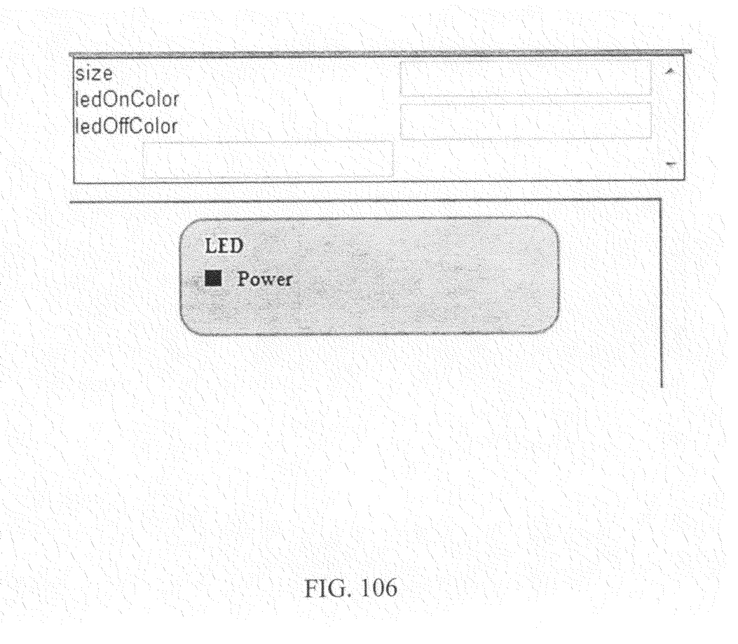

As shown in FIG. 106, “LED” components may include, for example, one input port. This input port may include, for example, “Power”. Data input to “Power” may be, for example, a “java.lang.Integer” data type. “LED” components may include, for example, no output ports.

When triggered by data input to “Power”, “LED” components may turn “on” or “off”. Conventionally, triggering by data input of “1” to “Power” turns “LED” components “on”, while triggering by data input of “0” to “Power” turns “LED” components “off”. However, other combinations may be used, such as triggering by data input of “1” to “Power” turns “LED” components “red”, while triggering by data input of “0” to “Power” turns “LED” components “green”.

“LED” components may, for example, serve diagnostic functions among other uses.

As also shown in FIG. 106, “LED” components—displayed in the Default Activity Window, may include configurable properties set before compilation—but not displayed in the Default Activity Window. The configurable properties may, for example, identify an LED size on a viewing display of the associated device, color of the LED when “on”, and color of the LED when “off”. The configurable properties may, for example, be respectively designated as “size”, “ledOnColor”, and “ledOffColor”.

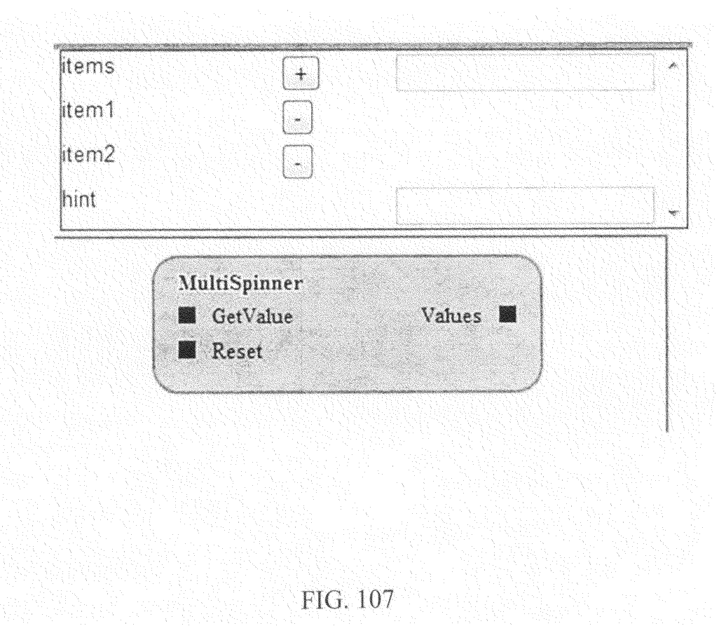

As shown in FIG. 107, “Multi Spinner” components may include, for example, two input ports. These input ports may include, for example, “Get Value” and “Reset”. Data input to “Get Value” may be, for example, a “java.lang.Object” data type. Data input to “Reset” may be, for example, a “java.lang.Object” data type. “Multi Spinner” components may include, for example, one output port. This output ports may include, for example, “Values”. Data output from “Values” may be, for example, a “java.util.ArrayList<String>” data type.

“Multi Spinner” components may allow, for example, a drop-down list to be shown on a viewing display of an associated device. “Multi Spinner” components may allow, for example, a user to make one or more selections from the drop-down list.

As also shown in FIG. 107, “Multi Spinner” components—displayed in the Default Activity Window, may include configurable properties set before compilation—but not displayed in the Default Activity Window. The configurable properties may, for example, provide a list of choices, a way of making the one or more selections from the drop-down list, and a hint. The configurable properties may, for example, be designated as “items”, “item 1”, “item 2”, and “hint”.

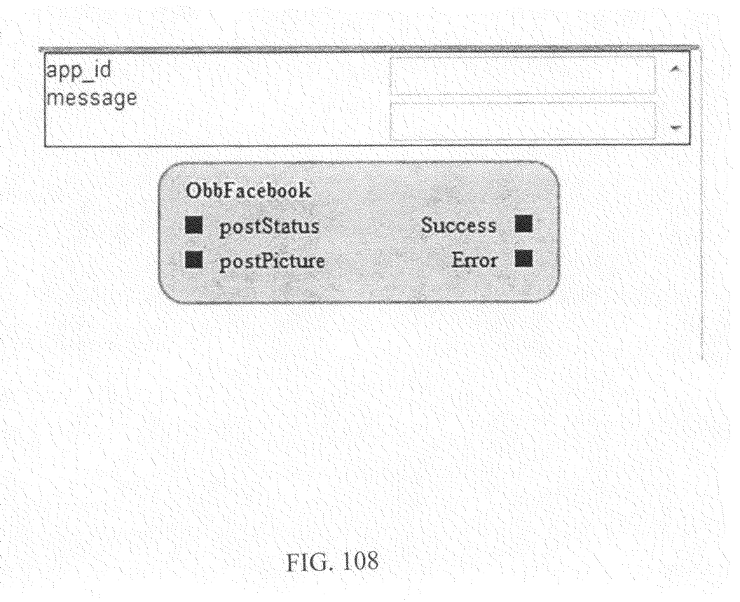

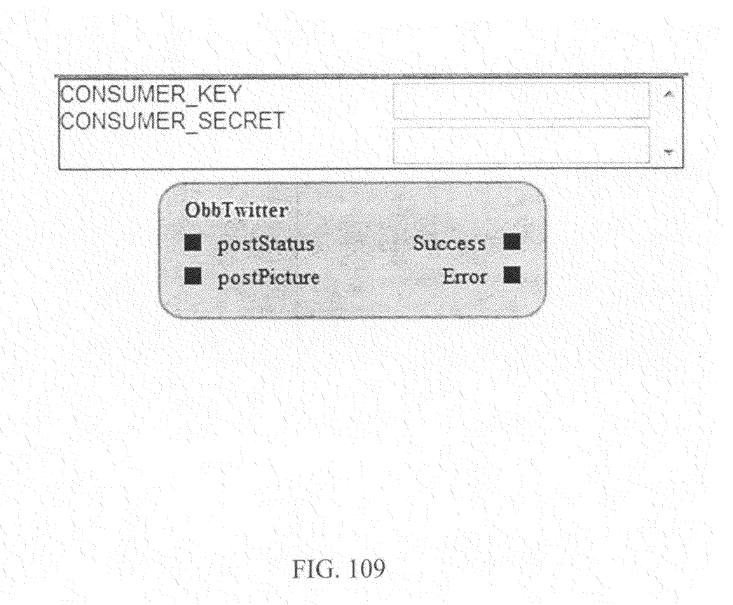

As shown in FIG. 108, “ObbFacebook” components may include, for example, two input ports. These input ports may include, for example, “Post Status” and “Post Picture”. Data input to “Post Status” may be, for example, a “java.lang.String” data type. Data input to “Post Picture” may be, for example, a “byte[ ]” data type. “ObbFacebook” components may include, for example, two output ports. These output ports may include, for example, “Success” and “Error”. Data output from “Success” may be, for example, a “java.lang.String” data type. Data output from “Error” may be, for example, a “java.lang.String” data type.

“ObbFacebook” components may, for example, work with Facebook Application Programming Interfaces (“APIs”) to post statuses on Facebook from data input to “Post Status”. “ObbFacebook” components may, for example, work with Facebook APIs to post pictures on Facebook from data input to “Post Picture”.

As also shown in FIG. 108, “ObbFacebook” components—displayed in the Default Activity Window, may include configurable properties set before compilation—but not displayed in the Default Activity Window. The configurable properties may, for example, provide account access values from Twitter when one signs up for Twitter APIs. The configurable properties may, for example, be respectively designated may be designated as “app_id” and “message”.

As shown in FIG. 109, “ObbTwitter” components may include, for example, two input ports. These input ports may include, for example, “Post Status” and “Post Picture”. Data input to “Post Status” may be, for example, a “java.lang.String” data type. Data input to “Post Picture” may be, for example, a “java.lang.String” data type. “ObbTwitter” components may include, for example, two output ports. These output ports may include, for example, “Success” and “Error”. Data output from “Success” may be, for example, a “java.lang.String” data type. Data output from “Error” may be, for example, a “java.lang.String” data type.

“ObbTwitter” components may, for example, work with Twitter APIs to post statuses on Twitter from data input to “Post Status”. “ObbTwitter” components may, for example, work with Twitter APIs to post pictures on Twitter from data input to “Post Picture”.

As also shown in FIG. 109, “ObbTwitter” components—displayed in the Default Activity Window, may include configurable properties set before compilation—but not displayed in the Default Activity Window. The configurable properties may, for example, provide account access values from Twitter when one signs up for Twitter APIs. The configurable properties may, for example, be respectively designated as “CONSUMER_KEY” and “CONSUMER_SECRET”.

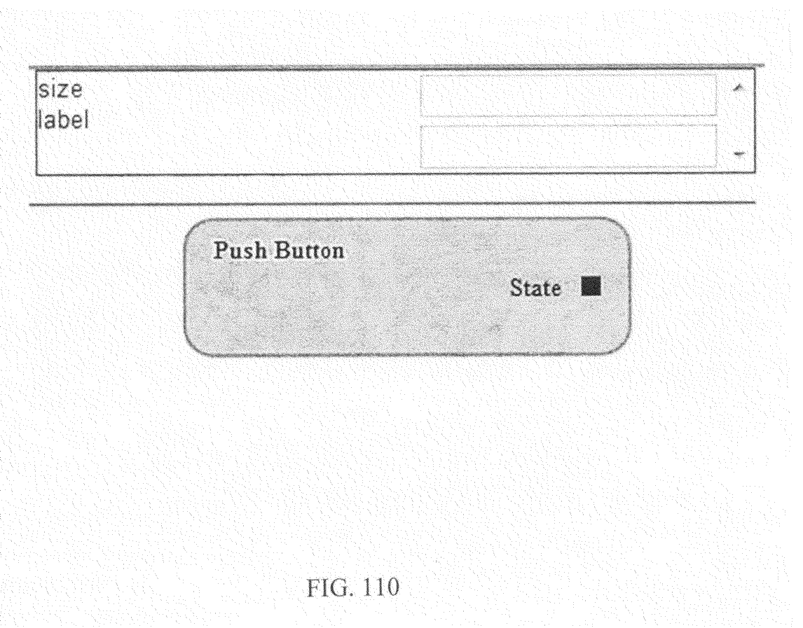

As shown in FIG. 110, “Push Button” components may include, for example, no input ports. “Push Button” components may include, for example, one output port. This output port may include, for example, “State”. Data output from “State” may be, for example, a “java.lang.Integer” data type.

“Push Button” components may, for example, provide a continuous output when pressed and held.

As also shown in FIG. 110, “Push Button” components—displayed in the Default Activity Window, may include configurable properties set before compilation—but not displayed in the Default Activity Window. The configurable properties may, for example, identify a button size on a viewing display of the associated device and a label describing button function. The configurable properties may, for example, be respectively designated as “size” and “label”.

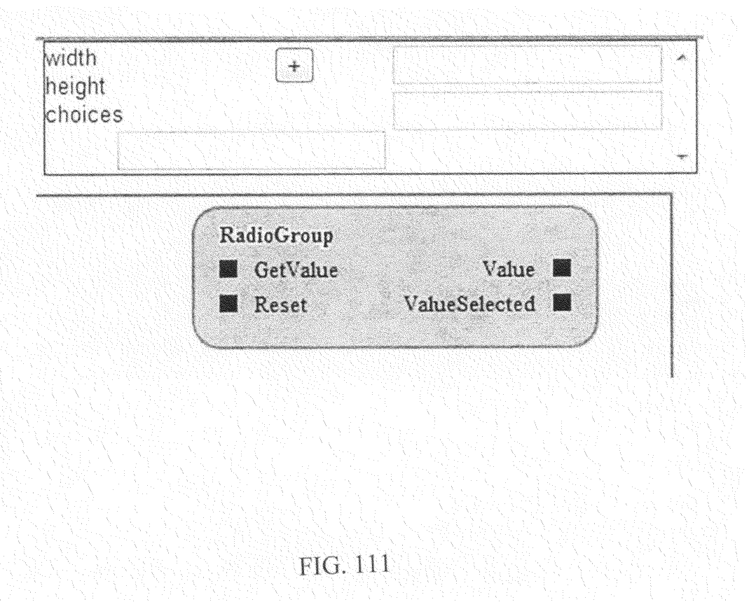

As shown in FIG. 111, “Radio Group” components may include, for example, two input ports. These input ports may include, for example, “Get Value” and “Reset”. Data input to “Get Value” may be, for example, a “java.lang.Object” data type. Data input to “Reset” may be, for example, a “java.lang.Object” data type. “Radio Group” components may include, for example, two output ports. These output ports may include, for example, “Value” and “Value Selected”. Data output from “Value” may be, for example, a “java.lang.String” data type. Data output from “Value Selected” may be, for example, a “java.lang.String” data type.

“Radio Group” components may allow, for example, a list to be shown on a viewing display of an associated device. “Radio Group” components may restrict, for example, a user to make a single selection from the list.

As also shown in FIG. 111, “Radio Group” components—displayed in the Default Activity Window, may include configurable properties set before compilation—but not displayed in the Default Activity Window. The configurable properties may, for example, provide the list and a way of making the single selection from the list. The configurable properties may, for example, be designated as “width”, “height”, and “choices”.

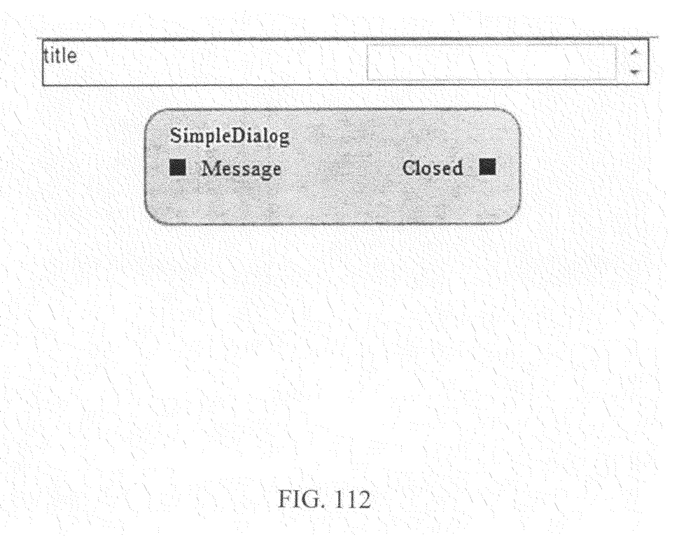

As shown in FIG. 112, “Simple Dialog” components may include, for example, one input port. This input port may include, for example, “Message”. Data input to “Message” may be, for example, a “java.lang.String” data type. “Simple Dialog” components may include, for example, one output port. This output port may include, for example, “Closed”. Data output from “Closed” may be, for example, a “java.lang.Integer” data type.

“Simple Dialog” components may receive, for example, data input to “Message”. “Simple Dialog” components may cause a dialog box to appear on a viewing display of the associated device. The dialog box may include a title and content of data input to “Message”. Data output from “Closed” may indicate, for example, an event of a user closing dialog.

As also shown in FIG. 112, “Simple Dialog” components—displayed in the Default Activity Window, may include configurable properties set before compilation—but not displayed in the Default Activity Window. The configurable properties may, for example, identify titles of dialog boxes on a viewing display of the associated device. The configurable properties may, for example, be designated as “title”.

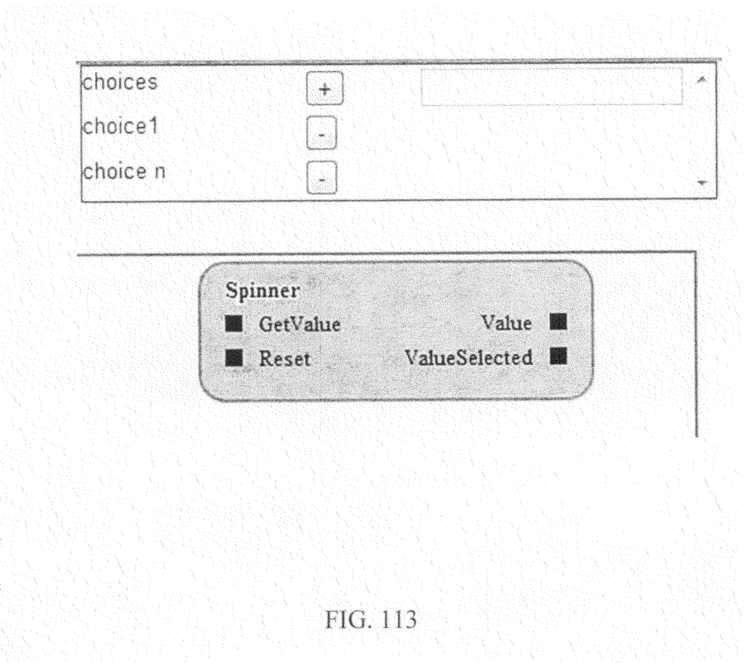

As shown in FIG. 113, “Spinner” components may include, for example, two input ports. These input ports may include, for example, “Get Value” and “Reset”. Data input to “Get Value” may be, for example, a “java.lang.Object” data type. Data input to “Reset” may be, for example, a “java.lang.Object” data type. “Spinner” components may include, for example, two output ports. These output ports may include, for example, “Value” and “Value Selected”. Data output from “Value” may be, for example, a “java.lang.String” data type. Data output from “Value Selected” may be, for example, a “java.lang.String” data type.

“Spinner” components may allow, for example, a drop-down list to be shown on a viewing display of an associated device. “Spinner” components may restrict, for example, a user to make a single selection from the drop-down list.

As also shown in FIG. 113, “Spinner” components—displayed in the Default Activity Window, may include configurable properties set before compilation—but not displayed in the Default Activity Window. The configurable properties may, for example, provide a list of choices and a way of making the single selection from the drop-down list. The configurable properties may, for example, be designated as “choices”, “choice 1”, and “choice n”.

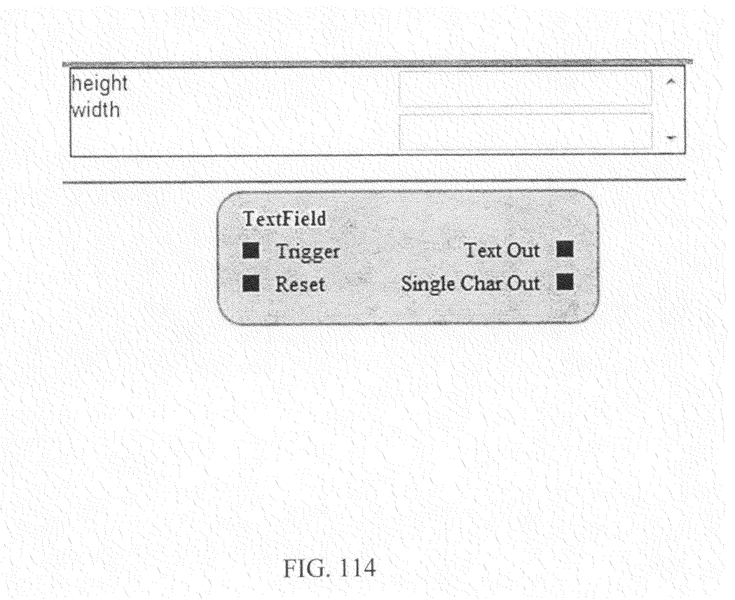

As shown in FIG. 114, “Text Field” components may include, for example, two input ports. These input ports may include, for example, “Trigger” and “Reset”. Data input to “Trigger” may be, for example, a “java.lang.Object” data type. Data input to “Reset” may be, for example, a “java.lang.Object” data type. “Text Field” components may include, for example, two output ports. These output ports may include, for example, “Text Out” and “Single Character Out”. Data output from “Text Out” may be, for example, a “java.lang.String” data type. Data output from “Single Character Out” may be, for example, a “java.lang.String” data type.

“Text Field” components may allow, for example, making of user-editable labels (e.g., for filling out forms on a viewing display of the associated device).

As also shown in FIG. 114, “Text Field” components—displayed in the Default Activity Window, may include configurable properties set before compilation—but not displayed in the Default Activity Window. The configurable properties may, for example, define the height and width of user-editable labels on the viewing display. The configurable properties may, for example, be respectively designated as “height” and “width”. Height may be set, for example, in pixels. Width may be set, for example, in pixels.

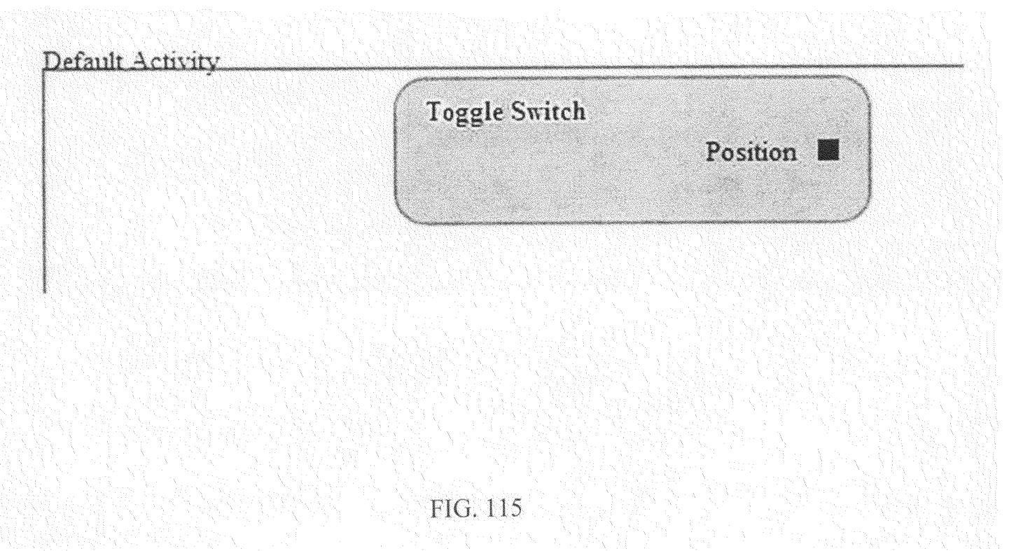

As shown in FIG. 115, “Toggle Switch” components may include, for example, no input ports. “Toggle Switch” components may include, for example, one output port. This output port may include, for example, “Position”. Data output from “Position” may be, for example, a “java.lang.Integer” data type.

“Toggle Switch” components may, for example, may maintain a current state of the switch and, when pressed or when pressed and released, may change the state of the switch and then output the changed state of the switch.

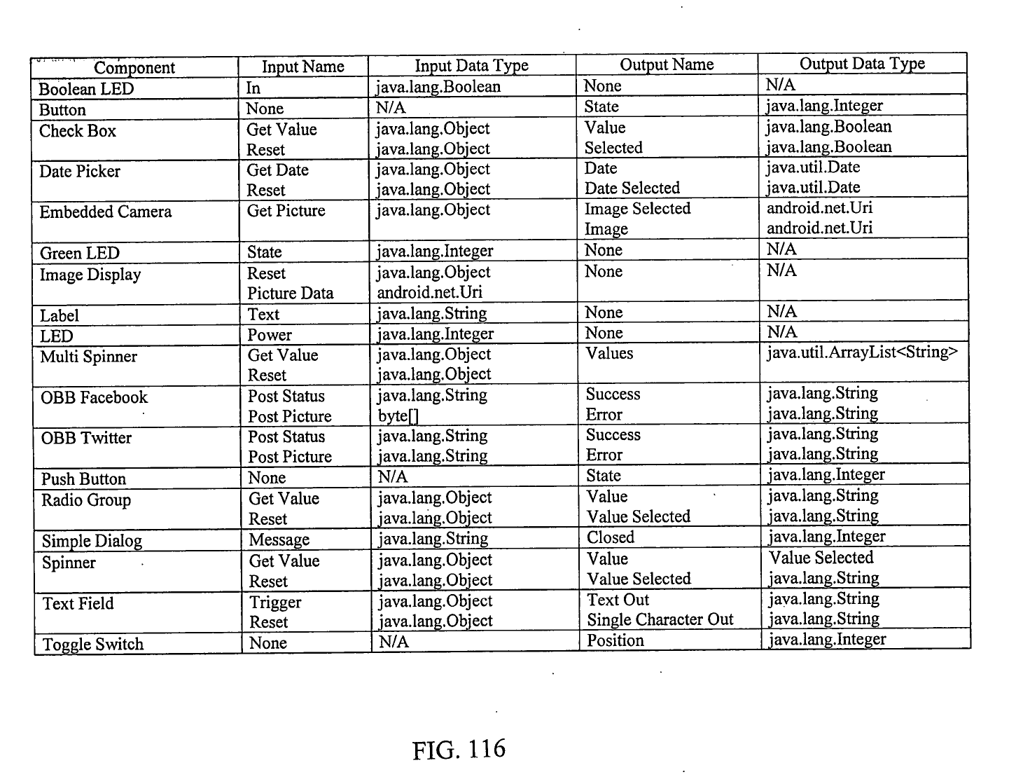

Related information regarding some example embodiments of user interface components may be found in the table of FIG. 116.

### 12. Example Components

### Miscellaneous Components

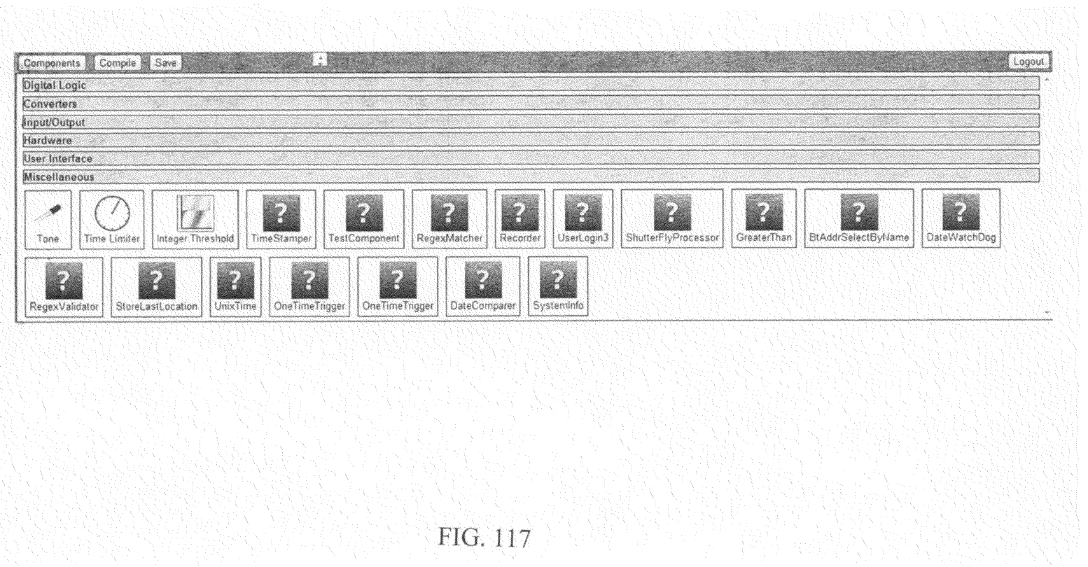

In some example embodiments, miscellaneous components may include, but are not limited to, “BTAddrSelectByName” components, “Date Comparer” components, “Date Watch Dog” components, “Greater Than” components, “Integer Threshold” components, “One Time Trigger, “Recorder” components, “Regex Matcher” components, “Regex Validator” components, “Shutterfly Processor” components, “Store Last Location” components, “System Info” components, “Time Limiter” components, “Time Stamper” components, “Tone” components, “Unix Time” components, and “User Login 3” components. FIG. 117 is a screenshot showing some example embodiments of user interface components.

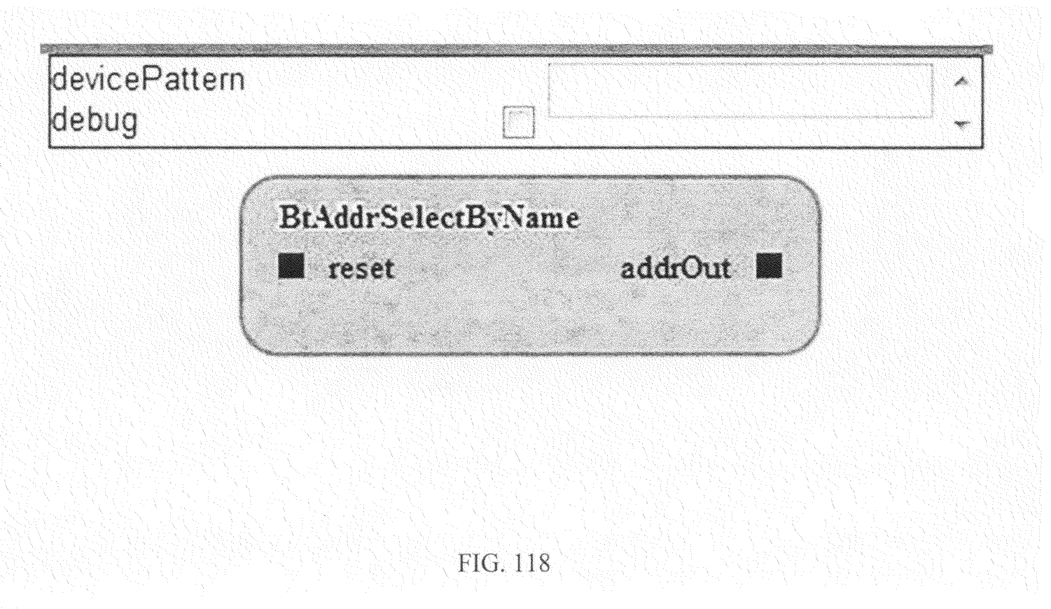

As shown in FIG. 118, “BTAddrSelectByName” components may include, for example, one input port. This input port may include, for example, “Reset”. Data input to “Reset” may be, for example, a “java.lang.Boolean” data type. “BTAddrSelectByName” components may include, for example, one output port. This output port may include, for example, “Address Out”. Data output from “Address Out” may be, for example, a “java.lang.String” data type.

“BTAddrSelectByName” components may provide, for example, a Bluetooth functionality by converting Bluetooth addresses into a different format.

As also shown in FIG. 118, “BTAddrSelectByName” components may include configurable properties set before compilation. For the configurable properties, devicePattern may, for example, define a regular expression pattern (in String format) that the component will use to search for Bluetooth devices with which to connect (e.g., this may be the ‘name’ that “BTAddrSelectByName” components convert into a Bluetooth address).

The debug property may, for example, determine whether “BTAddrSelectByName” components run in debug mode or not. The configurable properties may, for example, be designated as “devicePattern” and “debug”.

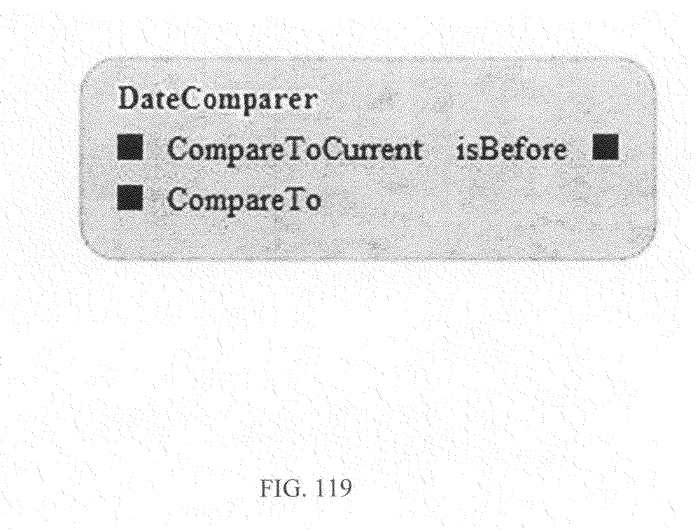

As shown in FIG. 119, “Date Comparer” components may include, for example, two input ports. These input ports may include, for example, “Compare to Current” and “Compare to”. Data input to “Compare to Current” may be, for example, a “java.util.date” data type. Data input to “Compare to” may be, for example, a “java.util.date[ ]” data type. “Date Comparer” components may include, for example, one output port. This output port may include, for example, “Is Before”. Data output from “Is Before” may be, for example, a “java.lang.Boolean” data type.

“Date Comparer” components may provide, for example, a comparison of data input to “Compare to Current” and data input to “Compare to”. For example, “Date Comparer” components may ask: Is the date corresponding to data input to “Compare to Current” before the date corresponding to data input to “Compare to”? If the answer to the question is ‘yes’, then data output from “Is Before” may be, for example, “True”. If the answer to the question is ‘no’, then data output from “Is Before” may be, for example, “False”.

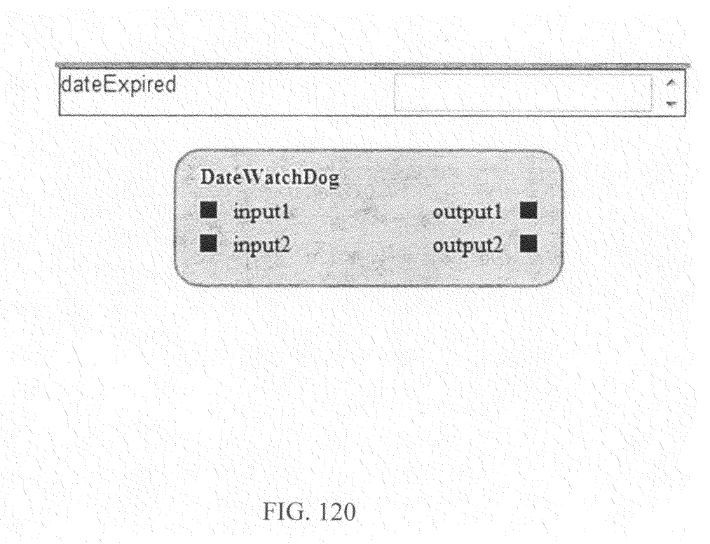

As shown in FIG. 120, “Date Watch Dog” components may include, for example, two input ports. These input ports may include, for example, “Input 1” and “Input 2”. Data input to “Input 1” may be, for example, a “java.lang.Object” data type. Data input to “Input 2” may be, for example, a “java.lang.Object” data type. “Date Watch Dog” components may include, for example, two output ports. These output ports may include, for example, “Output 1” and “Output 2”. Data output from “Output 1” may be, for example, a “java.lang.Object” data type. Data output from “Output 2” may be, for example, a “java.lang.Object” data type.

“Date Watch Dog” components may provide, for example, a gatekeeper function.

As also shown in FIG. 120, “Date Watch Dog” components may include configurable properties set before compilation. The configurable properties may, for example, define expiration dates for the gatekeeper function (e.g., on or after that date, no data is allowed to pass through the “Date Watch Dog” components). The configurable properties may, for example, be designated as “dateExpired”.

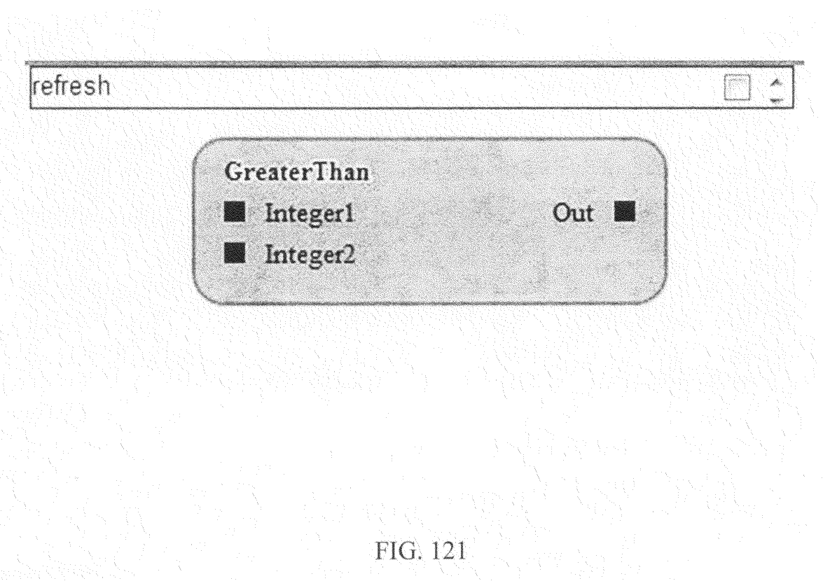

As shown in FIG. 121, “Greater Than” components may include, for example, two input ports. These input ports may include, for example, “Integer 1” and “Integer 2”. Data input to “Integer 1” may be, for example, a “java.lang.Integer” data type. Data input to “Integer 2” may be, for example, a “java.lang.Integer” data type. “Greater Than” components may include, for example, one output port. This output port may include, for example, “Out”. Data output from “Out” may be, for example, a “java.lang.Boolean” data type.

“Greater Than” components may provide, for example, a comparison of data input to “Integer 1” and data input to “Integer 2”. For example, “Greater Than” components may ask: Is data input to “Integer 1” greater than (e.g., >) data input to “Integer 2”? If data input to “Integer 1”>data input to “Integer 2”, then data output from “Out” may be, for example, “True”. If data input to “Integer 1” data input to “Integer 2”, then data output from “Out” may be, for example, “False”.

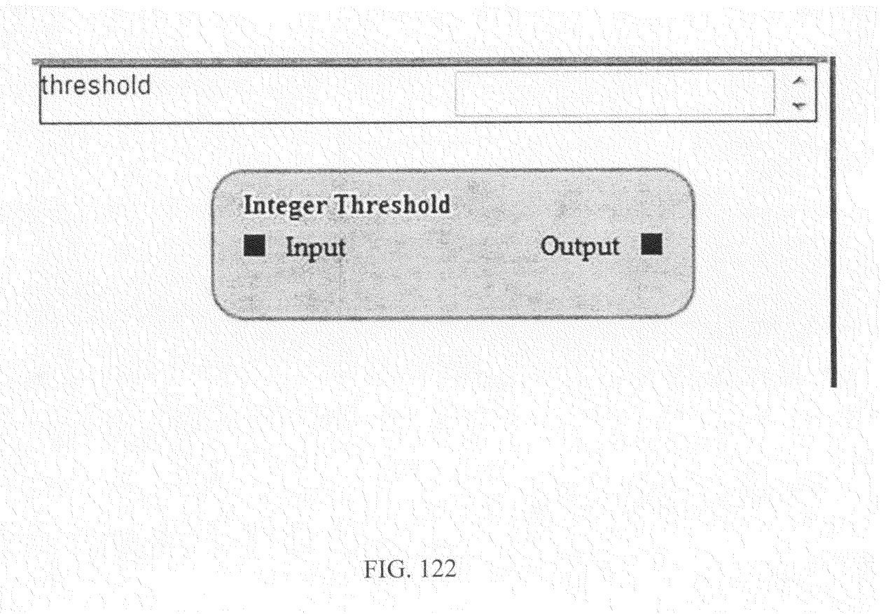

As shown in FIG. 122, “Integer Threshold” components may include, for example, one input port. This input port may include, for example, “Input”. Data input to “Input” may be, for example, a “java.lang.Integer” data type. “Integer Threshold” components may include, for example, one output port. This output port may include, for example, “Output”. Data output from “Output” may be, for example, a “java.lang.Integer” data type.

“Integer Threshold” components may provide, for example, a squelch function.

As also shown in FIG. 122, “Integer Threshold” components may include configurable properties set before compilation. The configurable properties may, for example, define a threshold such that if data input to “Input”>threshold, then data should be output from “Output”. The configurable properties may, for example, be designated as “threshold”.

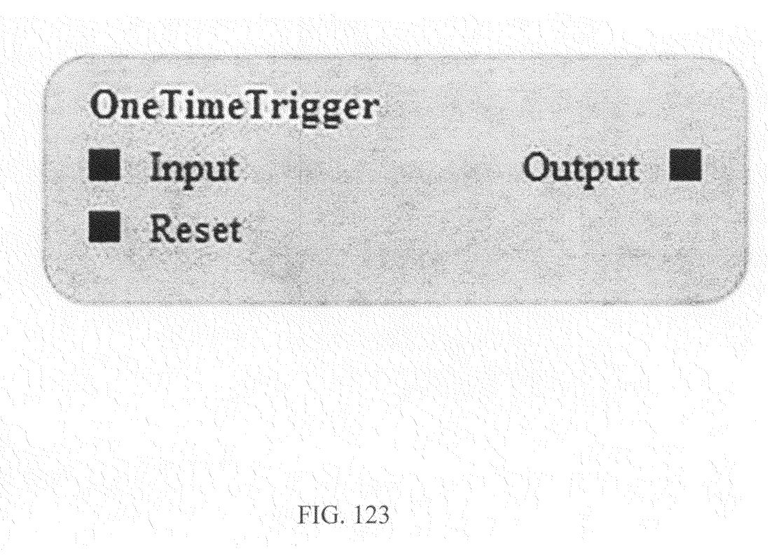

As shown in FIG. 123, “One Time Trigger” components may include, for example, two input ports. These input ports may include, for example, “Input” and “Reset”. Data input to “Input” may be, for example, a “java.lang.Object” data type. Data input to “Reset” may be, for example, a “java.lang.Object” data type. “One Time Trigger” components may include, for example, one output port. This output port may include, for example, “Output”. Data output from “Output” may be, for example, a “java.lang.Object” data type.

“One Time Trigger” components may provide, for example, a single-input-only-until-reset function. For example, a first data input to “Input” should become data output from “Output”. However, once first data input to “Input” has become data output from “Output”, then no more data input to “Input” should be allowed until data input to “Reset” resets the “One Time Trigger” components.

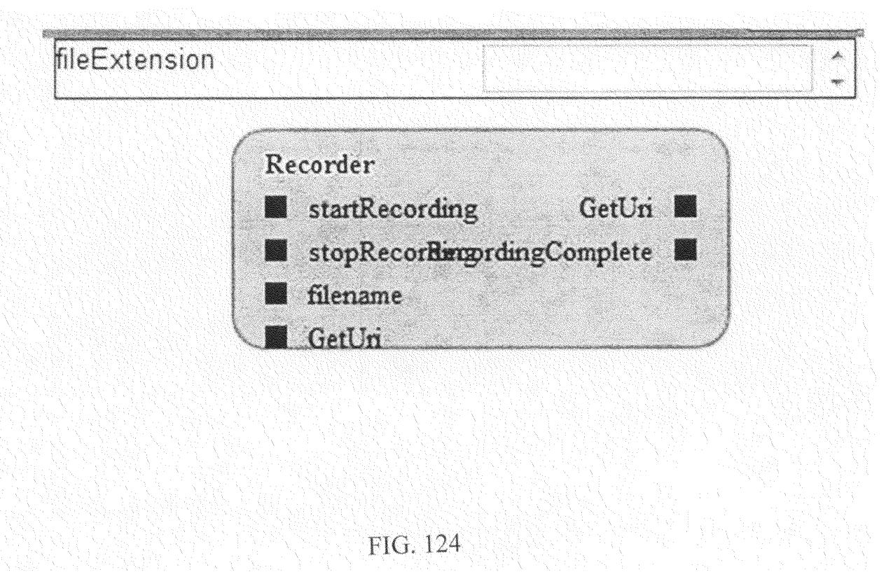

As shown in FIG. 124, “Recorder” components may include, for example, four input ports. These input ports may include, for example, “Start Recording”, “Stop Recording”, “Filename”, and “Get URI”. Data input to “Start Recording” may be, for example, a “java.lang.Integer” data type. Data input to “Stop Recording” may be, for example, a “java.lang.Integer” data type. Data input to “Filename” may be, for example, a “java.lang.String” data type. Data input to “Get URI” may be, for example, a “java.lang.Object” data type. “Recorder” components may include, for example, two output ports. These output ports may include, for example, “Get URI” and “Recording Complete”. Data output from “Get URI” may be, for example, an “android.net.Uri” data type. Data output from “Recording Complete” may be, for example, an “android.net.Uri” data type.

“Recorder” components may provide, for example, functionality for controlling audio recording through a microphone of the associated device. For example, “Get URI” may refer to the URI of the audio file saved by “Recorder” components.

As also shown in FIG. 124, “Recorder” components may include configurable properties set before compilation. The configurable properties may, for example, define a File Extension that determines the format in which the recording is saved. The configurable properties may, for example, be designated as “fileExtension”.

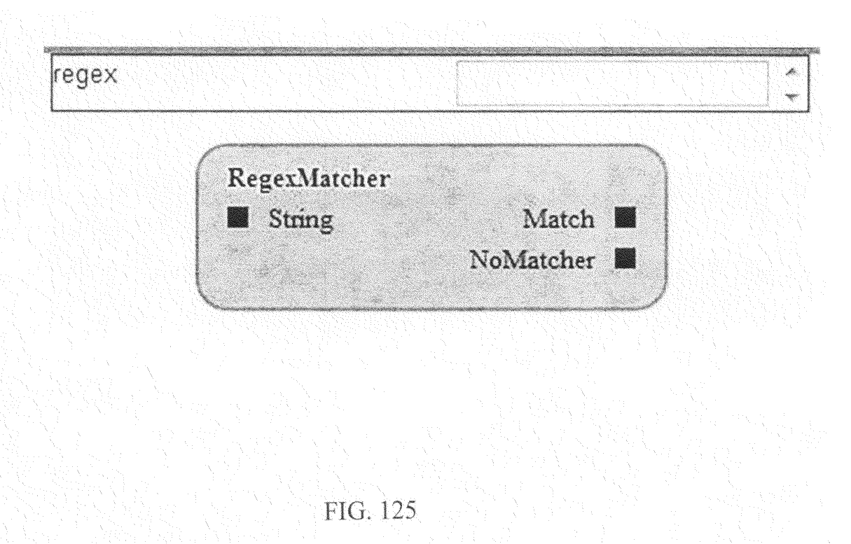

As shown in FIG. 125, “Regex Matcher” components may include, for example, one input port. This input port may include, for example, “String”. Data input to “String” may be, for example, a “java.lang.String” data type. “Regex Matcher” components may include, for example, two output ports. These output ports may include, for example, “Match” and “No Match”. Data output from “Match” may be, for example, a “java.lang.Boolean” data type. Data output from “No Match” may be, for example, a “java.lang.Boolean” data type.

“Regex Matcher” components may provide, for example, a simple String comparison function.

As also shown in FIG. 125, “Regex Matcher” components may include configurable properties set before compilation. The configurable properties may, for example, define a first String against which data input to “String” may be compared. If data input to “String” is the same as the first String, then data output from “Match” should be “True”. If data input to “String” is not the same as the first String, then data output from “No Match” should be “False”. The configurable properties may, for example, be designated as “regex”.

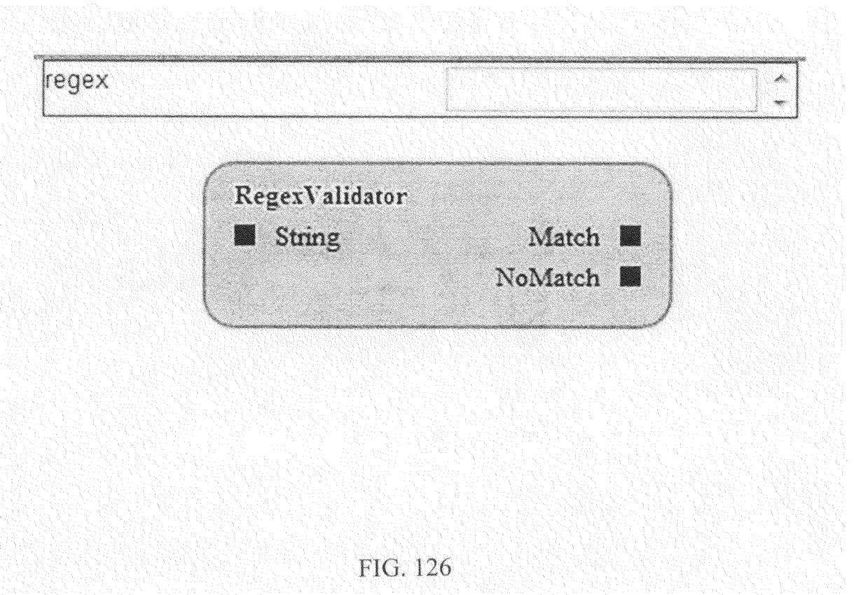

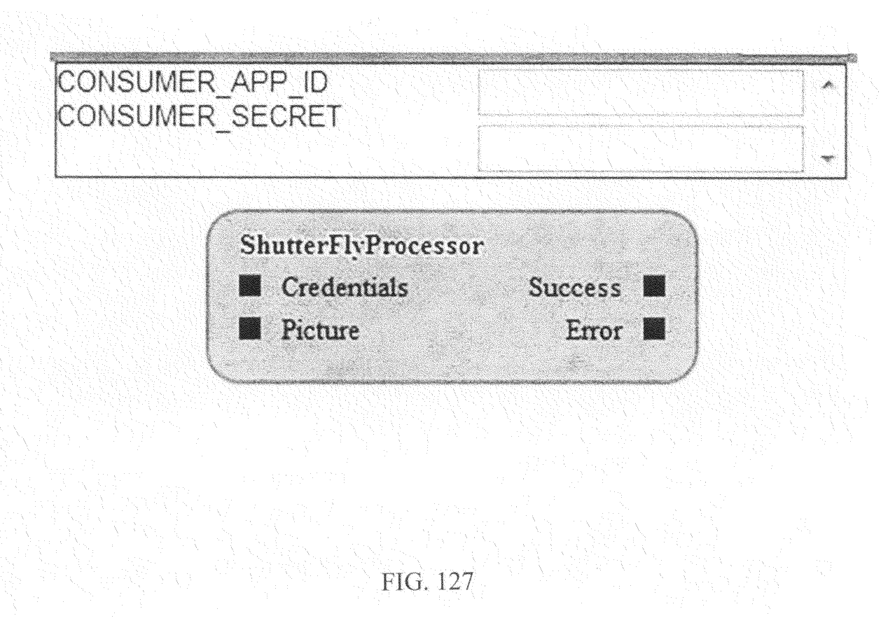

As shown in FIG. 126, “Regex Validator” components may include, for example, one input port. This input port may include, for example, “String”. Data input to “String” may be, for example, a “java.lang.String” data type. “Regex Validator” components may include, for example, two output ports. These output ports may include, for example, “Match” and “No Match”. Data output from “Match” may be, for example, a “java.lang.String” data type. Data output from “No Match” may be, for example, a “java.lang.String” data type.

“Regex Validator” components may provide, for example, a more complicated String comparison function.

As also shown in FIG. 126, “Regex Validator” components may include configurable properties set before compilation. The configurable properties may, for example, define a second String against which data input to “String” may be compared. If data input to “String” is the same as the second String, then data output from “Match” should be a String representing what did match. If data input to “String” is not the same as the second String, then data output from “No Match” should be a String representing what did not match. The configurable properties may, for example, be designated as “regex”.

As shown in FIG. 127, “Shutterfly Processor” components may include, for example, two input ports. These input ports may include, for example, “Credentials” and “Picture”. Data input to “Credentials” may be, for example, a “java.util.HashMap<String,String>” data type. Data input to “Picture” may be, for example, a “byte[ ]” data type. “Shutterfly Processor” components may include, for example, two output ports. These output ports may include, for example, “Success” and “Error”. Data output from “Success” may be, for example, a “java.lang.String” data type. Data output from “Error” may be, for example, a “java.lang.String” data type.

“Shutterfly Processor” components may provide, for example, functionality for logging into the Shutterfly Internet-based, social expression and personal publishing service. For example, data input to “Credentials” may be data output from “Send User Login” of “User Login 3” components. Data input to “Picture” may be from “Embedded Camera” components or a camera application of the associated device.

As also shown in FIG. 127, “Shutterfly Processor” components may include configurable properties set before compilation. The configurable properties may, for example, provide account access values from Shutterfly when one signs up for Shutterfly APIs. The configurable properties may, for example, be respectively designated as “CONSUMER_APP_ID” and “CONSUMER_SECRET”.

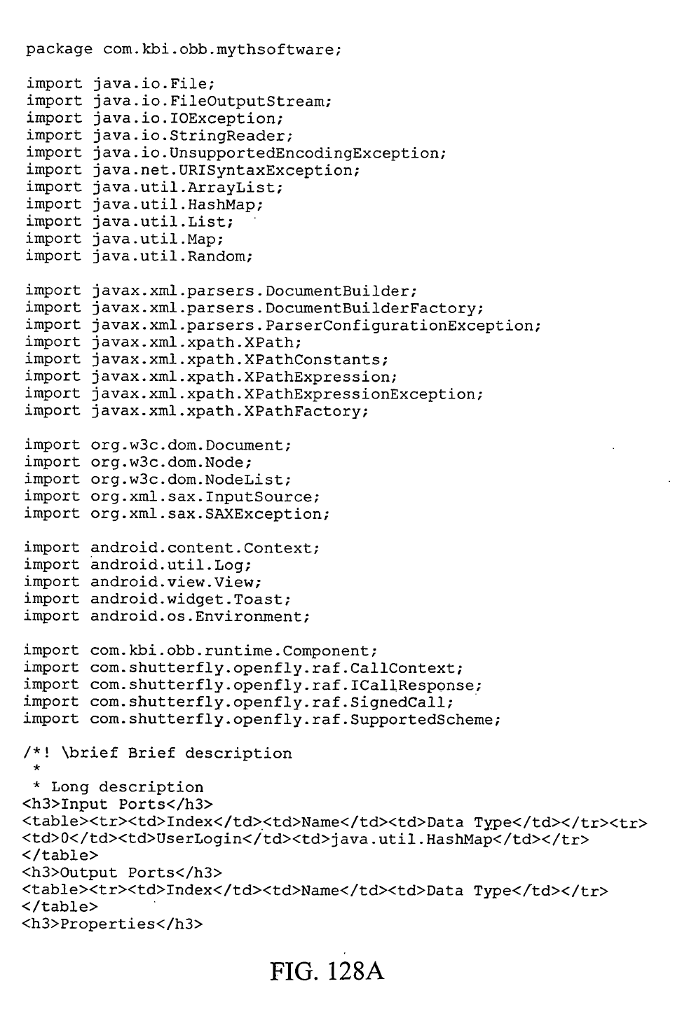

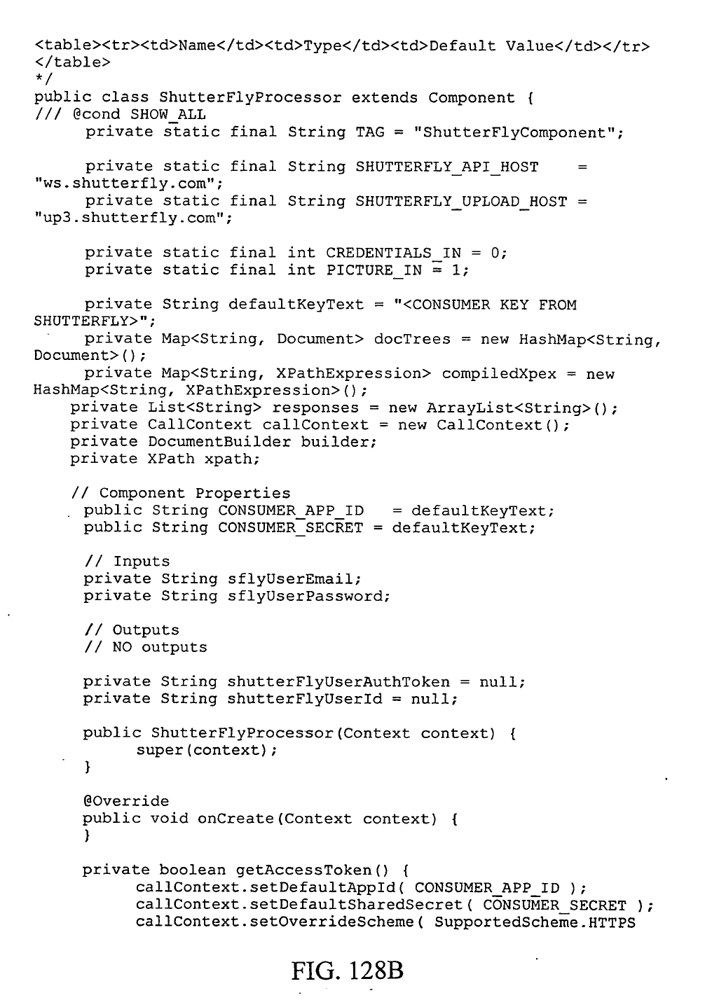

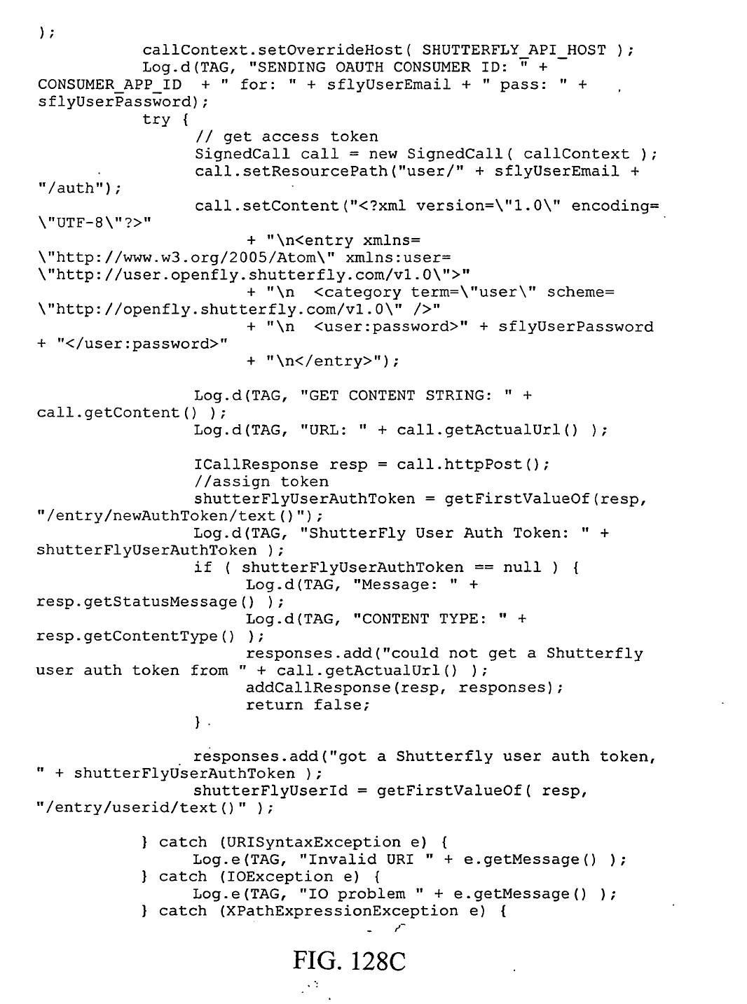

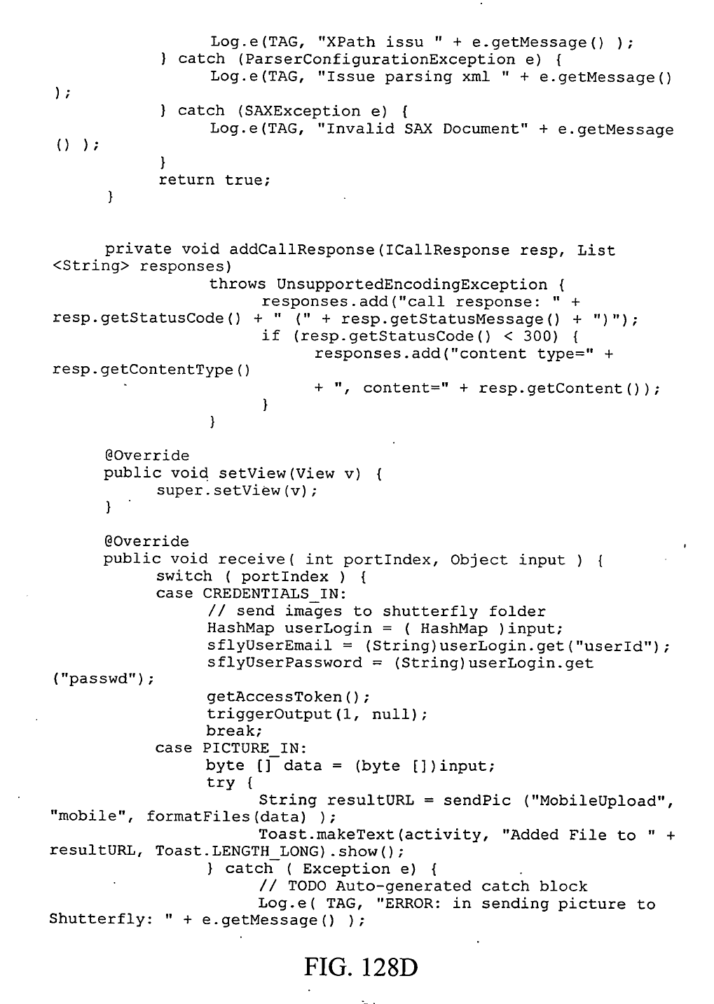

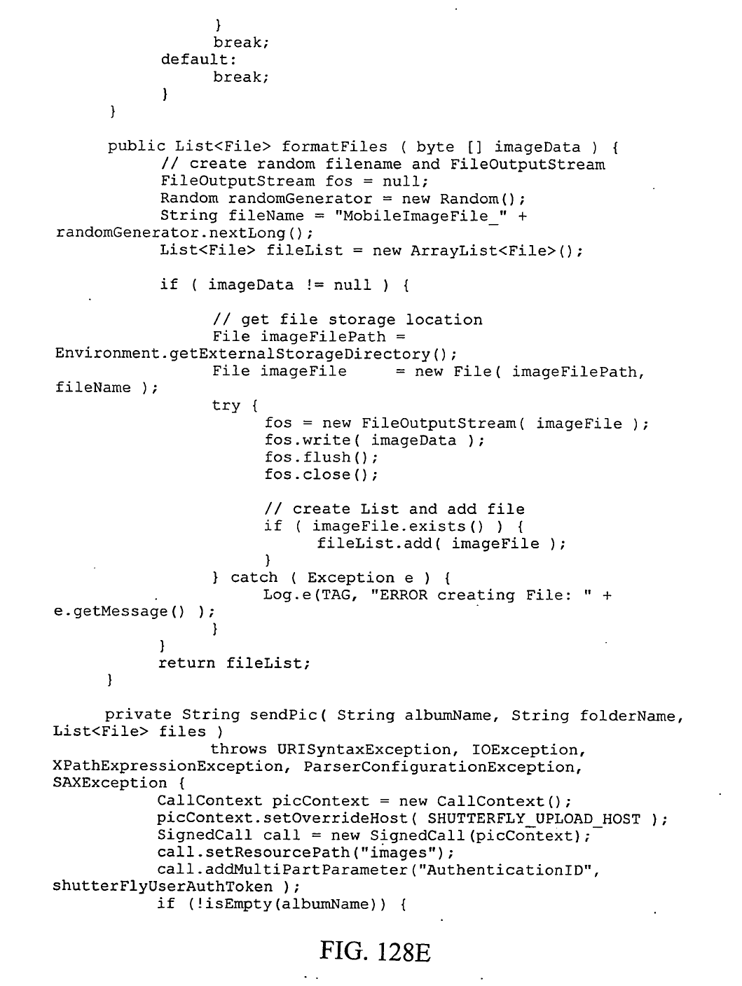

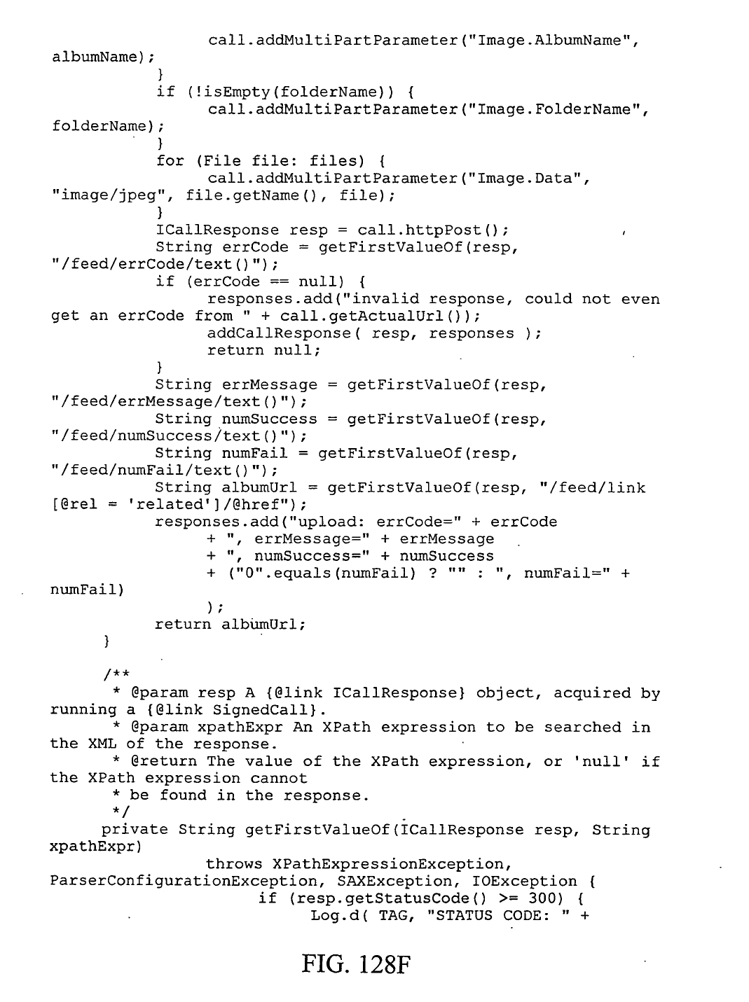

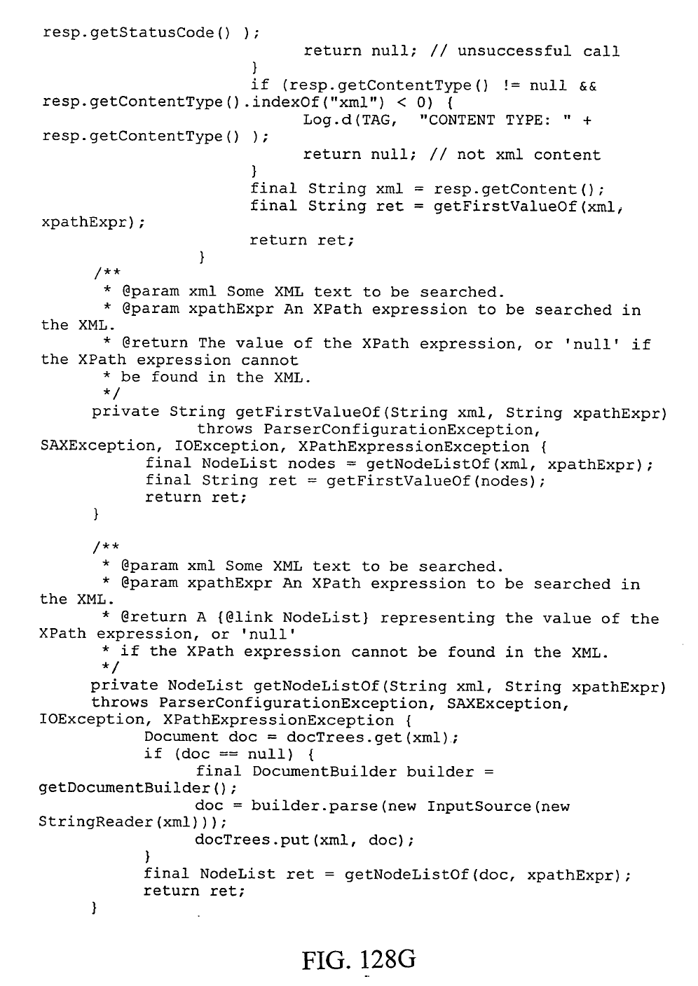

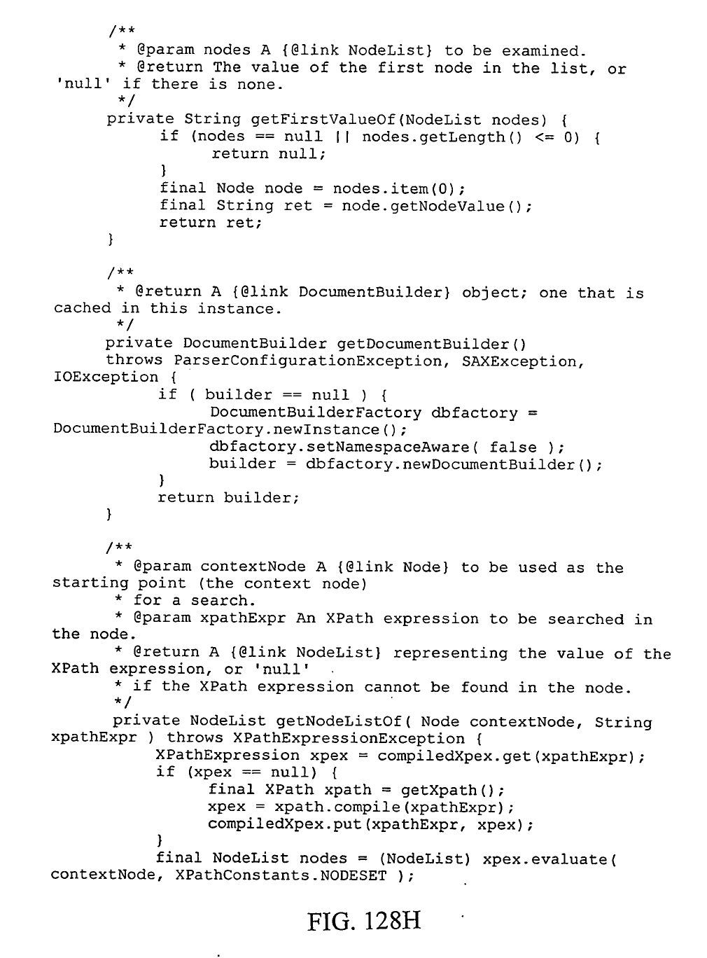

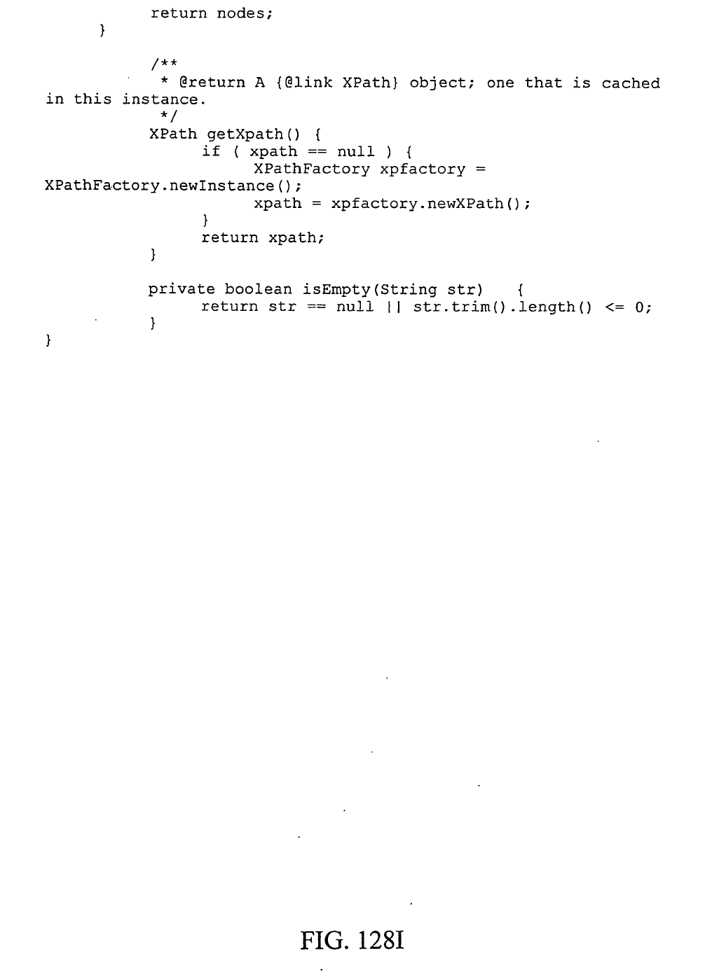

FIGS. 128A-M128I provide an example of source code, written in the Java programming language, for “Shutterfly Processor” components.

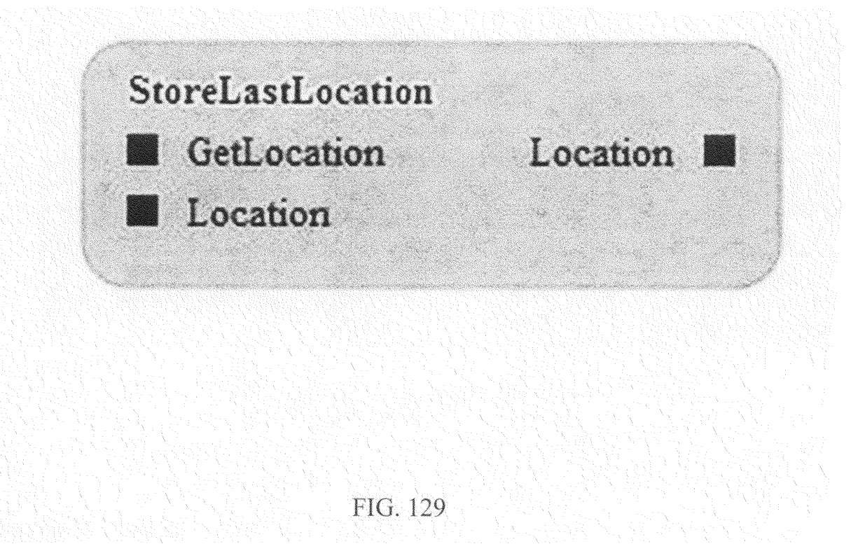

As shown in FIG. 129, “Store Last Location” components may include, for example, two input ports. These input ports may include, for example, “Get Location” and “Location”. Data input to “Get Location” may be, for example, a “java.lang.Object” data type. Data input to “Location” may be, for example, a “android.location.Location” data type. “Store Last Location” components may include, for example, one output port. This output port may include, for example, “Location”. Data output from “Location” may be, for example, a “android.location.Location” data type.

“Store Last Location” components may provide, for example, a functionality to store a last location (e.g., a last GPS location).

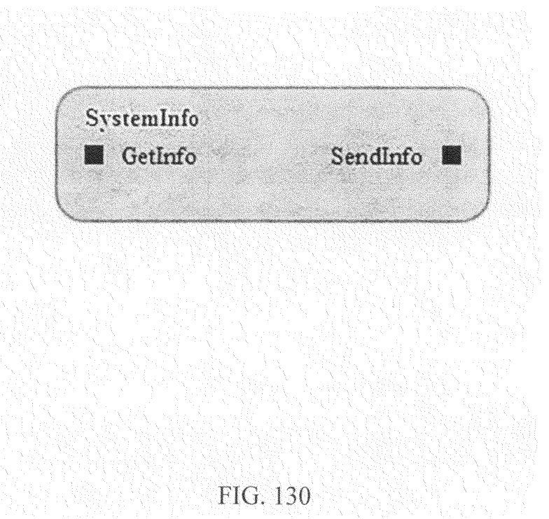

As shown in FIG. 130, “System Info” components may include, for example, one input port. This input port may include, for example, “Get Info”. Data input to “Get Info” may be, for example, a “java.lang.Object” data type. “System Info” components may include, for example, one output port. This output port may include, for example, “Send Info”. Data output from “Send Info” may be, for example, a “org.json.JSONArray” data type.

“System Info” components may provide, for example, a monitoring function. For example, the information being monitored may be the serial number and battery life of an associated device.

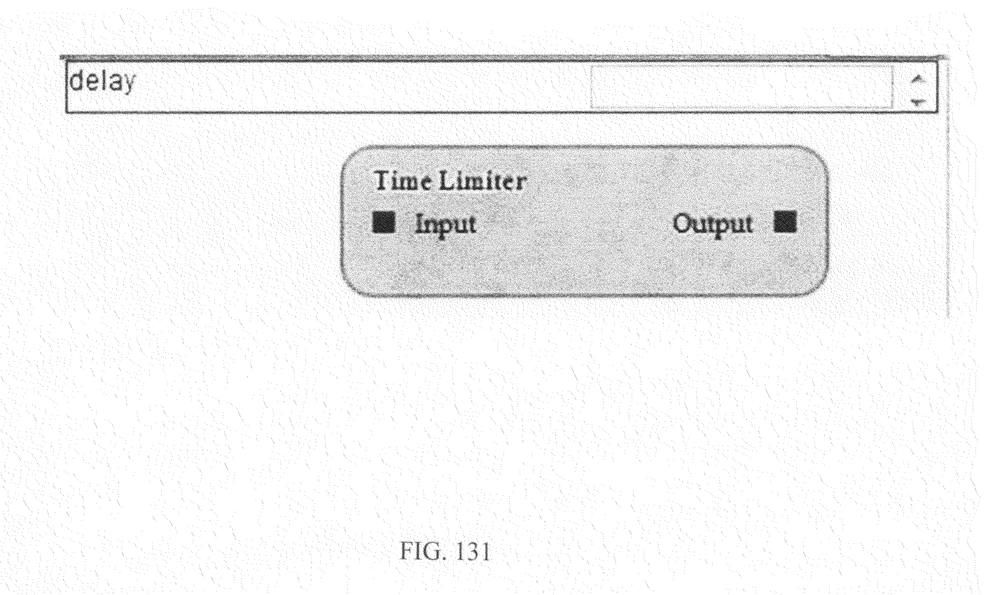

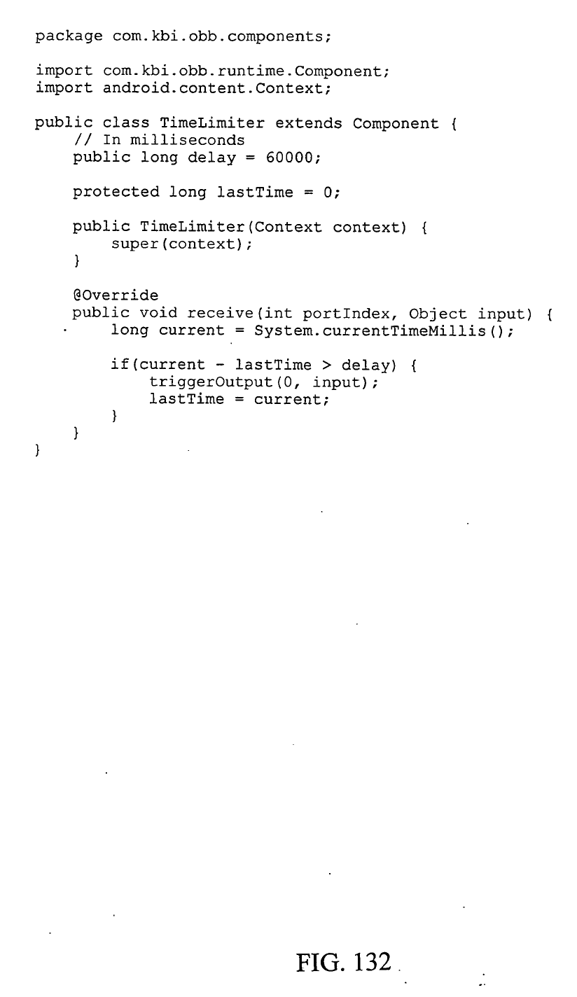

As shown in FIG. 131, “Time Limiter” components may include, for example, one input port. This input port may include, for example, “Input”. Data input to “Input” may be, for example, a “java.lang.Object” data type. “Time Limiter” components may include, for example, one output port. This output port may include, for example, “Output”. Data output from “Output” may be, for example, a “java.lang.Object” data type.

“Time Limiter” components may provide, for example, a time-delay function to reduce throughput of data.

As also shown in FIG. 131, “Time Limiter” components may include configurable properties set before compilation. The configurable properties may, for example, define a time delay such that throughput of data does not occur more often that the defined time delay. The configurable properties may, for example, be respectively designated as “delay”.

FIG. 132 provides an example of source code, written in the Java programming language, for “Time Limiter” components.

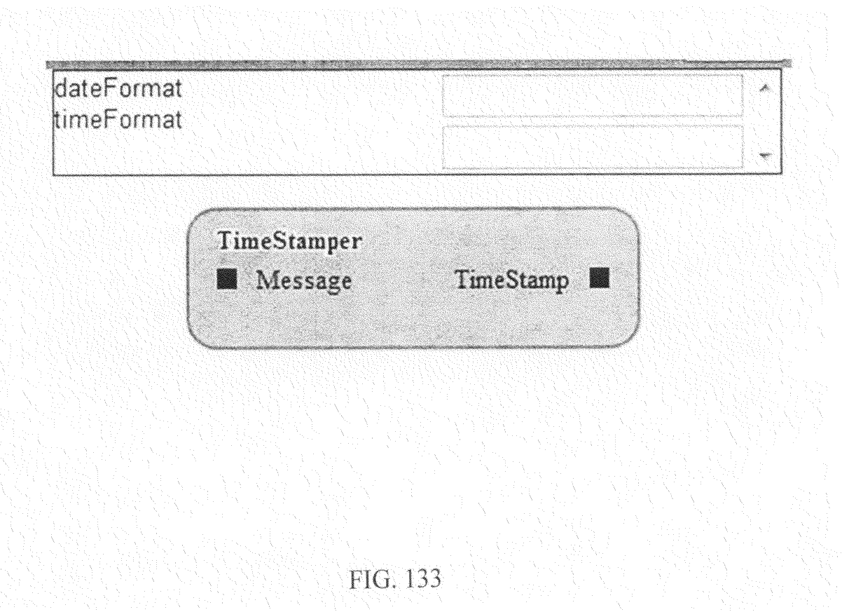

As shown in FIG. 133, “Time Stamper” components may include, for example, one input port. This input port may include, for example, “Message”. Data input to “Message” may be, for example, a “java.lang.String” data type. “Time Stamper” components may include, for example, one output port. This output port may include, for example, “Time Stamp”. Data output from “Time Stamp” may be, for example, a “java.lang.String” data type.

“Time Stamper” components may provide, for example, functionality to time stamp any String.

As also shown in FIG. 133, “Time Stamper” components may include configurable properties set before compilation. The configurable properties may, for example, define the date and time formats of the time stamp. The configurable properties may, for example, be respectively designated as “dateFormat” and “timeFormat”.

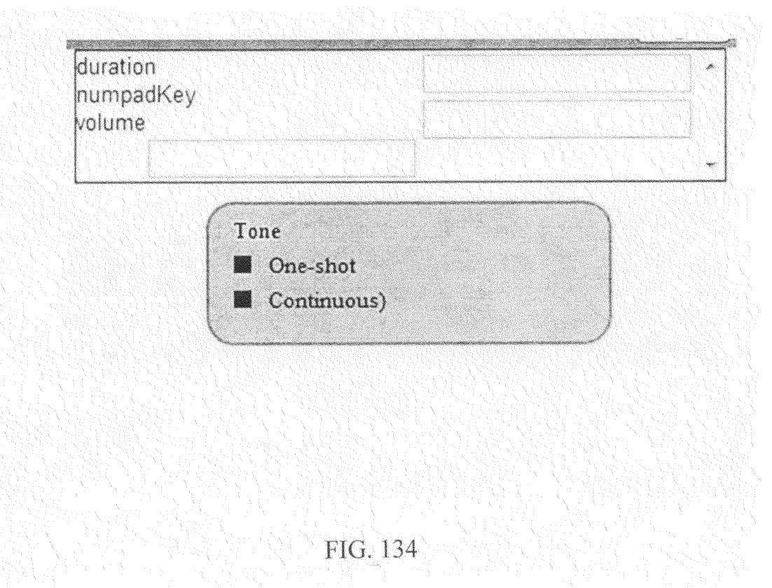

As shown in FIG. 134, “Tone” components may include, for example, two input ports. These input ports may include, for example, “One-Shot” and “Continuous”. Data input to “One-Shot” may be, for example, a “java.lang.Integer” data type. Data input to “Continuous” may be, for example, a “java.lang.Integer” data type. “Tone” components may include, for example, no output ports.

“Tone” components may provide, for example, a dual-tone multi-frequency (“DTMF”) tone.

As also shown in FIG. 134, “Tone” components may include configurable properties set before compilation. The configurable properties may, for example, define the length, frequency, and volume of the one-shot or continuous tone. The configurable properties may, for example, be respectively designated as “duration”, “numpadKey”, and “volume”.

Additionally, as shown in FIG. 134, “Tone” components may include, for example, two input ports. These input ports may include, for example, “One-Shot” and “Continuous”. Data input to “One-Shot” may be, for example, a “java.lang.Integer” data type. Data input to “Continuous” may be, for example, a “java.lang.Integer” data type. “Tone” components may include, for example, no output ports.

“Tone” components may provide, for example, a dual-tone multi-frequency (“DTMF”) tone.

Moreover, as shown in FIG. 134, “Tone” components may include configurable properties set before compilation. The configurable properties may, for example, define the length, frequency, and volume of the one-shot or continuous tone. The configurable properties may, for example, be respectively designated as “duration”, “numpadKey”, and “volume”.

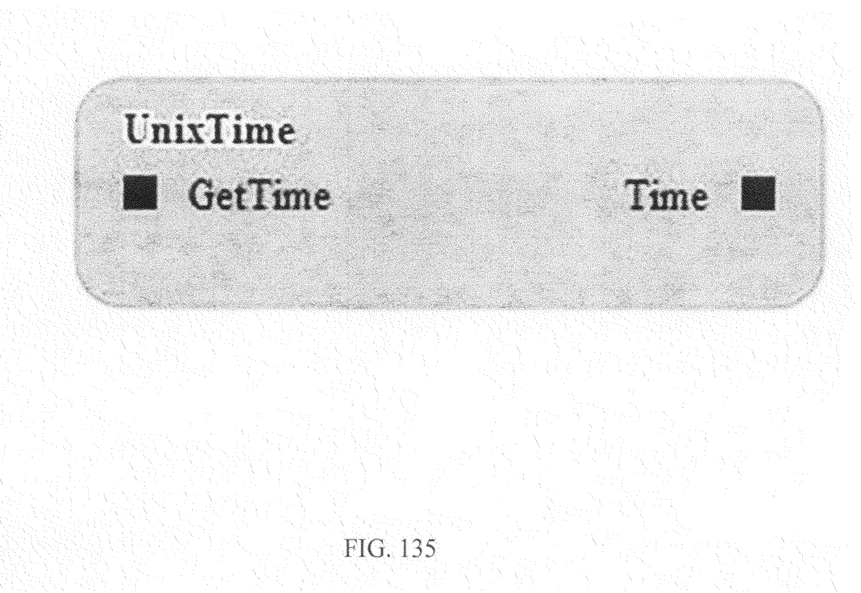

As shown in FIG. 135, “Unix Time” components may include, for example, one input port. This input port may include, for example, “Get Time”. Data input to “Get Time” may be, for example, a “java.lang.Object” data type. “Unix Time” components may include, for example, one output port. This output port may include, for example, “Time”. Data output from “Time” may be, for example, a “java.lang.String” data type.

Data input to “Get Time” may provide, for example, a trigger to cause “Time” to output integer current Unix time.

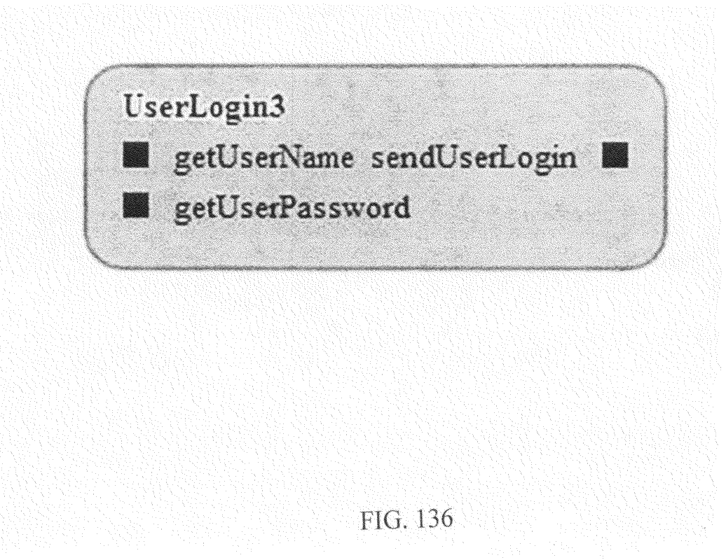

As shown in FIG. 136, “User Login 3” components may include, for example, two input ports. These input ports may include, for example, “Get User Name” and “Get User Password”. Data input to “Get User Name” may be, for example, a “java.lang.String” data type. Data input to “Get User Password” may be, for example, a “java.lang.String” data type. “User Login 3” components may include, for example, one output port. This output port may include, for example, “Send User Login”. Data output from “Send User Login” may be, for example, a “java.util.HashMap<String,String>” data type.

“User Login 3” components may provide, for example, functionality for logging into the Shutterfly Internet-based, social expression and personal publishing service.

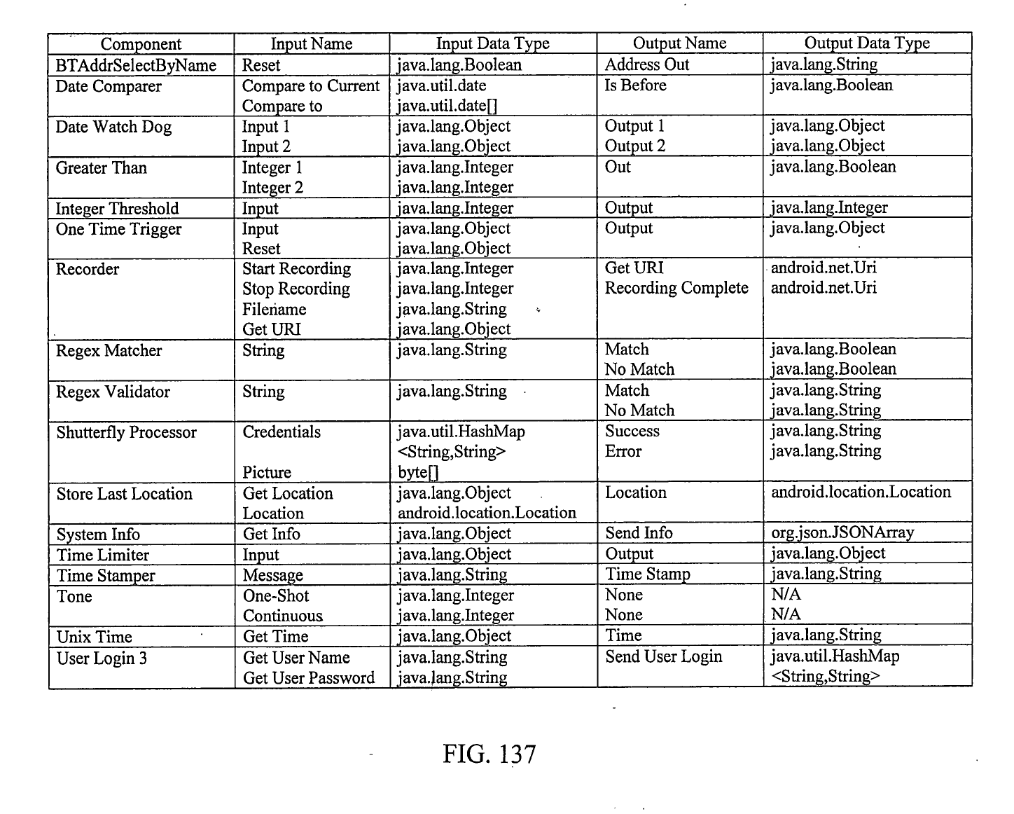

Related information regarding some example embodiments of miscellaneous components may be found in the table of FIG. 137.

### 13. Example Applications

### Generally

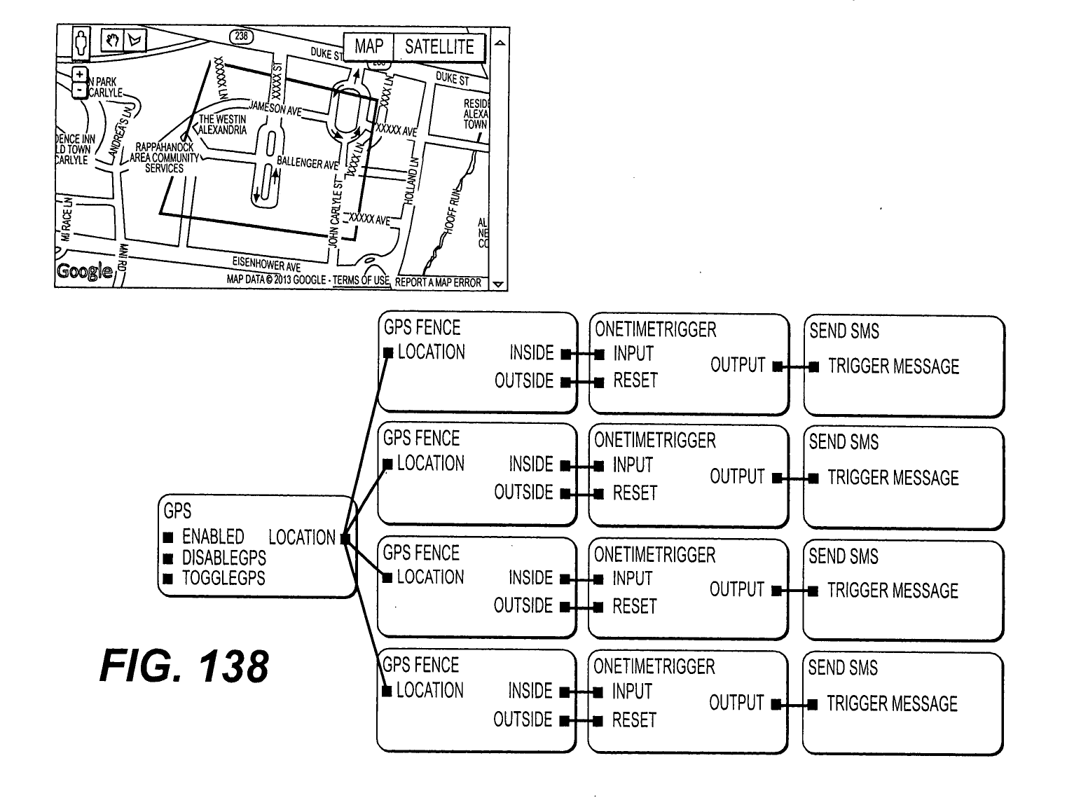

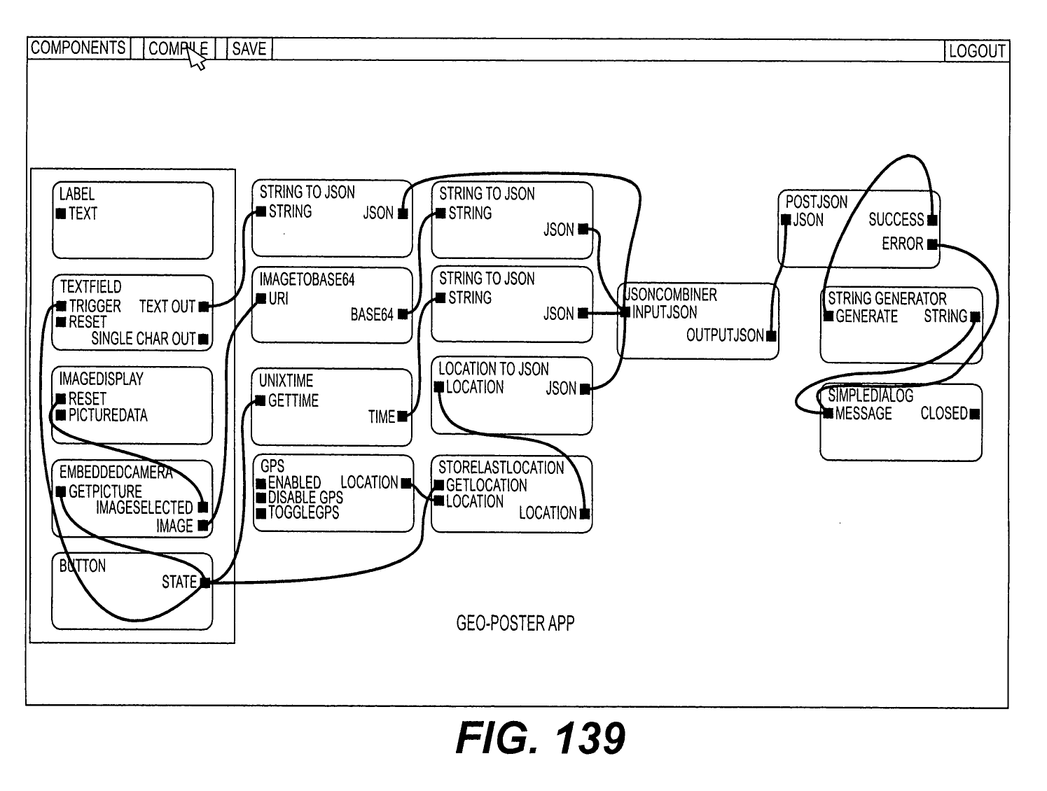

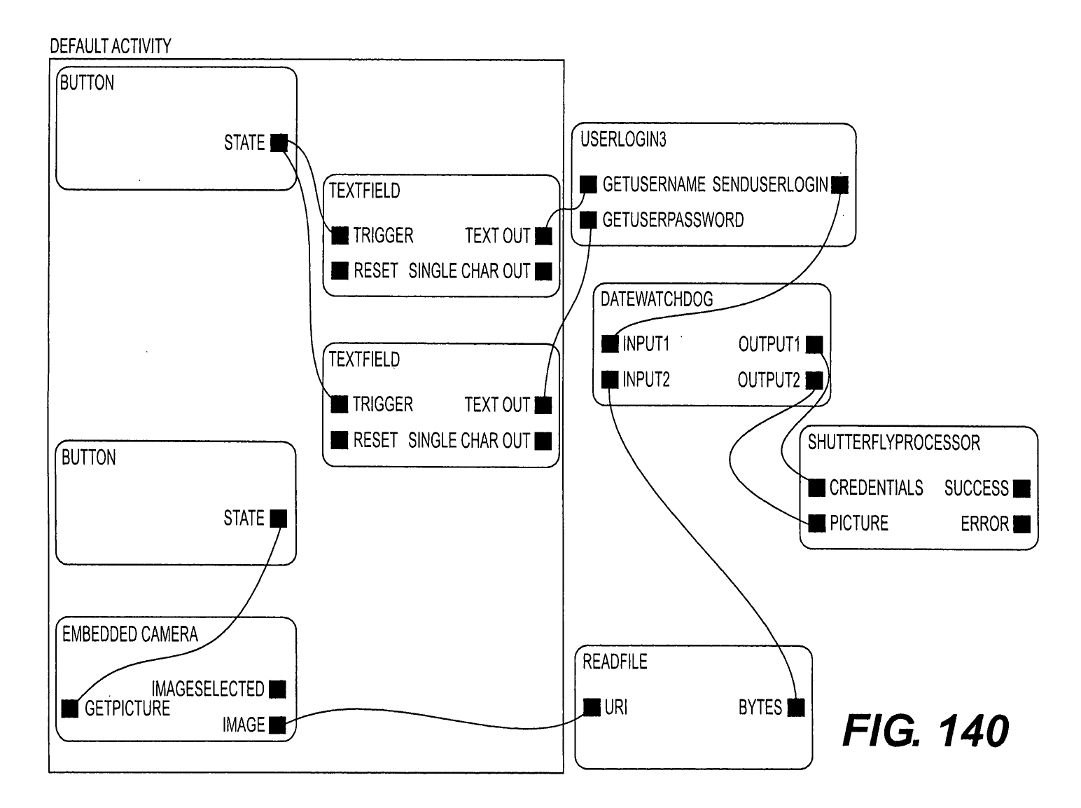

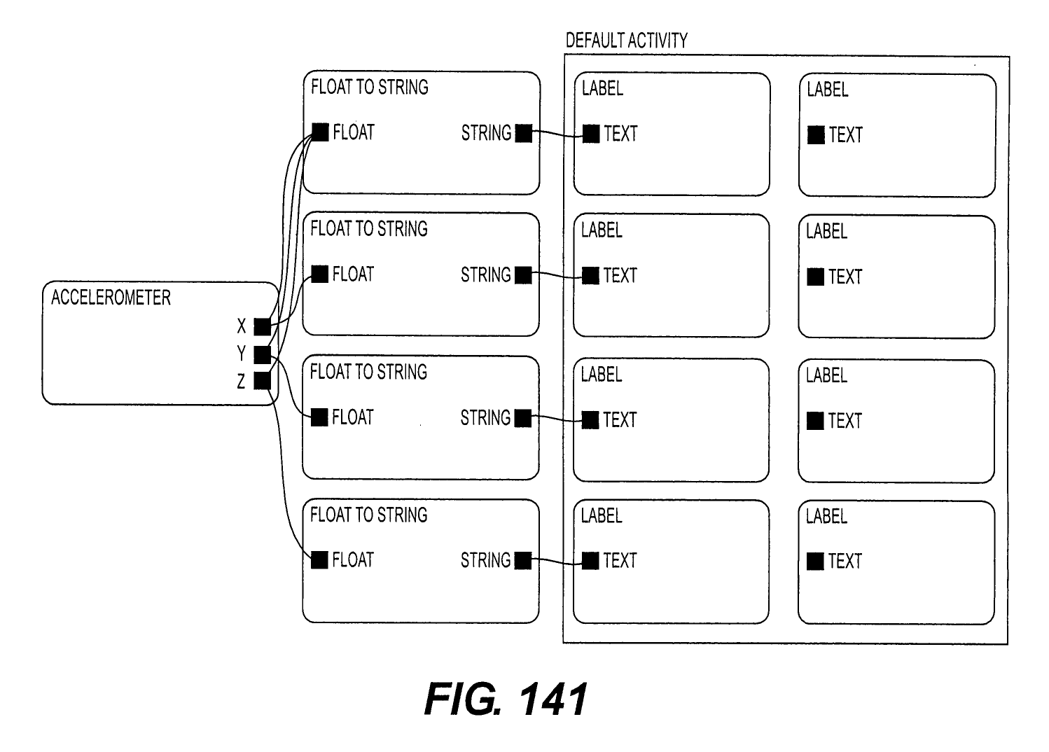

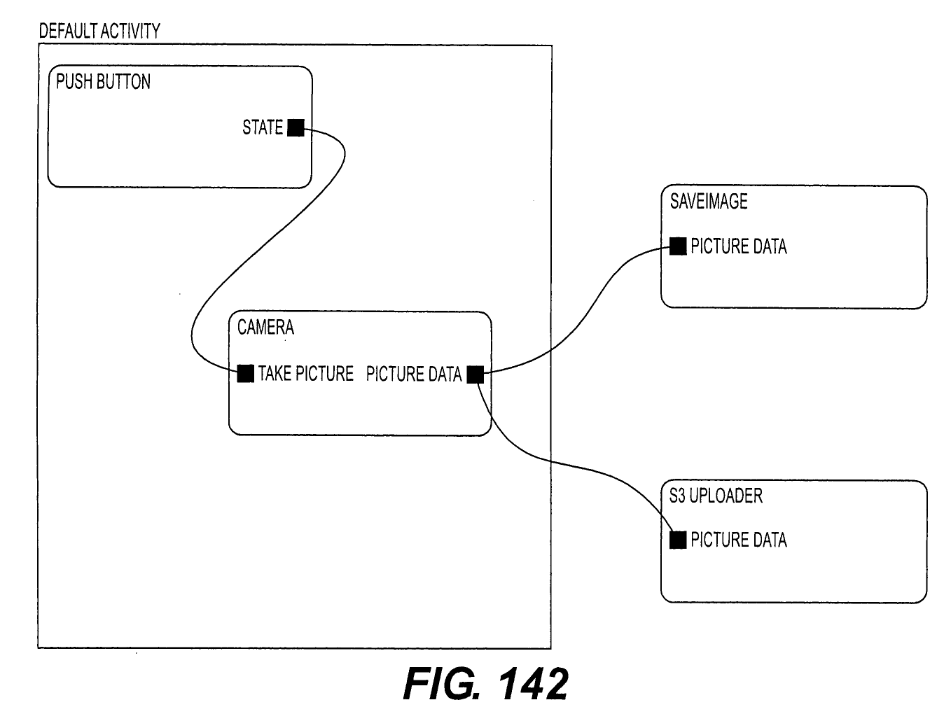

FIGS. 135-140 illustrates examples of the types of applications that may be built using the system. The applications described below may serve as examples of the range in types of applications and complexity which may be created with the system.

### 14. Example Applications

### Four Geo-Fence Application

The application listens to the device's GPS location. If the device is ever within one of the four defined geo fences, the message associated with that geo fence may be sent once. If the device leaves and re-enters a geo fence the message may be sent again.

### 15. Example Applications

### GeoPoster Application

The screen displays a label and text field to enter a description, an image preview for a picture, a button to open the camera application and a submit button to upload to the server. The application listens to the device's GPS location. When the user identifies something they would like to upload they enter a description in the text field, take a picture using the camera application and press submit. The text, image, the devices last known GPS location, and the current time get turned into a JSON object with keys matching the keys expected by the server. The application may then upload the data to a server and may show a dialog whether upload was successful or not.

### 16. Example Applications

### Shutterfly Post Application

The screen layout includes two text fields, one for username and the other for password, a button at the top to login and a button at the bottom to open a camera application. To use the application, the user first enters the username and password text fields, and presses the button above the user login text fields. This logs them into the Shutterfly server and gives them the credentials needed to upload images. They may then take a picture using the camera application and press the button below the user login text fields. When this button is pressed the last picture taken with the camera application may be uploaded to a server such as the Shutterfly server.

### 17. Example Applications

### Accelerometer Display Application

The screen layout has four pairs of labels. In each pair, the label on the right may be set at compile time. From top to bottom labels are classified as: ‘Latest’, ‘X’, ‘Y’, and ‘Z’. The application listens to the devices' accelerometer. For each value that the accelerometer outputs, the application translates the value into a String and then puts String into the appropriate label for display.

### 18. Example Applications

### Post-a-Picture Application

The screen has a button and a camera built in. When the button is pushed the camera takes a picture. This picture is then saved to the local storage and may be uploaded to a service such as the Amazon S3 service.

### 19. Example Applications

### Medical Triage Application

FIG. X illustrates an example of an application which requires adherence to set fields and data inclusion, such as a medical triage application, employing the standard “9-liner” which medical field personnel in military settings require. The data required (which actually totals more than nine lines) includes Name, Sex, Nationality, Date of Birth, patient's pregnancy status, drugs being taken, allergies, chief complaint, and means required for extraction.

In addition, optional pulse-oximeter data may be added from an external device, transmitted into the application via a component which integrates the Bluetooth protocol. Furthermore, the patient's picture may also be taken, and packaged with the bolus of data to be sent to the server. The form-fields included in this application may include free-text entry, “pick list”, and spinner-type data entry, which allows for either a set list of choices, or else a range of choices. Each of these aspects and data fields may be comprised of its own component, most of which are “reused” multiple times, meaning that the Application Builder would simply drag and drop a specific type of form-field component to the working area, and then insert the custom response parameters required for this exact application, and repeat until all fields are represented.

The features exemplified herein demonstrate aspects of both one-off application building utility, as well as the ability of the user to rapidly create mass-replicate forms for a mobile device. These standardized forms may explicitly adhere to official form standards which many organizations, agencies, and governmental entities use within their official functions.

### 20. Closing

While example embodiments have been particularly shown and described, it will be understood by those of ordinary skill in the art that various changes in form and details may be made therein without departing from the spirit and scope of the present invention as defined by the following claims.

1. A computer system, comprising:
a processor; and
a memory configured to store a library of applications for execution by the processor;
wherein the computer system is configured to allow users of the computer system to download one or more applications from the library of applications to communications devices,
wherein the downloaded one or more applications are configured to connect at least one first communications device of the communications devices to at least one second communications device of the communications devices in a network, and
wherein information transfer within the network from the at least one first communications device to the at least one second communications device is independent of the processor.

2. The computer system of claim 1, wherein the communications devices comprise one or more mobile communications devices.

3. The computer system of claim 1, wherein the communications devices comprise one or more wireless communications devices.

4. The computer system of claim 1, wherein the communications devices comprise one or more wired communications devices.

5. The computer system of claim 1, wherein the computer system is further configured to allow users of the computer system to edit the one or more applications from the library of applications prior to downloading the edited one or more applications from the library of applications to the communications devices.

6. The computer system of claim 5, wherein the computer system is further configured to allow users of the computer system to add the edited one or more applications to the library of applications.

7. The computer system of claim 1, wherein when a sensor of the at least one first communications device detects a change in an environment of the at least one first communications device, the at least one first communications device transfers information within the network from the at least one first communications device to the at least one second communications device.

8. A computer-implemented method for connecting communications devices using a library of applications stored in a memory of a computer system, the method comprising:
downloading one or more applications from the library of applications to the communications devices; and
using the downloaded one or more applications to connect at least one first communications device of the communications devices to at least one second communications device of the communications devices in a network;
wherein information transfer within the network from the at least one first communications device to the at least one second communications device is independent of the processor.

9. The method of claim 8, wherein the communications devices comprise one or more mobile communications devices.

10. The method of claim 8, wherein the communications devices comprise one or more wireless communications devices.

11. The method of claim 8, wherein the communications devices comprise one or more wired communications devices.

12. The method of claim 8, further comprising:
editing the one or more applications from the library of applications prior to downloading the one or more applications from the library of applications to the communications devices.

13. The method of claim 12, further comprising:
adding the edited one or more applications to the library of applications.

14. The method of claim 8, further comprising:
transferring information within the network from the at least one first communications device to the at least one second communications device when a sensor of the at least one first communications device detects a change in an environment of the at least one first communications device.

15. A computer-readable medium that is not a transitory propagating signal, the computer-readable medium having stored thereon instructions that, when executed by a computing device, cause the computing device to perform functions comprising:
allowing users of the computing device to download one or more applications, from a library of applications stored in a memory of the computing device, to communications devices; and
allowing the downloaded one or more applications to connect at least one first communications device of the communications devices to at least one second communications device of the communications devices in a network;
wherein information transfer within the network from the at least one first communications device to the at least one second communications device is independent of the processor.

16. The computer-readable medium of claim 15, wherein the communications devices comprise one or more mobile communications devices.

17. The computer-readable medium of claim 15, wherein the communications devices comprise one or more wireless communications devices.

18. The computer-readable medium of claim 15, wherein the communications devices comprise one or more wired communications devices.

19. The computer-readable medium of claim 15, the computer-readable medium having stored thereon instructions that, when executed by a computing device, cause the computing device to perform functions further comprising:
allowing the users of the computing device to edit the one or more applications from the library of applications prior to downloading the one or more applications from the library of applications to the communications devices.

20. The computer-readable medium of claim 19, the computer-readable medium having stored thereon instructions that, when executed by a computing device, cause the computing device to perform functions further comprising:
allowing the users of the computing device to add the edited one or more applications to the library of applications.
